(19) United States
(12) Patent Application Publication
(10) Pub. No.: US 2025/0087223 A1
(43) Pub. Date: Mar. 13, 2025

(54) VOCODER TECHNIQUES

(71) Applicant: Fraunhofer-Gesellschaft zur Förderung der angewandten Forschung e.V., Munchen (DE)

(72) Inventors: Nicola PIA, Erlangen (DE); Kishan GUPTA, Erlangen (DE); Srikanth KORSE, Erlangen (DE); Markus MULTRUS, Erlangen (DE); Guillaume FUCHS, Erlangen (DE)

(21) Appl. No.: 18/888,957

(22) Filed: Sep. 18, 2024

Related U.S. Application Data
(63) Continuation of application No. PCT/EP2023/057108, filed on Mar. 20, 2023.

(30) Foreign Application Priority Data
Mar. 18, 2022 (EP) 22163062.7
Jun. 29, 2022 (EP) 22182048.3

(51) Int. Cl. G10L 19/02

(52) U.S. Cl. CPC G10L 19/02

(57) ABSTRACT

An audio signal representation generator is provide for generating an output audio signal representation from an input audio signal that includes a sequence of input audio signal frames. Each input audio signal frame includes a sequence of input audio signal samples. The audio signal representation generator includes a format definer that defines a first multi-dimensional audio signal representation of the input audio signal, and a learnable layer that processes the first multidimensional audio signal representation of the input audio signal, or a processed version of the first multi-dimensional audio signal representation, to generate the output audio signal representation of the input audio signal.

### CROSS-REFERENCE TO RELATED APPLICATIONS

This application is a continuation of copending International Application No. PCT/EP2023/057108, filed Mar. 20, 2023, which is incorporated herein by reference in its entirety, and additionally claims priority from European Applications Nos. EP 22163062.7, filed Mar. 18, 2022, and EP 22182048.3, filed Jun. 29, 2022, which are all incorporated herein by reference in their entirety.

### BACKGROUND OF THE INVENTION

There are presented vocoder techniques and more in general techniques for generating an audio signal representation (e.g. a bitstream) and for generating an audio signal (e.g. at a decoder).

The techniques here are generally explained as referring to learnable layers, which may be embodied, for example, by neural networks (e.g. convolutional learnable layers, recurrent learnable layers, and so on).

The present techniques are also called, in some examples, Neural End-2-End Speech Codec (NESC).

### SUMMARY

According to an embodiment, an audio signal representation generator for generating an output audio signal representation from an input audio signal including a sequence of input audio signal frames, each input audio signal frame including a sequence of input audio signal samples, may have:
a format definer configured to define a first multi-dimensional audio signal representation of the input audio signal, the first multi-dimensional audio signal representation of the input audio signal including at least:
   a first dimension, so that a plurality of mutually subsequent frames is ordered according to the first dimension; and
   a second dimension so that a plurality of samples of at least one frame are ordered according to the second dimension,
at least one learnable layer configured to process the first multidimensional audio signal representation of the input audio signal, or processed version of the first multi-dimensional audio signal representation, to generate the output audio signal representation of the input audio signal,
wherein the format definer is configured to insert, along the second dimension of the first multi-dimensional audio signal representation of the input audio signal, additional input audio signal samples of one or more additional frames immediately successive to or immediately preceding the given frame.

According to another embodiment, an audio signal representation generator for generating an output audio signal representation from an input audio signal including a sequence of input audio signal frames, each input audio signal frame including a sequence of input audio signal samples, may have:
a format definer configured to define a first multi-dimensional audio signal representation of the input audio signal;
a second learnable layer which is a recurrent learnable layer configured to generate a third multi-dimensional audio signal representation of the input audio signal by operating along a first direction of the first multi-dimensional audio signal representation, or of a processed version thereof which is a second multi-dimensional audio signal representation, of the input audio signal;
a third learnable layer which is a convolutional learnable layer configured to generate a fourth multi-dimensional audio signal representation of the input audio signal by sliding along the second direction of the third multi-dimensional audio signal representation of the input audio signal, so as to obtain the output audio signal representation from the fourth multi-dimensional audio signal representation of the input audio signal.

In accordance to an aspect there is provided an audio generator, configured to generate an audio signal from a bitstream, the bitstream representing the audio signal, the audio signal being subdivided in a sequence of frames, the audio generator comprising:
a first data provisioner configured to provide, for a given frame, first data derived from an input signal;
a first processing block, configured, for the given frame, to receive the first data and to output first output data in the given frame,
wherein the first processing block comprises:
   at least one preconditioning learnable layer configured to receive the bitstream, or a processed version thereof, and, for the given frame, output target data representing the audio signal in the given frame;
   at least one conditioning learnable layer configured, for the given frame, to process the target data to obtain conditioning feature parameters for the given frame; and
   a styling element, configured to apply the conditioning feature parameters to the first data or normalized first data;
wherein the at least one preconditioning learnable layer includes at least one recurrent learnable layer.

In accordance to an aspect there is provided an audio generator, configured to generate an audio signal from a bitstream, the bitstream representing the audio signal, the bitstream being subdivided into a sequence of indexes, the audio signal being subdivided in a sequence of frames, the audio generator comprising:
a quantization index converter configured to convert the indexes of the bitstream onto codes,
a first data provisioner configured to provide, for a given frame, first data derived from an input signal from an external or internal source or from the bitstream;
a first processing block, configured, for the given frame, to receive the first data and to output first output data in the given frame, wherein the first processing block comprises:
   at least one preconditioning learnable layer configured to receive the bitstream, or a processed version thereof, and, for the given frame, output target data representing the audio signal in the given frame;
   at least one conditioning learnable layer configured, for the given frame, to process the target data to obtain conditioning feature parameters for the given frame; and
a styling element, configured to apply the conditioning feature parameters to the first data or normalized first data.

In accordance to an aspect there is provided an encoder for generating a bitstream in which an input audio signal including a sequence of input audio signal frames is encoded, each input audio signal frame including a sequence of input audio signal samples, the encoder comprising:
a format definer configured to define a first multi-dimensional audio signal representation of the input audio signal, the first multi-dimensional audio signal representation of the input audio signal including at least:
   a first dimension, so that a plurality of mutually subsequent frames is ordered according to the first dimension; and
   a second dimension, so that a plurality of samples of at least one frame are ordered according to the second dimension,
a learnable quantizer to associate, to each frame of the first multi-dimensional or a processed version of the first multi-dimensional audio signal representation of the input audio signal, indexes of at least one codebook, so as to generate the bitstream.

In accordance to an aspect there is provided an encoder for generating a bitstream in which an input audio signal including a sequence of input audio signal frames is encoded, each input audio signal frame including a sequence of input audio signal samples, the encoder comprising:
a learnable quantizer to associate, to each frame of a first multi-dimensional audio signal representation of the input audio signal, indexes of at least one codebook, so as to generate the bitstream.

In accordance to an aspect there is provided an encoder for generating a bitstream encoding an input audio signal including a sequence of input audio signal frames, each input audio signal frame including a sequence of input audio signal samples, the encoder comprising:
a format definer configured to define a first multi-dimensional audio signal representation of the input audio signal, the first multi-dimensional audio signal representation of the input audio signal including at least:
   a first dimension, so that a plurality of mutually subsequent frames is ordered according to the first dimension; and
   a second dimension, so that a plurality of samples of at least one frame are ordered according to the second dimension, at least one intermediate learnable layer;
a learnable quantizer to associate, to each frame of the first multi-dimensional or a processed version of the first multi-dimensional audio signal representation of the input audio signal, indexes of at least one codebook, so as to generate the bitstream.

In accordance to an aspect there is provided a method for generating an audio signal from a bitstream, the bitstream representing the audio signal, the audio signal being subdivided in a sequence of frames, the method comprising:
providing, for a given frame, first data derived from an input signal;
through a first processing block, receiving the first data and outputting first output data in the given frame,
wherein the first processing block comprises:
   at least one preconditioning learnable layer receiving the bitstream, or a processed version thereof, and, for the given frame, output target data representing the audio signal in the given frame;
   at least one conditioning learnable layer processing, e.g. for the given frame, the target data to obtain conditioning feature parameters for the given frame; and
   a styling element, applying the conditioning feature parameters to the first data or normalized first data;
wherein the at least one preconditioning learnable layer includes at least one recurrent learnable layer.

In accordance to an aspect there is provided a method for generating an audio signal from a bitstream, the bitstream representing the audio signal, the bitstream (3) being subdivided into a sequence of indexes, the audio signal being subdivided in a sequence of frames, the method comprising:
a quantization index converter step converting the indexes of the bitstream onto codes,
a first data provisioner step providing, e.g. for a given frame, first data derived from an input signal from an external or internal source or from the bitstream, and
a step using a first processing block to receive the first data and to output first output data in the given frame,
wherein the first processing block comprises:
   at least one preconditioning learnable layer to receive the bitstream, or a processed version thereof, and, for the given frame, output target data representing the audio signal in the given frame;
   at least one conditioning learnable layer, e.g. for the given frame, to process the target data to obtain conditioning feature parameters for the given frame; and
a styling element, to apply the conditioning feature parameters to the first data or normalized first data.

In accordance to an aspect there is provided an audio signal representation generator for generating an output audio signal representation from an input audio signal including a sequence of input audio signal frames, each input audio signal frame including a sequence of input audio signal samples, the audio signal representation generator comprising:
a format definer configured to define a first multi-dimensional audio signal representation of the input audio signal, the first multi-dimensional audio signal representation of the input audio signal including at least:
   a first dimension, so that a plurality of mutually subsequent frames is ordered according to the first dimension; and
   a second dimension so that a plurality of samples of at least one frame are ordered according to the second dimension,
at least one learnable layer configured to process the first multidimensional audio signal representation of the input audio signal, or processed version of the first multi-dimensional audio signal representation, to generate the output audio signal representation of the input audio signal.

In accordance to an aspect there is provided an audio signal representation generator for generating an output audio signal representation from an input audio signal including a sequence of input audio signal frames, each input audio signal frame including a sequence of input audio signal samples, the audio signal representation generator comprising:
a format definer configured to define a first multi-dimensional audio signal representation of the input audio signal;
a second learnable layer which is a recurrent learnable layer configured to generate a third multi-dimensional audio signal representation of the input audio signal by operating along a first direction of the first multi-dimensional audio signal representation, or a processed version thereof which is a second multi-dimensional audio signal representation, of the input audio signal;
a third learnable layer which is a convolutional learnable layer configured to generate a fourth multi-dimensional audio signal representation of the input audio signal by sliding along the second direction of the first multi-dimensional audio signal representation of the input audio signal,
so as to obtain the output audio signal representation from the fourth multi-dimensional audio signal representation of the input audio signal.

In accordance to an aspect there is provided a method for generating an output audio signal representation from an input audio signal including a sequence of input audio signal frames, each input audio signal frame including a sequence of input audio signal samples, the audio signal representation generator comprising:
defining a first multi-dimensional audio signal representation of the input audio signal;
through a first learnable layer, generating a second multi-dimensional audio signal representation of the input audio signal by sliding along a second direction of the first multi-dimensional audio signal representation of the input audio signal;
through a second learnable layer which is a recurrent learnable layer generating a third multi-dimensional audio signal representation of the input audio signal by operating along a first direction of the second multi-dimensional audio signal representation of the input audio signal;
through a third learnable layer which is a convolutional learnable layer generating a fourth multi-dimensional audio signal representation of the input audio signal by sliding along the second direction of the first multi-dimensional audio signal representation of the input audio signal,
so as to obtain the output audio signal representation from the fourth multi-dimensional audio signal representation of the input audio signal.

In accordance to an aspect there is provided an audio generator, configured to generate an audio signal from a bitstream, the bitstream representing the audio signal, the audio signal being subdivided in a sequence of frames, the audio generator comprising:
a first data provisioner configured to provide, for a given frame, first data derived from an input signal, wherein the first data have multiple channels;
a first processing block, configured, for the given frame, to receive the first data and to output first output data in the given frame, wherein the first output data may comprise a plurality of channels,
the audio generator also comprising a second processing block, configured, for the given frame, to receive, as second data, the first output data or data derived from the first output data,
wherein the first processing block comprises:
   at least one preconditioning learnable layer configured to receive the bitstream, or a processed version thereof, and, for the given frame, output target data representing the audio signal in the given frame with multiple channels and multiple samples for the given frame;
   at least one conditioning learnable layer configured, for the given frame, to process the target data to obtain conditioning feature parameters for the given frame; and
   a styling element, configured to apply the conditioning feature parameters to the first data or normalized first data;
wherein the second processing block is configured to combine the plurality of channels of the second data to obtain the audio signal,
wherein the at least one preconditioning learnable layer includes at least one recurrent learnable layer.

### BRIEF DESCRIPTION OF THE DRAWINGS

Embodiments of the present invention will be detailed subsequently referring to the appended drawings, in which:

FIGS. 1a and 1b show examples;

FIG. 1c shows an operation according to an example;

FIGS. 2a, 2b, 2c show experimental results;

FIG. 3 shows an example of elements of a decoder;

FIG. 4 shows an example of an audio generator;

FIGS. 5 and 6 show experimental results of listening tests;

FIG. 7 shows an example of a decoder;

FIG. 8 shows an example of an encoder and a decoder;

FIG. 9 shows an operation according to an example;

FIG. 10 shows an example of generative adversarial network (GAN) discriminator; and

FIGS. 11 and 12 show examples of GRU implementations.

### DETAILED DESCRIPTION OF THE INVENTION

### Examples

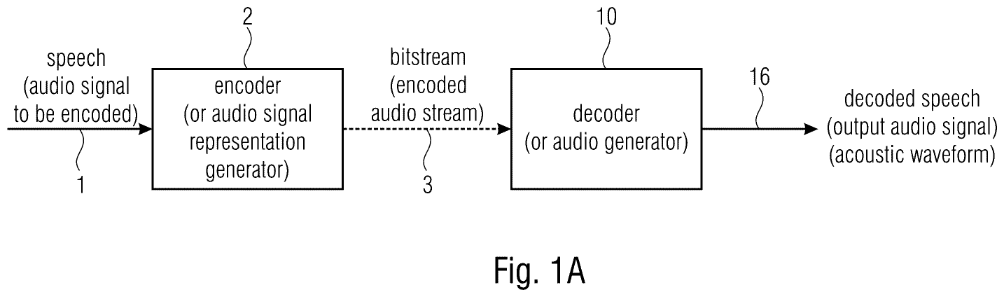

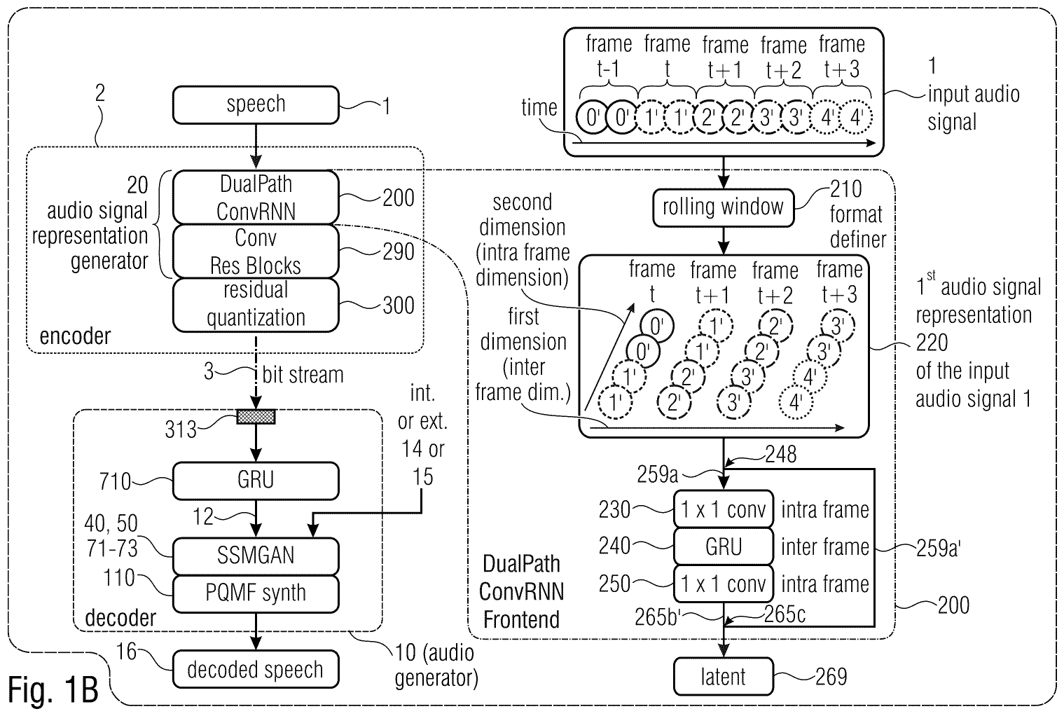

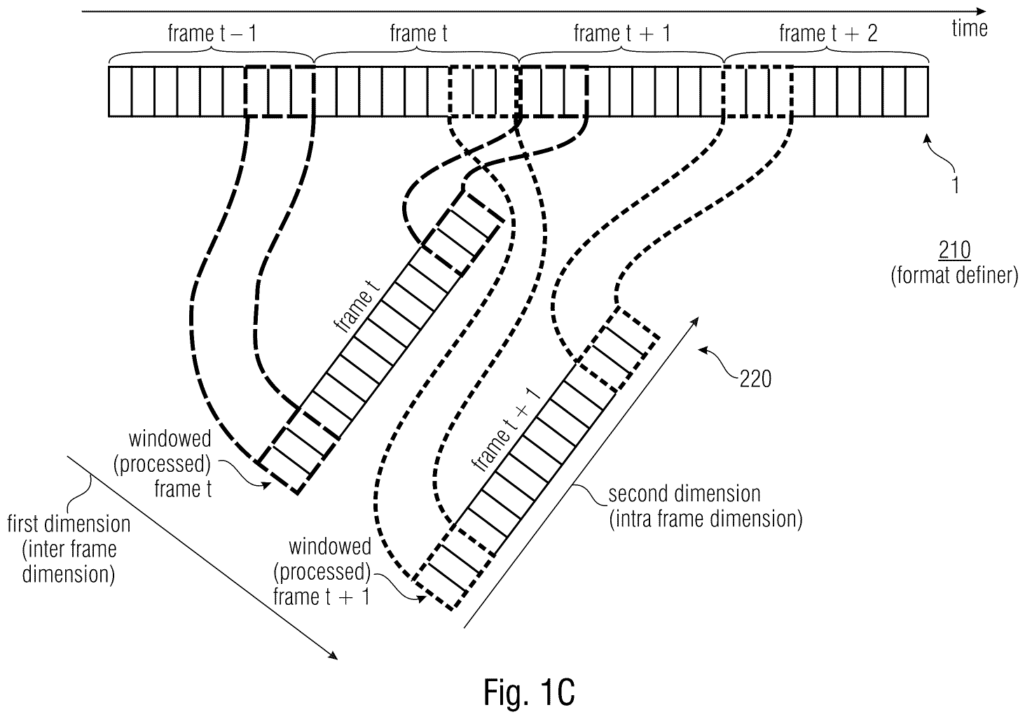

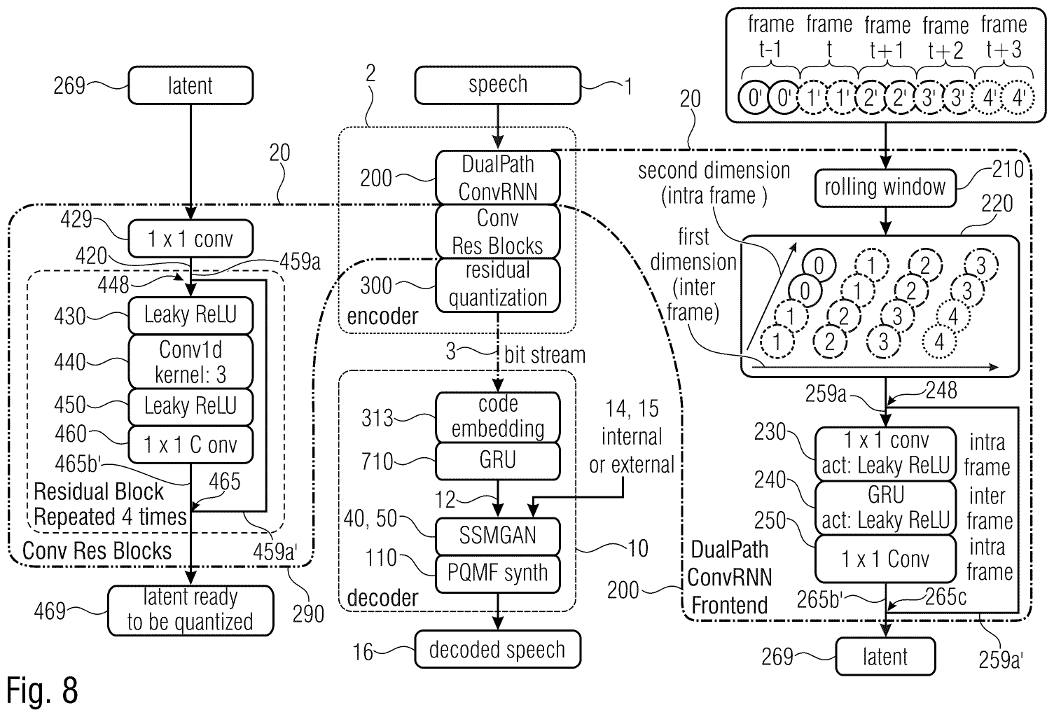

FIG. 1b (of which FIG. 1a is a simplified version, or FIG. 8 in its more detailed version) shows an example of a vocoder (or more in general, a system for processing audio signals) system. The vocoder system may include, for example, an audio signal representation generator 20 to generate an audio signal representation of an input audio signal 1. The audio signal 1 may be processed by the audio signal representation generator 20. The audio signal representation of the input audio signal 1 may be either stored (and e.g., used for purposes like processing of the audio signal) or may be quantized (e.g., through a quantizer 300), so as to obtain a bitstream 3. A decoder 10 (audio generator) may read the bitstream 3 and generate an output audio signal 16.

Each of the audio signal representation generator 20, the encoder 2, and/or the decoder 10 may be a learnable system and may include at least one learnable layer and/or learnable block.

The input audio signal 1 (which may be obtained, for example, from a microphone or can be obtained from other sources, such as a storage unit and/or a synthesizer) may be of the type having a sequence of audio signal frames. For example, the different input audio signal frames may represent the sound in a fixed time length (e.g., 10 ms or milliseconds, but in other examples, different lengths may be defined, eg., 5 ms and/or 20 ms). Each input audio signal frame may include a sequence of samples (for example, at 16 kHz or kilohertz and there would be 160 samples in each frame). In this case, the input audio signal is in the time domain, but in other cases, it could be in the frequency domain. In general terms, however, the input audio signal 1 may be understood as having a single dimension. In FIG. 1b (or FIG. 8 in its more detailed version), the input audio signal 1 is represented as having five frames, each frame having only two samples (this is, of course, for simplicity purposes). For example, the frame numbered as t−1 has two samples 0′ and 0′. The frame number t in the sequence has the samples 1′ and 1′. The frame number t+1 has the samples 2′ and 2′. The frame number t+2 has the samples 3′ and 3′. The frame number t+3 has the samples 4′ and 4′. The input audio signal 1 may be provided to a learnable block 200. The learnable block 200 may be of the type having a Dual Path (e.g. coping with at least one residual). The learnable block 200 may provide a processed version 269 of the input audio signal 1 onto a second learnable block 290 (this may be avoided in some cases). Subsequently, the learnable block 200 or the learnable block 290 may provide its outputted processed version of the input audio signal 1 to a quantizer 300. The quantizer 300 may provide the bitstream 3. It will be seen that the quantizer 300 may be a learnable quantizer. In some cases, the output may be provided only by the learnable block 290, to have an audio signal representation 269 as output. In some cases, the quantization 300 may therefore not even exist.

The learnable block 200 may process the input audio signal 1 (in one of its processed versions) after having converted the input audio signal 1 (or a processed version thereof) onto a multi-dimension representation. A format definer 210 may therefore be used. The format definer 210 may be a deterministic block (e.g., a non-learnable block). Downstream to the format definer 210, the processed version 220 outputted by the format definer 210 (also called first audio signal representation of the input audio signal 1) may be processed through at least one learnable layer (e.g., 230, 240, 250, 290, 429, 440, 460, 300, see below). At least the learnable layer(s) which is(are) internal to the learnable block 200 (e.g., layers 230, 240, 250) are learnable layers which process the first audio signal representation 220 of the input audio signal 1 in its multi-dimensional version (e.g., bi-dimensional version). The learnable layers 429, 440, 460 may also process multidimensional versions of the input audio signal 1. As will be shown, this may be obtained, for example, through a rolling window, which moves along the single dimension (time domain) of the input audio signal 1 and generates a multi-dimensional version 220 of the input audio signal 1. As can be seen, the first audio signal representation 220 of the input audio signal 1 may have a first dimension (inter frame dimension), so that a plurality of mutually subsequent frames (e.g., immediately subsequent to one with respect to each other) is ordered according to (along) first dimension.

It is also to be noted that the second dimension (intra frame dimension) is such that the samples of each frame are ordered according to (along) the second dimension. As can be seen in FIG. 1b, the frame t is then organized with the two samples 0′ and 0′ along the second direction (inter frame direction). As can be seen, this sequence of frames t, t+1, t+2, t+3, etc. may be respected along the first dimension while in the second dimension the sequence of samples is also respected for each frame. The format definer 210 is configured to insert, along the second dimension [e.g. intra frame dimension] of the first multidimensional audio signal representation of the input audio signal, input audio signal samples of each given frame. The format definer 210 is, additionally or in alternative, configured to insert, along the second dimension [e.g. intra frame dimension] of the first multi-dimensional audio signal representation 220 of the input audio signal 1, additional input audio signal samples of one or more additional frames immediately successive to the given frame [e.g. in a predefined number, e.g. application specific, e.g. defined by a user or an application]. The format definer 210 is configured to insert, along the second dimension of the first multidimensional audio signal representation 220 of the input audio signal 1, additional input audio signal samples of one or more additional frames immediately preceding the given frame [e.g. in a predefined number, e.g. application specific, e.g. defined by a user or an application].

As repeated in FIG. 1c (in that case, each frame is considered to have nine samples, but also as seen in FIG. 1b with a different number of samples) there is the possibility of inserting, along the second (intra frame) dimension, also samples of the preceding frame (immediately before) and/or samples of the successive (immediately following) frames. For example, in the example of FIG. 1c, in the first audio signal representation 220 of the input audio signal 1, the first three samples of frame t are actually occupied by the last three samples of the immediately preceding frame t−1. Alternatively or in addition, the last three samples of the frame t in the first audio signal representation 220 of the input audio signal 1, are occupied by the first three samples of the immediately following frame t+1. This is performed frame by frame, so that the first audio signal representation 220 has, in each from, the first samples inherited from the last samples of the immediately preceding frame, and, as last samples, the first samples of the immediately subsequent frame. Notably, the number of samples for each frame from the input version 1 to the processed version 220 is therefore increased. It is not always necessary, however, that this technique is performed. It is not always necessary that the number of samples inherited from the immediately preceding or the immediately successive or following frame is three (different numbers may be possible, although they are generally less than the samples inherited from other samples do not account, in total, for more than 50% of the samples of the frame in the version 220) or there may be different numbers of the initial samples and/or the final samples. In some cases, the initial samples or the final samples are not inherited from the immediately preceding or in the immediately subsequent frame. In some cases, this technique is not used. In the example of FIG. 1b (or FIG. 8 in its more detailed version), the frame t inherits the totality of the samples of a frame t−1, that frame t+1 inherits the totality of the samples of frame t, and so on. This is notwithstanding just a representation. A downsampling technique using strided convolutions or interpolation layers is notwithstanding avoided. As will be explained below, the inventors have understood that this is advantageous. Even for each frame, also multidimensional structures may be defined, so that the first audio signal representation 220 has more than two dimensions. This is an example of dual path convolutional recurrent learnable layer (e.g. dual path convolutional recurrent neural network). An example is also below, in the section “Discussion”, in the subsection 2.1.

Downstream to the format definer 210, at least one learnable layer (230, 240, 250) may be inputted by the first audio signal representation 220 of the input audio signal 1. Notably, in this case, the at least one learnable layer 230, 240, and 250 may follow a residual technique. For example, at point 248, there may be a generation of a residual value from the audio signal representation 220. In particular, the first audio signal representation 220 may be subdivided among a main portion 259a′ and a residual portion 259a of the first audio signal representation 220 of the input audio signal. The main portion 259a′ of the first audio signal representation 220 may therefore not be subjected to any processing up to point 265c in which the main portion 259a′ of the first audio signal representation 220 is added to (summed with) a processed residual version 265b′ outputted by the at least one learnable layer 230, 240, and 250 e.g. in cascade with each other. Accordingly, a processed version 269 of the input audio signal 1 may be obtained.

The at least one residual learnable layer 230, 240, 250 may include:
an optional first learnable layer (230), e.g. a first convolutional learnable layer, which is a convolutional learnable layer configured to generate a second multi-dimensional audio signal representation of the input audio signal (1) by sliding along a second direction [e.g. intra frame direction] of the first multi-dimensional audio signal representation (220) of the input audio signal (1);]
a second learnable layer (240) which may be a recurrent learnable layer (e.g. a gated recurrent learnable layer) configured to generate a third multi-dimensional audio signal representation of the input audio signal (1) by operating along the first direction [e.g. inter frame direction] of the second multi-dimensional audio signal representation (220) of the input audio signal (1) [e.g. using a 1×1 kernel, e.g. a 1×1 learnable kernel, or another kernel, e.g. another learnable kernel];
a third learnable layer (250) [which may be, for example, a second convolutional learnable layer] which is a convolutional learnable layer configured to generate a fourth multi-dimensional audio signal representation (265b′) of the input audio signal by sliding along the second direction [e.g. intra frame direction] of the first multi-dimensional audio signal representation of the input audio signal [e.g. using a 1×1 kernel, e.g. a 1×1 learnable kernel],

Notably, the first learnable layer 230 may be a first convolutional learnable layer. It may have a 1×1 kernel. The 1×1 kernel may be applied by sliding the kernel along the second dimension (i.e., for each frame). The recurrent learnable layer 240 (e.g., gated recurrent unit, GRU) may be inputted with the output from the first convolutional learnable layer 230. The recurrent learnable layer (e.g., GRU) may be applied in the first dimension (i.e., by sliding from frame t, to frame t+1, to frame t+2, and so on). As it will be explained later, in the recurrent learnable layer 240, each value of the output for each frame may also be based on the preceding frames (e.g., the immediately preceding frame, or also a number n of frames immediately before the particular frame; for example, for the output of the recurrent learnable layer 240 for frame t+3 in the case of n=2, then the output will take into consideration the values of the samples for the frame t+1 and for the frame t+2, but the values of the samples of frame t will not be taken into consideration). The processed version of the input audio signal 1 as outputted by the recurrent learnable layer 240 may be provided to a second convolution learnable layer (third learnable layer) 250. The second convolutional learnable layer 250 may have a kernel (e.g., 1×1 kernel) which slides along the second dimension for each frame (along the second, intra frame dimension). The output 265b′ of the second convolutional learnable layer 250 may then be added, e.g. at point 265c (some or other) with the main portion 259a′ of the first audio signal representation 220 of the input audio signal 1, which has bypassed the learnable layers 230, 240, and 250.

Then, a processed version 269 of the input audio signal 1 may be provided (as latent 269) to the at least one learnable block 290. The at least one convolutional learnable block 290 may provide a version of e.g., 256 samples (even though different numbers may be used, such as 128, 516, and so on).

As shown in FIG. 8, the at least one convolutional learnable block 290 may include a convolutional learnable layer 429, to perform a convolution (e.g. using a 1×1 kernel) onto the signal 269 (e.g., as outputted by the learnable block 200). The convolutional learnable layer 429 may be a non-residual learnable layer. The convolutional learnable layer 429 may output a convoluted version 420 of the signal 269 and may also be a processed versions of the input audio signal 1.

The at least one convolutional learnable block 290 may include at least one residual learnable layer. The at least one convolutional learnable block 290 may include at least one learnable layer(s) (e.g. 440, 460). The learnable layer(s) 440, 460 (or at least one or some of them) may follow a residual technique. For example, at point 448, there may be a generation of a residual value from the audio signal representation or latent representation 269 (or its convoluted version 420). In particular, the audio signal representation 420 may be subdivided among a main portion 459a′ and a residual portion 459a of the audio signal representation 420 of the input audio signal 1. The main portion 459a′ of the audio signal representation 420 of the input audio signal 1 may therefore not be subjected to any processing up to point 465 in which the main portion 459a′ audio signal representation 420 of the input audio signal 1 is added to (summed with) a processed residual version 465b′ outputted by the at least one learnable layer 440 and 460 in cascade with each other. Accordingly, a processed version 469 of the input audio signal 1 may be obtained, and may represent the output of the audio representation generator 20.

The at least one residual learnable layer in at least one convolutional learnable block 290 may include at least one of:
a first layer (430), configured to generate a residual multi-dimensional audio signal representation of the input audio signal (1) from the audio signal representation 420 (the first 1 layer 430 may be an activation function, e.g. a Leaky ReLu, see below);
a second, learnable layer (440) which is a convolutional learnable layer configured to generate a residual multi-dimensional audio signal representation of the input audio signal 1 by convolution [e.g. a kernel 3 may be used] from the audio signal representation outputted by the first learnable layer (430);
a third layer (450) to generate a residual multi-dimensional audio signal representation of the input audio signal 1 from audio signal representation outputted by the second learnable layer (440) (the learnable layer 450 may be an activation function, e.g. a Leaky ReLu, see below);
a fourth, learnable layer (460) which is a convolutional learnable layer configured to generate a residual multi-dimensional audio signal representation 456b′ of the input audio signal 1 by convolution [e.g. a kernel 1×1 may be used] from the residual multi-dimensional audio signal representation of the input audio signal 1 outputted by the third learnable layer (450);

The output 465b′ of the second convolutional learnable layer 460 (fourth learnable layer) may then be added to, at point 465, (summed with) the main portion 459a′ of the audio signal representation 420 (or 269) of the input audio signal 1, which has bypassed the layers 430, 440, 450, 460.

It is to be noted that the output 469 may be considered the audio signal representation outputted by the audio signal representation generator 20.

Subsequently, a quantizer 300 may be provided in case it is needed to write a bitstream 3. The quantizer 300 may be a learnable quantizer [e.g. a quantizer using at least one learnable codebook], which is discussed in detail below. The quantizer (e.g. the learnable quantizer) 300 may associate, to each frame of the first multi-dimensional audio signal representation (e.g. 220 or 469) of the input audio signal (1), or a processed version of the first multi-dimensional audio signal representation, index(es) of at least one codebook, so as to generate the bitstream [the at least one codebook may be, for example, a learnable codebook].

Notably, the cascade formed by the learnable layers 230, 240, 250 and/or the cascade formed by layers 430, 440, 450, 460 may include more or less layers, and different choices may be made. Notably, however, they are residual learnable layers, and they are bypassed by the main portion 259′ of the first audio signal representation 220.

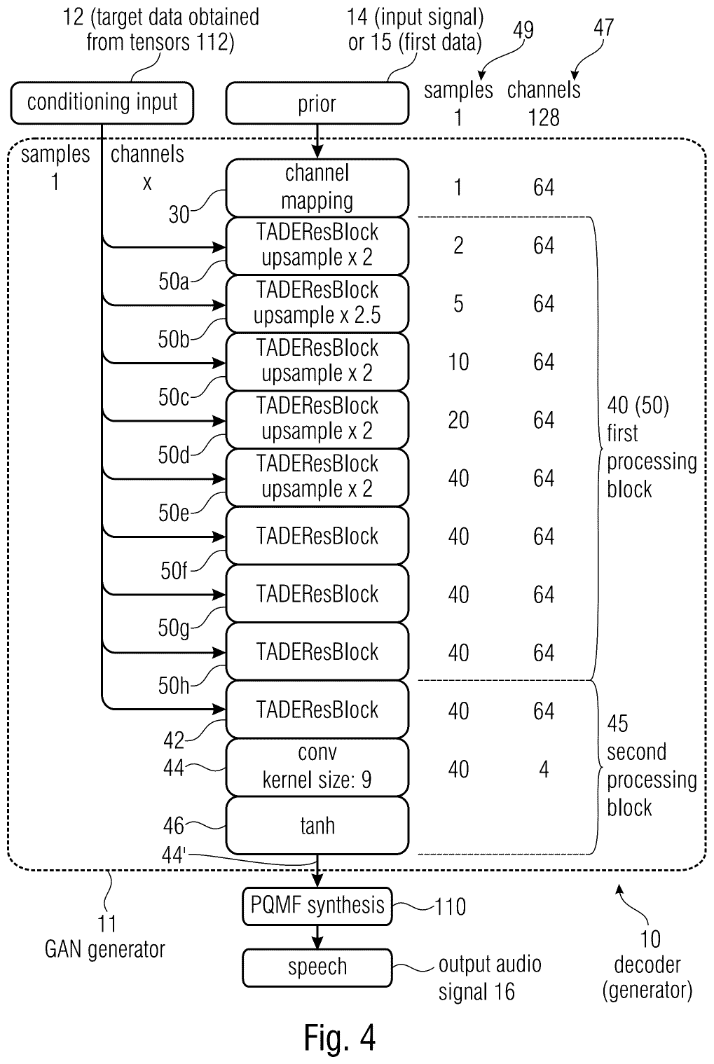

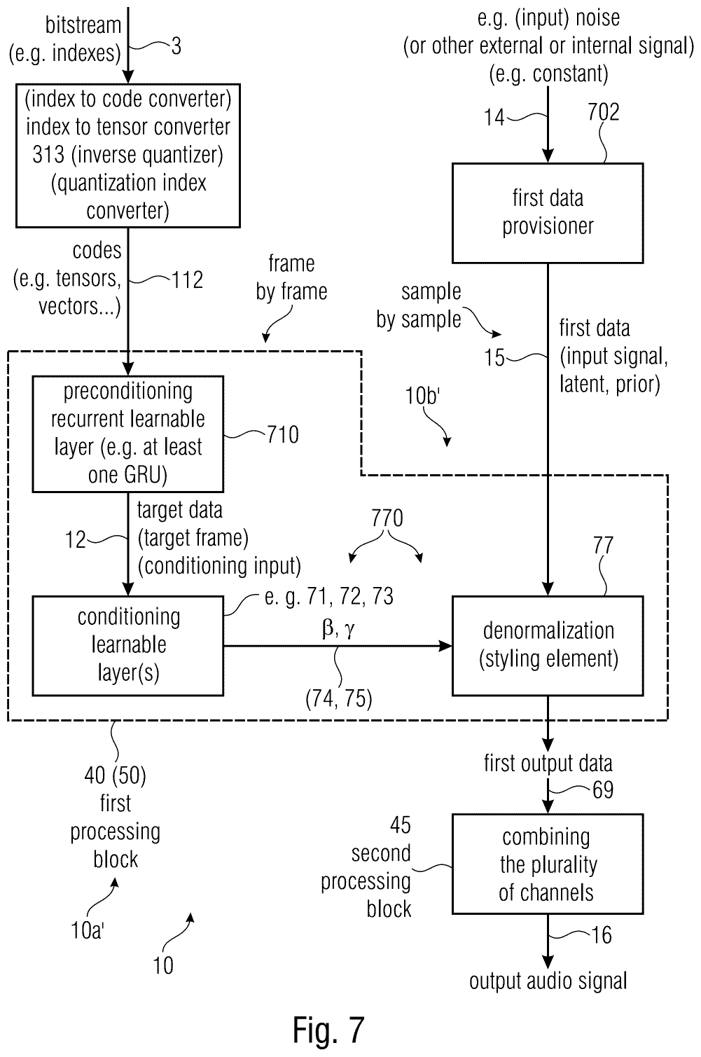

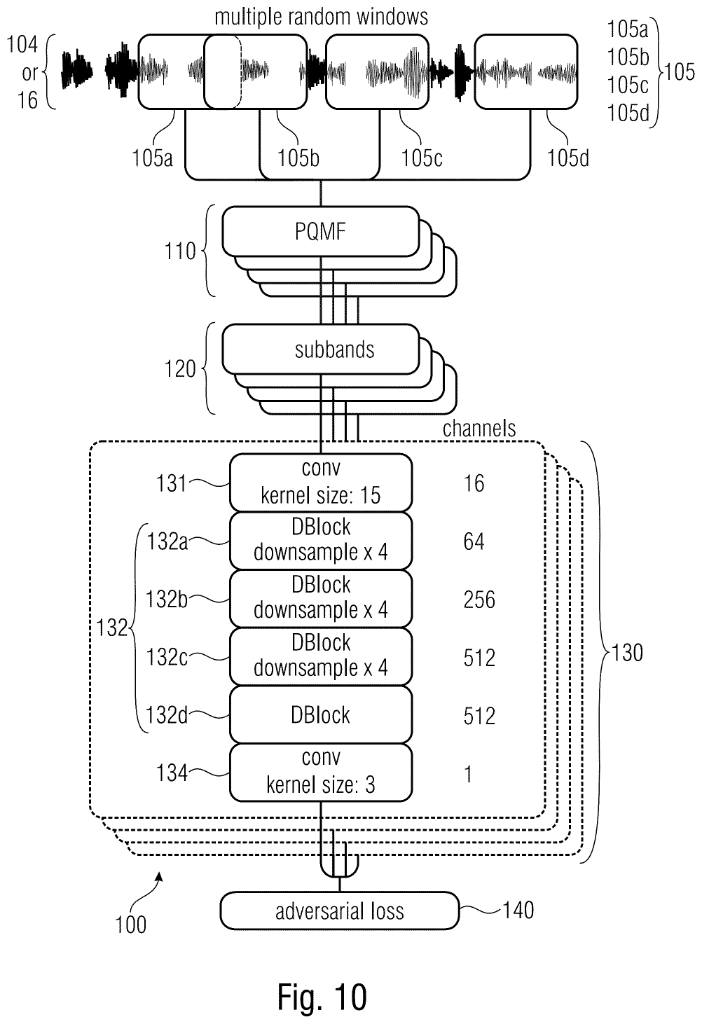

FIG. 7 shows an example of the decoder (audio generator) 10. The bitstream 3 (obtained in input) may comprise frames (e.g. encoded as indexes, e.g. encoded by the encoder 2, e.g. after quantization by the quantizer 300). An output audio signal 16 may be obtained. The audio generator 10 may include a first data provisioner 702. The first data provisioner 702 may be inputted with an input signal (input data) 14 (e.g. from an internal source, e.g. a noise generator or a storage unit, or from an external source e.g. an external noise generator or an external storage unit or even data obtained from the bitstream 3). The input signal 14 may be noise, e.g. white noise, or a deterministic value (e.g. a constant). The input signal 14 may have a plurality of channels (e.g. 128 channels, but other numbers of channels are possible, e.g. a number larger than 64). The first data provisioner 702 may output first data 15. The first data 15 may be noise, or taken from noise. The first data 15 may be inputted in at least one first processing block 50 (40). The first data 15 may be (e.g., when taken from noise, which therefore corresponds to the input signal 14) unrelated to the output audio signal 16, but in some cases they can be obtained from the bitstream 3, e.g. LPC parameters, or other parameters, taken from the bitstream 3; notably, an advantage of the present examples is that the first data 15 do not need to be explicit acoustic features, and the first data 15 may be more easily noise). The at least one first processing block 50 (40) may condition the first data 15 to obtain first output data 69, e.g. using a conditioning obtained by processing the bitstream 3. The first output data 69 may be provided to a second processing block 45. From the second processing block, an audio signal 16 may be obtained (e.g. through PQMF synthesis). The first output data 69 may be in a plurality of channels. The first output data 69 may be provided to the second processing block 45 which may combine the plurality of channels of the first output data 69 providing an output audio signal 16 in one signal channel (e.g. after the PQMF synthesis, e.g. indicated with 110 in FIGS. 4 and 10, but not shown in FIG. 7).

As explained above, the output audio signal 16 (as well as the original audio signal 1 and its encoded version, the bitstream 3 or its representation 20 or any other of its processed versions, such as 269, or the residual versions 259a and 265b′, or the main version 259a′, and any intermediate version outputted by layers 230, 240, 250, or any of the intermediate versions outputted by any of layers 429, 430, 440, 450, 460) are generally understood as being subdivided according to the sequence of frames (in some examples, the frames do not overlap with each other, while in some other examples they may overlap). Each frame includes a sequence of samples. For example, each frame may be subdivided into 16 samples (but other resolutions are possible). A frame can be long, as explained above, 10 ms (in other cases 5 ms or 20 ms or other time lengths may be used), while the sample rate may be for example 16 kHz (in other case 8 kHz, 32 kHz or 48 kHz, or any other sampling rates), and the bit-rate for example, 1.6 kbps (kilobit per second) or less than 2 kbps, or less than 3 kbps, or less than 5 kbps (in some cases, the choice is left to the encoder 1, which may change the resolution and signal which resolution is encoded). It is also noted that the multiple frames may be grouped in one single packet of the bitstream 3, e.g., for transmission or for storage. While the time length of one frame is in general considered fixed, the number of samples per frame may vary, and upsampling operations may be performed.

The decoder (audio generator) 10 may make use of:
a frame-by-frame branch 10a′, which may be updated for each frame, e.g. using the frames obtained from the bitstream 3 (e.g. the frame may be in form of indexes as quantized by the quantizer 300 and/or in form of codes (such as scalar, vectors, or more in general tensors) 112, e.g. as converted from a quantization index converter 313, which is also said reverse quantizer or inverse quantizer, or index to tensor converter); and/or
a sample-by-sample branch 10b′.

The sample-by-sample branch 10b′ may contain at least one of blocks 702, 77, and 69.

As shown by FIG. 7, indexes may be obtained from the quantization index convertor [or converter]313 to obtain codes (e.g. scalars, vectors or more in general tensors) 112. The codes 112 may be multi-dimensional (e.g. bidimensional, tridimensional, etc.) and may be here understood as being in the same format (or in a format which is analogous or similar to) the format of the audio signal representation outputted by the audio signal representation generator 20. The quantization index converter 313 may therefore be understood as performing the reverse operation of the quantizer 300. The quantization index converter 313 may include (e.g. be) learnable codebooks (the quantization index converter 313 may operate deterministically using at least one learnable codebook). The quantization index converter 313 may be trained together with the quantizer and, more in general, together with the other elements of the encoder 2 and/or the audio generator 10. The quantization index converter 313 may operate in a frame-by-frame fashion, e.g. by considering a new index for each new frame to generate. Hence each code (scalar, vector or more in general tensor . . . ) 112 has the same structure of each of latent representation which was quantized, without necessary sharing the exact same value but rather an approximation of them.

The sample-by-sample branch 10b′ may be updated for each sample e.g. at the output sampling rate and/or for each sample at a lower sampling-rate than the final output sampling-rate, e.g. using noise 14 or another input taken from an external or internal source.

It is also to be noted that the bitstream 3 is here considered to encode mono signals and also the output audio signal 16 and the original audio signal 1 are considered to be mono signals. In the case of stereo signals or multi-channel signals like loudspeaker signal or Ambisonics signal for example, then all the techniques here are repeated for each audio channel (in stereo case, there are two input audio channels 1, two output audio channels 16, etc.).

In this document, when referring to “channels”, it has to be understood in the context of convolutional neural networks, according to which a signal is seen as an activation map which has at least two dimensions:
a plurality of samples (e.g., in an abscissa dimension, or e.g. time axis); and
a plurality of channels (e.g., in the ordinate direction, or e.g. frequency axis).

The first processing block 40 may operate like a conditional network, for which data from the bitstream 3 (e.g. scalars, vectors or more in general tensors 112) are provided for generating conditions which modify the input data 14 (input signal). The input data (input signal) 14 (in any of its evolutions) will be subjected to several processings, to arrive at the output audio signal 16, which is intended to be a version of the original input audio signal 1. Both the conditions, the input data (input signal) 14 and their subsequent processed versions may be represented as activation maps which are subjected to learnable layers, e.g. by convolutions. Notably, during its evolutions towards the speech 16, the signal 1 may be subjected to an upsampling (e.g. from one sample 49 to multiple samples, e.g. thousands of samples, in FIG. 4), but its number of channels 47 may be reduced (e.g. from 64 or 128 channels to 1 single channel in FIG. 4).

First data 15 may be obtained (e.g. the sample-by-sample branch 10b′), for example, from an input (such as noise or a signal from an external signal), or from other internal or external source(s). The first data 15 may be considered the input of the first processing block 40 and may be an evolution of the input signal 14 (or may be the input signal 14). The first data 15 may be considered, in the context of conditional neural networks (or more in general conditional learnable blocks or layers), as a latent signal or a prior signal. Basically, the first data 15 is modified according to the conditions set by the first processing block 40 to obtain the first output data 69. The first data 15 may be in multiple channels, e.g. in one single sample. Also, the first data 15 as provided to the first processing block 40 may have the one sample resolution, but in multiple channels. The multiple channels may form a set of parameters, which may be associated to the coded parameters encoded in the bitstream 3. In general terms, however, during the processing in the first processing block 40 the number of samples per frame increases from a first number to a second, higher number (i.e. the sampling rate, which is here also called bitrate, increases from a first sampling rate to a second, higher sampling rate). On the other side, the number of channels may be reduced from a first number of channels to a second, lower number of channels. The conditions used in the first processing block (which are discussed in great detail below) can be indicated with 74 and 75 and are generated by target data 12, which in turn are generated from target data 12 obtained from the bitstream 3 (e.g. through the quantization index 313). It will be shown that also the conditions (conditioning feature parameters) 74 and 75, and/or the target data 12 may be subjected to upsampling, to conform (e.g. adapt) to the dimensions of the versions of the target data 12. The unit that provides the first data 15 (either from an internal source, an external source, the bitstream 3, etc.) is here called first data provisioner 702.

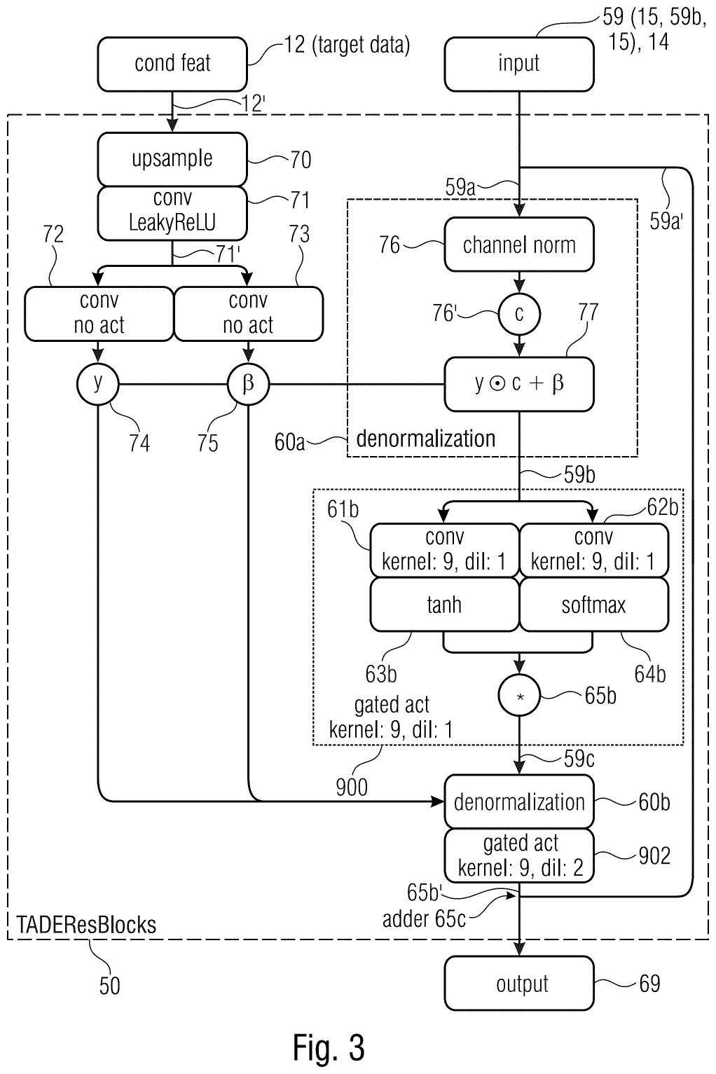

As can be seen from FIG. 7, the first processing block 40 may include a preconditioning learnable layer 710, which may be or comprise a recurrent learnable layer, e.g. a recurrent learnable neural network, e.g. a GRU. The preconditioning learnable layer 710 may generate target data 12 for each frame. The target data 12 may be at least 2-dimensional (e.g. multi-dimensional): there may be multiple samples for each frame in the second dimension and multiple channels for each frame in the first dimension. The target data 12 may be in the form of a spectrogram, which may be a mel-spectrogram, e.g. in case the frequency scale is non-uniform and/or is motivated by perceptual principles. In case the sampling rate corresponding to conditioning learnable layer to be fed is different from the frame rate, the target data 12 may be the same for all the samples of the same frame e.g. at a layer sampling rate. Another up-sampling strategy can also be applied. The target data 12 may be provided to at least one conditioning learnable layer, which is here indicated as having the layer 71, 72, 73 (also see FIG. 3 and also below). The conditioning learnable layer(s) 71, 72, 73 may generate conditions (some of which may be indicated as β, beta, and γ, gamma, or the numbers 74 and 75), which are also called conditioning feature parameters to be applied to the first data 12, and any upsampled data derived from the first data. The conditioning learnable layer(s) 71, 72, 73 may be in the form of matrixes with multiple channels and multiple samples for each frame. The first processing block 40 may include a denormalization (or styling element) block 77. For example, the styling element 77 may apply the conditioning feature parameters 74 and 75 to the first data 15. An example may be element wise multiplication of the values of the first data by the condition β (which may operate as bias) and an addition with the condition γ (which may operate as multiplier). The styling element 77 may produce a first output data 69 sample by sample.

The decoder (audio generator) 10 may include a second processing block 45. The second processing block 45 may combine the plurality of channels of the first output data 69, to obtain the output audio signal 16 (or its precursor the audio signal 44′, as shown in FIG. 4).

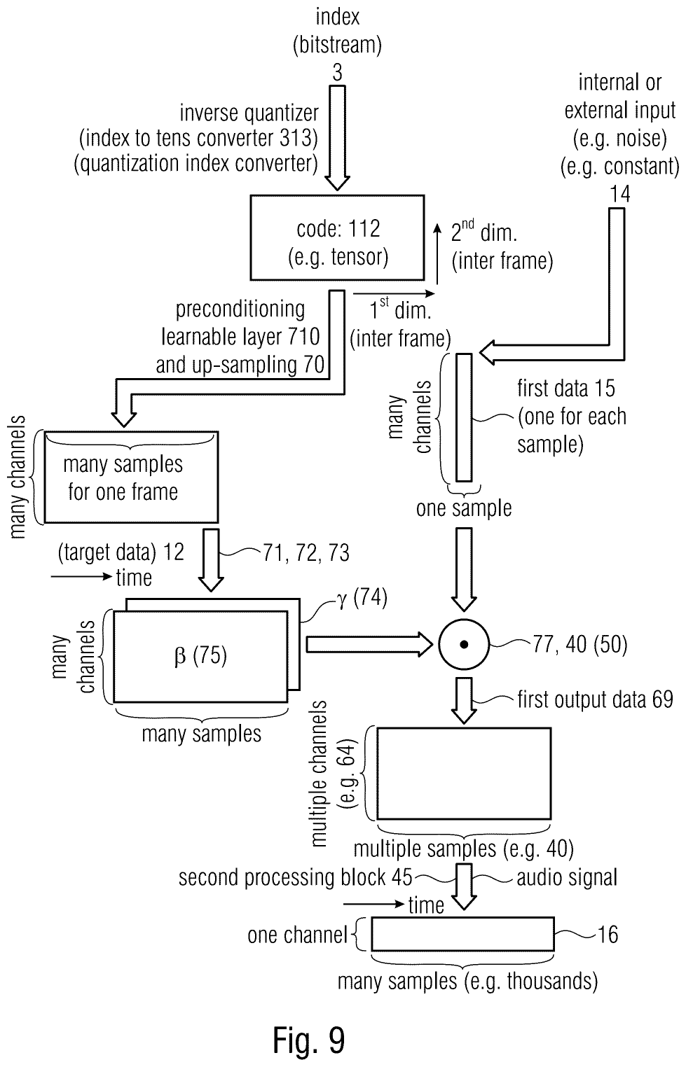

Reference is now mainly made to FIG. 9. A bitstream 3 is subdivided onto a plurality of frames, which are however encoded in the form of indexes (e.g. as obtained from the quantizer 300). From the indexes of the bitstream 3, codes (e.g. scalars, vectors or more in general tensors) 112 are obtained through the quantization index converter 313. First and second dimensions are shown in codes 112 of FIG. 9 (other dimensions may be present). Each frame is subdivided into a plurality of samples in the abscissa direction (first, inter frame dimension). A different terminology may be “frame index” for the abscissa direction (first direction) and “feature map depth”, “latent dimension or coded parameter dimension). In the ordinate direction (second, intra frame dimension), a plurality of channels are provided). The codes 112 may be used by the preconditioning learnable layer(s) 710 (e.g. recurrent learnable layer(s)) to generate target data 12, which may also be in at least two dimensions (e.g. multi-dimensional), such as in the form of a spectrogram (e.g., a mel-spectrogram). Each target data 12 may represent one single frame and the sequence of frames may evolve, in the abscissa direction (from left to right) with time, along the first, inter frame dimension. Several channels may be in the ordinate direction (second, intra frame dimension) for each frame. For example, different coefficients will take place in different entries of each column in association with coefficients associated with the frequency bands. Conditioning learnable layer(s) 71, 72, 73, generate feature parameter(s) 74, 75 (β and γ). The abscissa (second, intra frame dimension) of β and γ is associated to different samples of the same frame, while the ordinate (first, inter frame dimension) is associated to different channels. In parallel, the first data provisioner 702 may provide the first data 15. A first data 15 may be generated for each sample and may have many channels. At the styling element 77 (and more in general, at the first conditioning block 40) the conditioning feature parameters β and γ (74, 75) may be applied to the first data 15. For example, an element-by-element multiplication may be performed between a column of the styling conditions 74, 75 (conditioning feature parameters) and the first data 15 or an evolution thereof. It will be shown that this process may be reiterated many times.

As clear from above, the first output data 69 generated by the first processing block 40 may be obtained as a 2-dimensional matrix (or even a tensor with more than two dimensions) with samples in abscissa (first, inter frame dimension) and channels in ordinate (second, intra frame dimension). Through the second processing block 45, the audio signal 16 may be generated having one single channel and multiple samples (e.g., in a shape similar to the input audio signal 1), in particular in the time domain. More in general, at the second processing block 45, the number of samples per frame (bitrate, also called sampling rate) of the first output data 69 may evolve from a second number of samples per frame (second bitrate or second sampling rate) to a third number of samples per frame (third bitrate or third sampling rate), higher than the second number of samples per frame (second bitrate or second sampling rate). On the other side, the number of channels of the first output data 69 may evolve from a second number of channels to a third number of channels, which is less than the second number of channels. Said in other terms, the bitrate or sampling rate (third bitrate or third sampling rate) of the output audio signal 16 may be higher than the bitrate (or sampling rate) of the first data 15 (first bitrate or first sampling rate) and of the bitrate or sampling rate (second bitrate or second sampling rate) of the first output data 69, while the number of channels of the output audio signal 16 may be lower than the number of channels of the first data 15 (first number of channels) and of the number of channels (second number of channels) of the first output data 69.

The models processing the of coded parameters frame-by-frame by juxtaposing the current frame to the previous frames already in the state are also called streaming or stream-wise models and may be used as convolution maps for convolutions for real-time and stream-wise applications like speech coding.

Examples of convolutions are discussed here below and it can be understood that they may be used at any of the preconditional learnable layer(s) 710 (e.g. recurrent learnable layer(s)), at least one conditional learnable layers 71, 72, 73, and more in general, in the first processing block 40 (50). In general terms, the arriving set of conditional parameters (e.g., for one frame) may be stored in a queue (not shown) to be subsequently processed by the first or second processing block while the first or second processing block, respectively, processes a previous frame.

A discussion on the operations mainly performed in blocks downstream to the preconditioning learnable layer(s) 710 (e.g. recurrent learnable layer(s)) is now provided. We take into account the target data 12 already obtained from the preconditioning learnable layer(s) 710, and which are applied to the conditioning learnable layer(s) 71-73 (the conditioning learnable layer(s) 71-73 being, in turn, applied to the stylistic element 77). Blocks 71-73 and 77 may be embodied by a generator network layer 770. The generator network layer 770 may include a plurality of learnable layers (e.g. a plurality of blocks 50a-50h, see below).

FIG. 7 (and its embodiment in FIG. 4) shows an example of an audio decoder (generator) 10 which can decode (e.g. generate, synthesize) an audio signal (output signal) 16 from the bitstream 3, e.g. according to the present techniques (also called StyleMelGAN). The output audio signal 16 may be generated based on the input signal 14 (also called latent signal and which may be noise, e.g. white noise (“first option”), or which can be obtained from another source. The target data 12 may, as explained above, comprise (e.g. be) a spectrogram (e.g., a mel-spectrogram), the spectrogram (e.g. mel-spectrogram) providing mapping, for example, of a sequence of time samples onto mel scale (e.g. obtained from the preconditioning learnable layer(s) 710). The target data 12 and/or the first data 15 is/are in general to be processed, in order to obtain a speech sound recognizable as natural by a human listener. In the decoder 10, the first data 15 obtained from the input is styled (e.g. at block 77) to have a vector (or more in general a tensor) with the acoustic features conditioned by the target data 12. At the end, the output audio signal 16 will be recognized as speech by a human listener. The input vector 14 and/or the first data 15 (e.g. noise e.g. obtained from an internal or external source) may be, like in FIG. 4, a 128×1 vector (one single sample, e.g. time domain samples or frequency domain samples, and 128 channels) (FIG. 4 shows the input signal 14, to be provided to the channel mapping 30, the first data provisioner 702 not being shown or being considered to be the same as the channel mapping 30). A different length of the input vector 14 could be used in other examples. The input vector 14 may be processed (e.g. under the conditioning of the target data 12 obtained from the bitstream 3 through the preconditioning layer(s) 710) in the first processing block 40. The first processing block 40 may include at least one, e.g. a plurality of, processing blocks 50 (e.g. 50a . . . 50h). In FIG. 4 there are shown eight blocks 50a . . . 50h (each of them is also identified as “TADEResBlock”), even though a different number may be chosen in other examples. In many examples, the processing blocks 50a, 50b, etc. provide a gradual upsampling of the signal which evolves from the input signal 14 to the final audio signal 16 (e.g., at least some processing blocks, e.g. 50a, 50b, 50c, 50d, 50e increases the sampling rate, in such a way that each of them increases the sampling rate (also called bitrate) in output with respect to the sampling rate in its input), while some other processing blocks (e.g. 50f-50h) (e.g. downstream with respect to those (e.g. 50a, 50b, 50c, 50d, 50e) which increase the sampling rate) do not increase the sampling rate (or bitrate). The blocks 50a-50h may be understood as forming one single block 40 (e.g. the one shown in FIG. 7). In the first processing block 40, a conditioning set of learnable layers (e.g., 71, 72, 73, but different numbers are possible) may be used to process the target data 12 and the input signal 14 (e.g., first data 15). Accordingly, conditioning feature parameters 74, 75 (also referred to as gamma, γ, and beta, β) may be obtained, e.g. by convolution, during training. The learnable layer(s) 71-73 may therefore be part of a weight layer of a learning network. As explained above, the first processing block(s) 40, 50 may include at least one styling element 77 (normalization block 77). The at least one styling element 77 may output the first output data 69 (when there are a plurality of processing blocks 50, a plurality of styling elements 77 may generate a plurality of components, which may be added to each other to obtain the final version of the first output data 69). The at least one styling element 77 may apply the conditioning feature parameters 74, 75 to the input signal 14 (latent) or the first data 15 obtained from the input signal 14.

The first output data 69 may have a plurality of channels. The generated audio signal 16 may have one single channel.

The audio generator (e.g. decoder) 10 may include a second processing block 45 (in FIG. 4 shown as including the blocks 42, 44, 46, 110). The second processing block 45 may be configured to combine the plurality of channels (indicated with 47 in FIG. 4) of the first output data 69 (inputted as second input data or second data), to obtain the output audio signal 16 in one single channel, but in a sequence of samples (in FIG. 4, the samples are indicated with 49).

The “channels” are not to be understood in the context of stereo sound, but in the context of neural networks (e.g. convolutional neural networks) or more in general of the learnable units. For example, the input signal (e.g. latent noise) 14 may be in 128 channels (in the representation in the time domain), since a sequence of channels are provided. For example, when the signal has 40 samples and 64 channels, it may be understood as a matrix of 40 columns and 64 rows, while when the signal has 20 samples and 64 channels, it may be understood as a matrix of 20 columns and 64 rows (other schematizations are possible). Therefore, the generated audio signal 16 may be understood as a mono signal. In case stereo signals are to be generated, then the disclosed technique is simply to be repeated for each stereo channel, so as to obtain multiple audio signals 16 which are subsequently mixed.

At least the original input audio signal 1 and/or the generated speech 16 may be a sequence of time domain values. To the contrary, the output of each (or at least one of) the blocks 30 and 50a-50h, 42, 44 may have in general a different dimensionality (e.g. bi-dimensional or other multi-dimensional tensors). In at least some of the blocks 30 and 50a-50e, 42, 44, the signal (14, 15, 59, 69), evolving from the input 14 (e.g. noise or LPC parameters, or other parameters, taken from the bitstream) towards becoming speech 16, may be upsampled. For example, at the first block 50a among the blocks 50a-50h, a 2-times upsampling may be performed. An example of upsampling may include, for example, the following sequence: 1) repetition of same value, 2) insert zeros, 3) another repeat or insert zero+linear filtering, etc.

The generated audio signal 16 may generally be a single-channel signal. In case multiple audio channels are needed (e.g., for a stereo sound playback) then the claimed procedure may be in principle iterated multiple times.

Analogously, also the target data 12 may have multiple channels (e.g. in spectrogram, such as mel-spectrogram), as generated by the preconditioning learnable layer(s) 710. In some examples, the target data 12 may be upsampled (e.g. by a factor of two, a power of 2, a multiple of 2, or a value greater than 2, e.g. by a different factor, such as 2.5 or a multiple thereof) to adapt to the dimensions of the signal (59a, 15, 69) evolving along the subsequent layers (50a-50h, 42), e.g. to obtain the conditioning feature parameters 74, 75 in dimensions adapted to the dimensions of the signal.

If the first processing block 40 is instantiated in multiple blocks (e.g. 50a-50h), the number of channels may, for example, remain at least some of the multiple blocks (e.g., from 50e to 50h and in block 42 the number of channels does not change). The first data 15 may have a first dimension or at least one dimension lower than that of the audio signal 16. The first data 15 may have a total number of samples across all dimensions lower than the audio signal 16. The first data 15 may have one dimension lower than the audio signal 16 but a number of channels greater than the audio signal 16.

Examples may be performed according to the paradigms of generative adversarial networks (GANs). A GAN includes a GAN generator 11 (FIG. 4) and a GAN discriminator 100 (FIG. 10). The GAN generator 11 tries to generate an audio signal 16, which is as close as possible to a real audio signal. The GAN discriminator 100 shall recognize whether the generated audio signal 16 is real or fake. Both the GAN generator 11 and the GAN discriminator 100 may be obtained as neural networks (or other by other learnable techniques). The GAN generator 11 shall minimize the losses (e.g., through the method of the gradients or other methods), and update the conditioning features parameters 74, 75 (and/or the codebook) by taking into account the results at the GAN discriminator 100. The GAN discriminator 100 shall reduce its own discriminatory loss (e.g., through the method of gradients or other methods) and update its own internal parameters. Accordingly, the GAN generator 11 is trained to generate better and better audio signals 16, while the GAN discriminator 100 is trained to recognize real signals 16 from the fake audio signals generated by the GAN generator 11. The GAN generator 11 may include the functionalities of the decoder 10, without at least the functionalities of the GAN discriminator 100. Therefore, in most of the foregoing, the GAN generator 11 and the audio decoder 10 may have more or less the same features, apart from those of the discriminator 100. The audio decoder 10 may include the discriminator 100 as an internal component. Therefore, the GAN generator 11 and the GAN discriminator 100 may concur in constituting the audio decoder 10. In examples where the GAN discriminator 100 is not present, the audio decoder 10 can be constituted uniquely by the GAN generator 11.

As explained by the wording “conditioning set of learnable layers”, the audio decoder 10 may be obtained according to the paradigms of conditional neural networks (e.g. conditional GANs), e.g. based on conditional information. For example, conditional information may be constituted by target data (or upsampled version thereof) 12 from which the conditioning set of layer(s) 71-73 (weight layer) are trained and the conditioning feature parameters 74, 75 are obtained. Therefore, the styling element 77 is conditioned by the learnable layer(s) 71-73. The same may apply to the preconditional layers 710.

The examples at the encoder 2 (or at the audio signal representation generator 20) and/or at the decoder (or more in general audio generator) 10 may be based on convolutional neural networks. For example, a little matrix (e.g., filter or kernel), which could be a 3×3 matrix (or a 4×4 matrix, or 1×1, or less than 10×10 etc.), is convolved (convoluted) along a bigger matrix (e.g., the channel×samples latent or input signal and/or the spectrogram and/or the spectrogram or upsampled spectrogram or more in general the target data 12), e.g. implying a combination (e.g., multiplication and sum of the products; dot product, etc.) between the elements of the filter (kernel) and the elements of the bigger matrix (activation map, or activation signal). During training, the elements of the filter (kernel) are obtained (learnt) which are those that minimize the losses. During inference, the elements of the filter (kernel) are used which have been obtained during training. Examples of convolutions may be used at at least one of blocks 71-73, 61b, 62b (see below), 230, 250, 290, 429, 440, 460. Notably, instead of matrixes, also three-dimensional tensors (or tensors with more than three dimensions) may be used. Where a convolution is conditional, then the convolution is not necessarily applied to the signal evolving from the input signal 14 towards the audio signal 16 through the intermediate signals 59a (15), 69, etc., but may be applied to the target signal 14 (e.g. for generating the conditioning feature parameters 74 and 75 to be subsequently applied to the first data 15, or latent, or prior, or the signal evolving form the input signal towards the speech 16). In other cases (e.g. at blocks 61b, 62b, see below) the convolution may be non-conditional, and may for example be directly applied to the signal 59a (15), 69, etc., evolving from the input signal 14 towards the audio signal 16. Both conditional and non-conditional convolutions may be performed.

It is possible to have, in some examples (at the decoder or at the encoder), activation functions downstream to the convolution (ReLu, TanH, softmax, etc.), which may be different in accordance to the intended effect. ReLu may map the maximum between 0 and the value obtained at the convolution (in practice, it maintains the same value if it is positive, and outputs 0 in case of negative value). Leaky ReLu may output x if x>0, and 0.1*x if x≤0, x being the value obtained by convolution (instead of 0.1 another value, such as a predetermined value within 0.1±0.05, may be used in some examples). TanH (which may be implemented, for example, at block 63a and/or 63b) may provide the hyperbolic tangent of the value obtained at the convolution, e.g.

$$Tan H ( x ) = ( {e}^{x} - {e}^{- x} ) / ( {e}^{x} + {e}^{- x} ) ,$$

with x being the value obtained at the convolution (e.g. at block 61b, see below). Softmax (e.g. applied, for example, at block 64b) may apply the exponential to each element of the elements of the result of the convolution, and normalize it by dividing by the sum of the exponentials. Softmax may provide a probability distribution for the entries which are in the matrix which results from the convolution (e.g. as provided at 62b). After the application of the activation function, a pooling step may be performed (not shown in the figures) in some examples, but in other examples it may be avoided. It is also possible to have a softmax-gated TanH function, e.g. by multiplying (e.g. at 65b, see below) the result of the TanH function (e.g. obtained at 63b, see below) with the result of the softmax function (e.g. obtained at 64b). Multiple layers of convolutions (e.g. a conditioning set of learnable layers, or at least one conditioning learnable layer) may, in some examples, be one downstream to another one and/or in parallel to each other, so as to increase the efficiency. If the application of the activation function and/or the pooling are provided, they may also be repeated in different layers (or maybe different activation functions may be applied to different layers, for example) (this may also apply to the encoder).

At the decoder (or more in general audio generator) 10, the input signal 14 is processed, at different steps, to become the generated audio signal 16 (e.g. under the conditions set by the conditioning set(s) of learnable layer(s) or the learnable layer(s) 71-73, and on the parameters 74, 75 learnt by the conditioning set(s) of learnable layer(s) or the learnable layer(s) 71-73). Therefore, the input signal 14 (or its evolved version, i.e. the first data 15) can be understood as evolving in a direction of processing (from 14 to 16 in FIGS. 4 and 7) towards becoming the generated audio signal 16 (e.g. speech). The conditions will be substantially generated based on the target signal 12 and/or on the preconditions in the bitstream 3, and on the training (so as to arrive at the most advantageous set of parameters 74, 75).

It is also noted that the multiple channels of the input signal 14 (or any of its evolutions) may be considered to have a set of learnable layers and a styling element 77 associated thereto. For example, each row of the matrixes 74 and 75 may be associated to a particular channel of the input signal (or one of its evolutions), e.g. obtained from a particular learnable layer associated to the particular channel. Analogously, the styling element 77 may be considered to be formed by a multiplicity of styling elements (each for each row of the input signal x, c, 12, 76, 76′, 59, 59a, 59b, etc.).

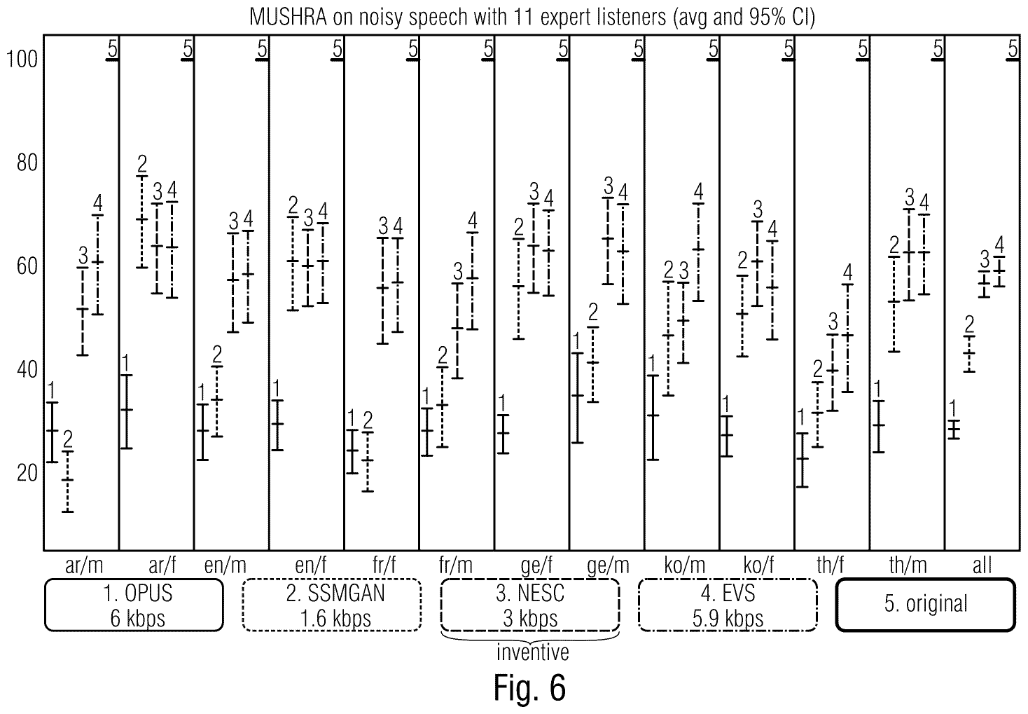

FIG. 4 shows an example of the audio decoder (or more in general audio generator) 10 (which may embody the audio decoder 10 of FIG. 6), and which may also comprise (e.g. be) a GAN generator 11 (see below). FIG. 4 does now show the preconditioning learnable layer 710 (shown in FIG. 7), even though the target data 12 are obtained from the bitstream 3 through the preconditioning layer(s) 710 (see above). The target data 12 may be a mel-spectrogram (or other tensor(s)) obtain from the preconditioning learnable layer 710 (but they may be other kinds of tensor(s)); the input signal 14 may be a latent (prior) noise or a signal obtained from internal or external source, and the output 16 may be speech. The input signal 14 may have only one sample and multiple channels (indicated as “x”, because they can vary, for example the number of channels can be 80 or something else). The input vector 14 may be obtained in a vector with 128 channels (but other numbers are possible). In case the input signal 14 is noise (“first option”), it may have a zero-mean normal distribution, and follow the formula z˜ [symbol] (0, I₁₂₈); it may be a random noise of dimension 128 with mean 0, and with an autocorrelation matrix (square 128×128) equal to the identity I (different choice may be made). Hence, in examples in which the noise is used as input signal 14, it can be completely decorrelated between the channels and of variance 1 (energy). [symbol] (0, I₂₈) may be realized at every 22528 generated samples (or other numbers may be chosen for different examples); the dimension may therefore be 1 in the time axis and 128 in the channel axis. In examples, the input signal 14 may be a constant value.

The input vector 14 may be step-by-step processed (e.g., at blocks 702, 50a-50h, 42, 44, 46, etc.), so as to evolve to speech 16 (the evolving signal will be indicated, for example, with different signals 15, 59a, x, c, 76′, 79, 79a, 59b, 79b, 69, etc.).

At block 30, a channel mapping may be performed. It may consist of or comprise a simple convolution layer to change the number channels, for example in this case from 128 to 64.

Block 30 may therefore be learnable (in some examples, it may be deterministic). As can be seen, at least some of the processing blocks 50a, 50b, 50c, 50d, 50e, 50f, 50g, 50h (altogether embodying the first processing block 50 of FIG. 6) may increase the number of samples by performing an upsampling (e.g., maximum 2-upsampling), e.g. for each frame. The number of channels may remain the same (e.g., 64) along blocks 50a, 50b, 50c, 50d, 50e, 50f, 50g, 50h. The samples may be, for example, the number of samples per second (or other time unit): we may obtain, at the output of block 50h, sound at 16 kHz or more (e.g. 22 Khz). As explained above, a sequence of multiple samples may constitute one frame. Each of the blocks 50a-50h (50) can also be a TADEResBlock (residual block in the context of TADE, Temporal Adaptive DEnormalization). Notably, each block 50a-50h (50) may be conditioned by the target data (e.g., codes, which may be tensors, such as a multidimensional tensor, e.g. with 2, 3, or more dimensions) 12 and/or by the bitstream 3 At a second processing block 45 (FIGS. 1 and 6), only one single channel may be obtained, and multiple samples are obtained in one single dimension (see also FIG. 9). As can be seen, another TADEResBlock 42 (further to blocks 50a-50h) may be used (which reduces the dimensions to four single channels). Then, a convolution layer 44 and an activation function (which may be TanH 46, for example) may be performed. A (Pseudo Quadrature Mirror Filter)-bank) 110 may also be applied, so as to obtain the final 16 (and, possibly, stored, rendered, etc.).

At least one of the blocks 50a-50h (or each of them, in particular examples) and 42, as well as the encoder layers 230, 240 and 250 (and 430, 440, 450, 460), may be, for example, a residual block. A residual learnable block (layer) may operate a prediction to a residual component of the signal evolving from the input signal 14 (e.g. noise) to the output audio signal 16. The residual signal is only a part (residual component) of the main signal evolving form the input signal 14 towards the output signal 16. For example, multiple residual signals may be added to each other, to obtain the final output audio signal 16. Other architectures may be notwithstanding used.

FIG. 3 shows an example of one of the blocks 50a-50h (50). The blocks 50a-50h (50) may be replica with each other, although, when trained, they may result to As can be seen, each block 50 (50a-50h) is inputted with a first data 59a, which is either the first data 15, (or the upsampled version thereof, such as that output by the upsampling block 30) or the output from a preceding block. For example, the block 50b may be inputted with the output of block 50a; the block 50c may be inputted with the output of block 50b, and so on. In examples, different blocks may operate in parallel to each other, and there results are added together. From FIG. 3 it is possible to see that the first data 59a provided to the block 50 (50a-50h) or 42 is processed and its output is the output data 69 (which will be provided as input to the subsequent block). As indicated by the line 59a′, a main component of the first data 59a actually bypasses most of the processing of the first processing block 50a-50h (50). For example, blocks 60a, 900, 60b and 902 and 65b are bypassed by the main component 59a′. The residual component 59a of the first data 59 (15) may be processed to obtain a residual portion 65b′ to be added to the main component 59a′ at an adder 65c (which is indicated in FIG. 3, but not shown). The bypassing main component 59a′ and the addition at the adder 65c may be understood as instantiating the fact that each block 50 (50a-50h) processes operations to residual signals, which are then added to the main portion of the signal. Therefore, each of the blocks 50a-50h can be considered a residual block. The addition at adder 65c does not necessarily need to be performed within the residual block 50 (50a-50h). A single addition of a plurality of residual signals 65b′ (each outputted by each of residual blocks 50a-50h) can be performed (e.g., at one single adder block in the second processing block 45, for example). Accordingly, the different residual blocks 50a-50h may operate in parallel with each other. In the example of FIG. 3, each block 50 (50a-50h) may repeat its convolution layers twice. A first denormalization block 60a and a second denormalization block 60b may be used in cascade. The first denormalization block 60a may include an instance of the stylistic element 77, to apply the conditioning feature parameters 74 and 75 to the first data 59 (15) (or its residual version 59a). The first denormalization block 60a may include a normalization block 76. The normalization block 76 may perform a normalization along the channels of the first data 59 (15) (e.g. its residual version 59a). The normalized version c (76′) of the first data 59 (15) (or its residual version 59a) may therefore be obtained. The stylistic element 77 may therefore be applied to the normalized version c (76′), to obtain a denormalized (conditioned) version of the first data 59 (15) (or its residual version 59a). The denormalization at element 77 may be obtained, for example, through an element-by-element multiplication of the elements of the matrix (or more in general tensor) 7 (which embodies the condition 74) and the signal 76′ (or another version of the signal between the input signal and the speech), and/or through an element-by-element addition of the elements of the matrix (or more in general tensor) β (which embodies the condition 75) and the signal 76′ (or another version of the signal between the input signal and the speech). A denormalized version 59b (conditioned by the conditioning feature parameters 74 and 75) of the first data 59 (15) (or its residual version 59a) may therefore be obtained.

Then, a gated activation 900 may be performed on the denormalized version 59b of the first data 59 (e.g. its residual version 59a). In particular, two convolutions 61b and 62b may be performed (e.g., each with 3×3 kernel and with dilation factor 1). Different activation functions 63b and 64b may be applied respectively to the results of the convolutions 61b and 62b. The activation 63b may be TanH. The activation 64b may be softmax. The outputs of the two activations 63b and 64b may be multiplied by each other, to obtain a gated version 59c of the denormalized version 59b of the first data 59 (or its residual version 59a). Subsequently, a second denormalization 60b may be performed on the gated version 59c of the denormalized version 59b of the first data 59 (or its residual version 59a). The second denormalization 60b may be like the first denormalization and is therefore here not described. Subsequently, a second activation 902 may performed. Here, the kernel may be 3×3, but the dilation factor may be 2. In any case, the dilation factor of the second gated activation 902 may be greater than the dilation factor of the first gated activation 900. The conditioning set of learnable layer(s) 71-73 (e.g. as obtained from the preconditioning learnable layer(s)) and the styling element 77 may be applied (e.g. twice for each block 50a, 50b . . . ) to the signal 59a. An upsampling of the target data 12 may be performed at upsampling block 70, to obtain an upsampled version 12′ of the target data 12. The upsampling may be obtained through non-linear interpolation, and may use e.g. a factor of 2, a power of 2, a multiple of two, or another value greater than 2. Accordingly, in some examples it is possible to have that the spectrogram (e.g. mel-spectrogram) 12′ has the same dimensions (e.g. conform to) the signal (76, 76′, c, 59, 59a, 59b, etc.) to be conditioned by the spectrogram. In examples, the first and second convolutions at 61b and 62b, respectively downstream to the TADE block 60a or 60b, may be performed at the same number of elements in the kernel (e.g., 9, e.g., 3×3). However, the second convolutions in block 902 may have a dilation factor of 2. In examples, the maximum dilation factor for the convolutions may be 2 (two).

As explained above, the target data 12 may be upsampled, e.g. so as to conform to the input signal (or a signal evolving therefrom, such as 59, 59a, 76′, also called latent signal or activation signal). Here, convolutions 71, 72, 73 may be performed (an intermediate value of the target data 12 is indicated with 71′), to obtain the parameters γ (gamma, 74) and β (beta, 75). The convolution at any of 71, 72, 73 may also need a rectified linear unit, ReLu, or a leaky rectified linear unit, leaky ReLu. The parameters γ and β may have the same dimension of the activation signal (the signal being processed to evolve from the input signal 14 to the generated audio signal 16, which is here represented as x, 59, 59a, or 76′ when in normalized form). Therefore, when the activation signal (x, 59, 59a, 76′) has two dimensions, also γ and β (74 and 75) have two dimensions, and each of them is superimposable to the activation signal (the length and the width of γ and β may be the same of the length and the width of the activation signal). At the stylistic element 77, the conditioning feature parameters 74 and 75 are applied to the activation signal (which may be the first data 59a or the 59b output by the multiplier 65a). It is to be noted, however, that the activation signal 76′ may be a normalized version (at instance norm block 76) of the first data 59, 59a, 59b (15), the normalization being in the channel dimension. It is also to be noted that the formula shown in stylistic element 77 (γ*c+β, also indicated with γ⊙c+β in FIG. 3) may be an element-by-element product, and in some examples is not a convolutional product or a dot product. The convolutions 72 and 73 have not necessarily activation function downstream of them. The parameter γ (74) may be understood as having variance values and β (75) as having bias values. It is noted that for each block 50a-50h, 42, the learnable layer(s) 71-73 (e.g. together with the styling element 77) may be understood as embodying weight layers. Also, block 42 of FIG. 4 may be instantiated as block 50 of FIG. 3. Then, for example, a convolutional layer 44 will reduce the number of channels to 1 and, after that, a TanH 46 is performed to obtain speech 16. The output 44′ of the blocks 44 and 46 may have a reduced number of channels (e.g. 4 channels instead of 64), and/or may have the same number of channels (e.g., 40) of the previous block 50 or 42.

A PQMF synthesis (see also below) 110 is performed on the signal 44′, so as to obtain the audio signal 16 in one channel.

In examples, the bitstream (3) may be transmitted (e.g., through a communication medium, e.g. a wired connection and/or a wireless connection), and/or may be stored (e.g., in a storage unit). The encoder 3 and/or the audio signal representation generator 20 may therefore comprise and/or be connected and/or be configured to control transmissions units (e.g., modems, transceivers, etc.) and/or storage units (e.g. mass memories, etc.). In order to permit storage and/or transmission, between the quantizer 300 and the converter 313 there may be other devices that process the bitstream for the purpose of storing and/or transmitting, and reading and/or receiving.

Quantization and Conversion from Indexes onto Codes Using Learnable Techniques

There are here discussed the operations of the quantizer 300 when it is a learnable quantizer and of the quantization index converter 313 (inverse or reverse quantizer) when it is a learnable quantization index converter. It is noted that quantizer 300 may be inputted with a scalar, a vector, or more in general a tensor. The quantization index converter 313 may covert an index onto at least one code (which is taken from a codebook, which may be a learnable codebook). It is to be noted that in some examples the learnable quantizer 300 and the quantization index converter 313 may use a quantization/dequantization which as such deterministic, but uses at least one codebook which is learnable.

Here, the following conventions are used:
x is the speech (or more in general input signal 1)
E(x) is the output (e.g. 269) of the audio signal generator 20, (i.e. x after being processed by the learnable block 200 (DualPathConvRNN) and/or the at least one convolutional learnable block 290 (ConvEncoder), which may be a vector or more in general a tensor
Indexes (e.g. i_{z}, iᵣ, i_{q}) which refer (e.g. point) to codes (e.g. z, r, q) are in at least one codebook (e.g. zₑ, rₑ, qₑ)
The indexes (e.g. i_{z}, iᵣ, i_{q}) are written in the bitstream 3 by the learnable quantizer 300 (or more in general by the encoder 2) and are read by the quantization index converter 313 (or more in general by the audio decoder 10)
A main code (e.g. z) is chosen in such a way to approximate the value E(x)
A first (if present) residual code (e.g. r) is chosen in such a way to approximate the residual E(x)−z
A second (if present) residual code (e.g. q) is chosen in such a way to approximate the residual E(x)−z−r
The decoder 3 (e.g. quantization index converter 313) reads the indexes (e.g. i_{z}, iᵣ, i_{q}) from the bitstream 3, obtains the codes (e.g. z, r, q), and reconstructs a tensor (e.g. a tensor which represents the frame in the first audio signal representation 220 of the first audio signal 1), e.g. by summing the codes (e.g. z+r+q) as tensor 112.
Dithering can be added (e.g. after the tensor 112 is obtained, and/or before the preconditioning layer 710), to avoid potential clustering effect.

The learnable quantizer (300) of the encoder 2 may be configured to associate, to each frame of the first multi-dimensional audio signal representation (e.g., 220) of the input audio signal 1 or another processed version (e.g. 269, 469, etc.) of the input audio signal 1, indexes read in the bitstream 3 to codes of the at least one codebook (e.g. learnable codebook), so as to generate the bitstream 3. The learnable quantizer 300 may associate, to each frame (e.g. tensor) of the first multi-dimensional audio signal representation (e.g. 220) or a processed version of the first multi-dimensional audio signal representation (e.g. as outputted by the block 290) of the input audio signal 1, a code which best approximates the tensor (e.g. a code which minimizes the distance from the tensor) of the codebook, so as to write in the bitstream 3 the index which, in the codebook, is associated to the code which minimizes the distance.

As explained above, the at least one codebook may be defined according to a residual technique. For example there may be:
1) A main (base) codebook zₑ which may be defined as having a plurality of codes, so that a particular code z∈zₑ in the codebook is chosen which is associated to, and/or which approximates, the main portion of the frame E(x) (input vector) outputted by the block 290;
2) An optional first residual codebook rₑ, having a plurality of codes, may be defined, so that a particular code r∈rₑ is chosen which approximates (e.g. best approximates) the residual E(x)−z of the main portion of the input vector E(x);
3) An optional second residual codebook qₑ, having a plurality of codes, may be defined, so that a particular code q∈qₑ is chosen which approximates the first-rank residual E(x)−zₑ−rₑ;
4) Possible optional further lower ranked residual codebooks.

The codes of each learnable codebook may be indexed according to indexes, and the association between each code in the codebook and the index may be obtained by training. What is written in the bitstream 3 is the index for each portion (main portion, first residual portion, second residual portion). For example, we may have:
1) A first index i_{z} pointing at z∈zₑ
2) A second index iᵣ pointing at the first residual r∈rₑ
3) A third index iᵣ pointing at the second residual q∈qₑ

While the codes z, r, q may have the dimensions of the output E(x) of the audio signal representation generator 20 for each frame, the indexes i_{z}, iᵣ, i_{q} may be their encoded versions (e.g., a string of bits, such as 10 bits).

Therefore, at the quantizer 300 there may be a multiplicity of residual codebooks, so that:
the second residual codebook qₑ associates, to indexes to be encoded in the audio signal representation, codes (e.g. scalar, vectors or more in general tensors) representing second residual portions of the first multi-dimensional audio signal representation of the input audio signal,
the first residual codebook rₑ associates, to indexes to be encoded in the audio signal representation, codes representing first residual portions of frames of the first multi-dimensional audio signal representation,
the second residual portions of frames being residual [e.g. low-ranked] with respect to the first residual portions of frames.

Dually, the audio generator 10 (e.g. decoder, or in particular the quantization index converter 313) may perform the reverse operation. The audio generator 10 may have a learnable codebook which may to convert the indexes (e.g. i_{z}, iᵣ, i_{q}) of the bitstream (13) onto codes (e.g. z, r, q) from the codes in the learnable codebook.

For example, in the residual case of above, the bitstream may present, for each frame of the bitstream 3:
1) A main index i_{z} representing a code z∈zₑ for converting from the index (code) i_{z} to the code z, thereby forming a main portion z of the tensor (e.g. vector) approximating E(x)
2) A first residual index (second index) iᵣ representing the code r∈rₑ for converting from the index iᵣ to the code r, thereby forming a first residual portion of the tensor (e.g. vector) approximating E(x)
3) A second residual index (third index) i_{q} representing the code q∈r_{q} for converting from the index i_{q} to the code q, thereby forming a second residual portion of the tensor (e.g. vector) approximating E(x)

Then the code version (tensor version) 112 of the frame may be obtained, for example, as sum z+r+q. Dithering may then be applied to the obtained sum.

It is to be noted that solutions according to the particular kind of quantization can also be used without the implementation of the preconditioning learnable layer 710 being a RNN. This may also apply in the case in which the preconditioning learnable layer 710 is not present or is a deterministic layer.

### GAN Discriminator

The GAN discriminator 100 of FIG. 10 may be used during training for obtaining, for example, the parameters 74 and 75 to be applied to the input signal 12 (or a processed and/or normalized version thereof). The training may be performed before inference, and the parameters (e.g. 74, 75, and/or the at least one learnable codebooks) may be, for example, stored in a non-transitory memory and used subsequently (however, in some examples it is also possible that the parameters 74 or 75 are calculated on line).

The GAN discriminator 100 has the role of learning how to recognize the generated audio signals (e.g., audio signal 16 synthesized as discussed above) from real input signals (e.g. real speech) 104. Therefore, the role of the GAN discriminator 100 is mainly exerted during a training session (e.g. for learning parameters 72 and 73) and is seen in counter position of the role of the GAN generator 11 (which may be seen as the audio decoder 10 without the GAN discriminator 100).

In general terms, the GAN discriminator 100 may be input by both audio signal 16 synthesized generated by the GAN decoder 10 (and obtained from the bitstream 3, which in turn is generated by the encoder 2 from the input audio signal 1), and real audio signal (e.g., real speech) 104 acquired e.g., through a microphone or from another source, and process the signals to obtain a metric (e.g., loss) which is to be minimized. The real audio signal 104 can also be considered a reference audio signal. During training, operations like those explained above for synthesizing speech 16 may be repeated, e.g. multiple times, so as to obtain the parameters 74 and 75, for example.

In examples, instead of analyzing the whole reference audio signal 104 and/or the whole generated audio signal 16, it is possible to only analyze a part thereof (e.g. a portion, a slice, a window, etc.). Signal portions generated in random windows (105a-105d) sampled from the generated audio signal 16 and from the reference audio signal 104 are obtained. For example random window functions can be used, so that it is not a priori pre-defined which window 105a, 105b, 105c, 105d will be used. Also the number of windows is not necessarily four, at may vary.

Within the windows (105a-105d), a PQMF (Pseudo Quadrature Mirror Filter)-bank) 110 may be applied. Hence, subbands 120 are obtained. Accordingly, a decomposition (110) of the representation of the generated audio signal (16) or the representation of the reference audio signal (104) is obtained.

An evaluation block 130 may be used to perform the evaluations. Multiple evaluators 132a, 132b, 132c, 132d (complexively indicated with 132) may be used (different number may be used). In general, each window 105a, 105b, 105c, 105d may be input to a respective evaluator 132a, 132b, 132c, 132d. Sampling of the random window (105a-105d) may be repeated multiple times for each evaluator (132a-132d). In examples, the number of times the random window (105a-105d) is sampled for each evaluator (132a-132d) may be proportional to the length of the representation of the generated audio signal or the representation of the reference audio signal (104). Accordingly, each of the evaluators (132a-132d) may receive as input one or several portions (105a-105d) of the representation of the generated audio signal (16) or the representation of the reference audio signal (104).

Each evaluator 132a-132d may be a neural network itself. Each evaluator 132a-132d may, in particular, follow the paradigms of convolutional neutral networks. Each evaluator 132a-132d may be a residual evaluator. Each evaluator 132a-132d may have parameters (e.g. weights) which are adapted during training (e.g., in a manner similar to one of those explained above).

As shown in FIG. 10, each evaluator 132a-132d also performs a downsampling (e.g., by 4 or by another downsampling ratio). The number of channels may increase for each evaluator 132a-132d (e.g., by 4, or in some examples by a number which is the same of the downsampling ratio).

Upstream and/or downstream to the evaluators, convolutional layers 131 and/or 134 may be provided. An upstream convolutional layer 131 may have, for example, a kernel with dimension 15 (e.g., 5×3 or 3×5). A downstream convolutional layer 134 may have, for example, a kernel with dimension 3 (e.g., 3×3).

During training, a loss function (adversarial loss) 140 may be optimized. The loss function 140 may include a fixed metric (e.g. obtained during a pretraining step) between a generated audio signal (16) and a reference audio signal (104). The fixed metric may be obtained by calculating one or several spectral distortions between the generated audio signal (16) and the reference audio signal (104). The distortion may be measured by keeping into account:
magnitude or log-magnitude of the spectral representation of the generated audio signal (16) and the reference audio signal (104), and/or
different time or frequency resolutions.

In examples, the adversarial loss may be obtained by randomly supplying and evaluating a representation of the generated audio signal (16) or a representation of the reference audio signal (104) by one or more evaluators (132). The evaluation may comprise classifying the supplied audio signal (16, 132) into a predetermined number of classes indicating a pretrained classification level of naturalness of the audio signal (14, 16). The predetermined number of classes may be, for example, “REAL” vs “FAKE”.

Examples of losses may be obtained as

$$ℒ ( D ; G ) = {E}_{x , z} [ R e L U ( 1 - D ( x ) ) + ReLU ( 1 + D ( G ( z ; s ) ) ) ] ,$$

where:
x is the real speech 104,
z is the latent input 14 (which may be noise or another input obtained from the bitstream 3),
s is the tensor representing x (or more in general the target signal 12).
D( . . . ) is the output of the evaluators in terms of distribution of probability (D( . . . )=0 meaning “for sure fake”, D( . . . )=1 meaning “for sure real”).

The spectral reconstruction loss [symbol] _{rec} is still used for regularization to prevent the emergence of adversarial artifacts. The final loss is can be, for example:

$$ℒ = \frac{1}{4} {\sum }_{i = 1}^{4} ℒ ( {D}_{i} ; G ) + {ℒ}_{rec} .$$

where each i is the contribution at each evaluator 132a-132d (e.g. each evaluator 132a-132d providing a different Di) and [symbol] _{rec} is the pretrained (fixed) loss.

During training session, there is a search for the minimum value of [symbol] , which may be expressed for example as

$${min}_{G} ( {E}_{z} [ {\sum }_{i = 1}^{4} - {D}_{i} G ( s , z ) ] + {ℒ}_{rec} )$$

Other kinds of minimizations may be performed.

In general terms, the minimum adversarial losses 140 are associated to the best parameters (e.g., 74, 75) to be applied to the stylistic element 77.
1) It is to be noted that the training session, also the encoder 2 (or at least the audio signal representation generator 20) may be trained together with the decoder 10 (or more in general audio generator 10). Therefore, together with the parameters of the decoder 10 (or more in general audio generator 10), also the parameter of the encoder 2 (or at least the audio signal representation generator 20) may be obtained. In particular, at least one of the following may be obtained by training: The weights of the learnable layers 230, 250 (e.g., kernels)
2) The weights of the recurrent learnable layer 240
3) The weights of the learnable block 290, including the weights (e.g., kernels) of the layers 429, 440, 460
4) The codebook(s) (e.g. at least one of zₑ, rₑ, qₑ) to be used by the learnable quantizer 300 (dually to the codebook(s) of the quantization index converter 313).

A general way to train the encoder 2 and the decoder 10 one together with the other is to use a GAN, in the discriminator 100 shall discriminate between:
audio signals 16 generated from frames in the bitstreams 3 actually generated by the encoder 1; and
audio signals 16 generated from frames in bitstreams non-generated by the encoder 1.

### Generation of the at Least One Codebook

With particular attention to the codebook(s) (e.g. at least one of zₑ, rₑ, qₑ) to be used by the learnable quantizer 300 and/or by the quantization index converter 313, it is noted that there may be different way of defining the codebook(s).

During the training session a multiplicity of bitstreams 3 may be generated by the learnable quantizer 300 and are obtained by the quantization index converter 313. Indexes (e.g. i_{z}, iᵣ, i_{q}) are written in the bitstreams (3) to encode known frames representing known audio signals. The training session may include an evaluation of the generated audio signals 16 at the decoder 2 in respect to the known input audio signals 1 provided to the encoder 2: associations of indexes of the at least one codebook are adapted with the frames of the encoded bitstreams [e.g. by minimizing the difference between the generated audio signal 16 and the known audio signals 1].

In the cases in which a GAN is used, the discriminator 100 shall discriminate between:
audio signals 16 generated from frames in the bitstreams 3 actually generated by the encoder 1; and
audio signals 16 generated from frames in bitstreams non-generated by the encoder 1.

Notably, during the training session it is possible to define the length of the indexes (e.g., 10 bits instead of 15 bits) for each index. The training may therefore provide at least:
a multiplicity of first bitstreams (e.g. generated by the encoder 2) with first candidate indexes having a first bitlength and being associated with first known frames representing known audio signals, the first candidate indexes forming a first candidate codebook, and
a multiplicity of second bitstreams with second candidate indexes having a second bitlength and being associated with known frames representing the same first known audio signals, the second candidate indexes forming a second candidate codebook.

The first bitlength may be higher than the second bitlength [and/or the first bitlength has higher resolution but it occupies more band than the second bitlength]. The training session may include an evaluation of the generated audio signals obtained from the multiplicity of the first bitstreams in comparison with the generated audio signals obtained from the multiplicity of the second bitstreams, to thereby choose the codebook [e.g. so that the chosen learnable codebook is the chosen codebook between the first and second candidate codebooks] [for example, there may be an evaluation of a first ratio between a metrics measuring the quality of the audio signal generated from the multiplicity of first bitstreams in respect to the bitlength vs a second ratio between a metrics measuring the quality of the audio signal generated from the multiplicity of second bitstreams in respect to the bitrate (also called sampling rate), and to choose the bitlength which maximizes the ratio] [e.g. this can be repeated for each of the codebooks, e.g. the main, the first residual, the second residual, etc.]. The discriminator 100 may evaluate whether the outputs signal 16 generated using the second candidate codebook with low bitlength indexes appear to be similar to outputs signal 16 generated using fake bitstreams 3 (e.g. by evaluating a threshold of the minimum value of [symbol] and/or an error rate at the discriminator 100), and in positive case the second candidate codebook with low bitlength indexes will be chosen; otherwise, the first candidate codebook with high bitlength indexes will be chosen.

In addition or alternative, the training session may performed by using:
a first multiplicity of first bitstreams with first indexes associated with first known frames representing known audio signals, wherein the first indexes are in a first maximum number, the first multiplicity of first candidate indexes forming a first candidate codebook; and
a second multiplicity of second bitstreams with second indexes associated with known frames representing the same first known audio signals, the second multiplicity of second candidate indexes forming a second candidate codebook, wherein the second indexes are in a second maximum number different from the first maximum number.

The training session may include an evaluation of the generated audio signals 16 obtained from the first multiplicity of the first bitstreams 3 in comparison with the generated audio signals 16 obtained from the second multiplicity of the second bitstreams 3, to thereby choose the learnable indexes [e.g. so that the chosen learnable codebook is chosen among the first candidate codebook and the second candidate codebook] [for example, there may be an evaluation of a first ratio between a metrics measuring the quality of the audio signal generated from the first multiplicity of first bitstreams vs a second ratio between a metrics measuring the quality of the audio signal generated from the second multiplicity of second bitstreams in respect to the bitrate (or sampling rate), and to choose the multiplicity, among the first multiplicity and second multiplicity, which maximizes the ratio] [e.g. this can be repeated for each of the codebooks, e.g. the main, the first residual, the second residual, etc.]. In this second case, the different candidate codebooks have different numbers of codes (and indexes pointing to the codes), and the discriminator 100 may evaluate whether the low-number-of-codes is needed or the high-number-of codes is needed (e.g., by evaluating a threshold of the minimum value of [symbol] and/or an error rate at the discriminator 100).

In some cases, it is possible to decide which resolution to use (e.g., how many low-ranked codebook to use). This may be obtained, for example, by using:
a first multiplicity of first bitstreams with first indexes representing codes obtained from known audio signals, the first multiplicity of first bitstreams forming at least one first codebook [e.g. at least one main codebook zₑ]; and
a second multiplicity of second bitstreams including both the first indexes representing main codes obtained from known audio signals and second indexes representing residual codes in respect to the main codes, the second multiplicity of second bitstreams forming the at least one first codebook [e.g. at least one main codebook zₑ] and at least one second codebook [e.g. at least one residual codebook rₑ].

The training session may include an evaluation of the generated audio signals obtained from the first multiplicity of the first bitstreams in comparison with the generated audio signals obtained from the second multiplicity of the second bitstreams. The discriminator 100 may choose among using:
only a low resolution encoding (e.g., only main codes) having only the first multiplicity [and/or the first candidate codebook zₑ] and t
he second multiplicity [and/or the first candidate codebook zₑ as main codebook, together with the at least one second codebook used as residual codebook rₑ] [e.g. so that the chosen learnable codebook is chosen among the first candidate codebook and the second candidate codebook](the use of the second multiplicity may mean to also use more low-ranked residual codebooks with respect to the first multiplicity).

[for example, there may be an evaluation of a first ratio between a metrics measuring the quality of the audio signal generated from the first multiplicity of first bitstreams vs a second ratio between a metrics measuring the quality of the audio signal generated from the second multiplicity of second bitstreams in respect to the bitrate (or sampling rate), and to choose the multiplicity, among the first multiplicity and second multiplicity, which maximizes the ratio] [e.g. this can be repeated for each of the codebooks, e.g. the main, the first residual, the second residual, etc.].

In some examples, the discriminator 100 will choose the low-resolution multiplicity (e.g., only the main codebook) by evaluating a threshold of the minimum value of [symbol] and/or an error rate, or otherwise the second multiplicity (high resolution, but also high payload in the bitstream) is needed.

### Recurrent Learnable Layer

The learnable layer 240 of the encoder (e.g. audio signal representation generator 20) may be of the recurrent type (the same may apply to the preconditioning learnable layer 710). In this case, the output of the learnable layer 240 and/or preconditioning learnable layer 710 for each frame may be conditioned by the output of the previous frame. For example, for each t-th frame, the output of the learnable layer 240 may be f(t, t−1, t−2, . . . ) wherein the parameters of the function f( ) may be obtained by training. The function f( ) may be linear or non-linear (e.g., a linear function with an activation function). For example, there may be weights W0, W1 and W2 (with W0, W1 and W2 obtained by training) so that, if the output 240 for the frame t−1 is Fₜ₋₁ and for the frame t−2 is Fₜ₋₂ then the output Fₜ for the frame t is Fₜ=W0*Fₜ₋₁+W1*Fₜ₋₂+W2*Fₜ₋₃, and the output Fₜ₊₁ for the frame t+1 is Fₜ₊₁=W0*Fₜ+W1*Fₜ₋₁+W2*Fₜ₋₂. Hence the output Fₜ of the learnable layer 240 for a given frame t may be conditioned by at least one previous frame (e.g. t−1, t−2, etc.) e.g. before (e.g. immediately before) the given frame t. In some cases, the output value of the learnable layer 240 for the given frame t may be obtained through a linear combination (e.g., through the weights W0, W1 and W2) of the previous frames (e.g. immediately) preceding the given frame t.

Notably, each frame may have some samples obtained from the immediately preceding frame, and this simplifies the operations.

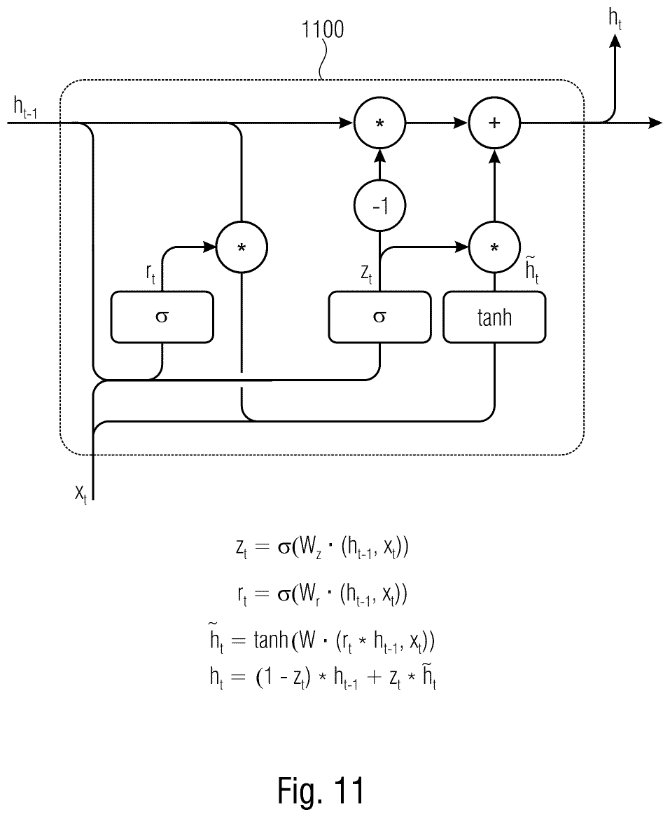

In examples, a GRU may operate in this way. Other types of GRUs may be used. FIG. 11 shows an example of GRU which may be used (e.g. in the layer 240 and/or in the preconditioning learnable layer 710).

In general terms, a recurrent learnable layer (e.g. a GRU, which may be a RNN) may be seen as a learnable layer having states, so as each time step is conditioned, not only by the output, but also by the state of the immediately preceding time step. Therefore, the recurrent learnable layer may be understood as being unrollable in a plurality of feedforward modules (each corresponding to a time step), in such a way that each feedforward module inherits the state from the immediately preceding feedforward module (while the first feedforward module may be inputted with a default state).

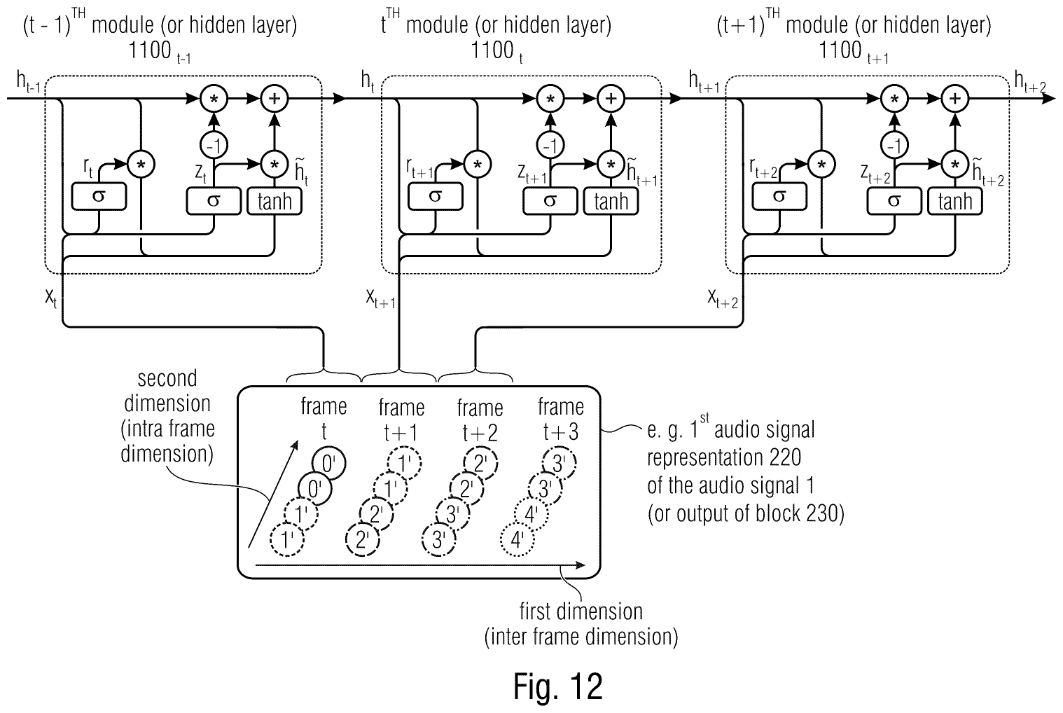

In FIG. 11, one single GRU 1100 is shown. The GRU (or a cascade of GRUs) may form, for example, the learnable layer 240 of the encoder and/or of the preconditioning learnable layer 710 of the decoder. We can note in FIG. 12 that a single GRU or recurrent unit 1100 can be unrolled in feedforward modules (1100ₜ₋₁, 1100ₜ, 1100ₜ₊₁, etc.) removing the backward path of it. In this case the t^{th} module of the GRU follows the (t−1)^{th} (accept its output state as input) module and precedes the (t+1)^{th} module by conveying its state.

Alternatively, a cascade of recurrent modules can be used (like in FIG. 12) wherein each GRU or recurrent unit will maintain independently its own states. In this case GRUs may be built one over the other and this time the output of one GRU is conveyed to the input of the next GRU. Another alternative could be to also connect the states between the cascaded recurrent units with mechanisms such an attention.

The relationships may be governed, for example, by formulas such as at least one of the following:

$$\begin{matrix}{z}_{t} = σ ( {W}_{z} \cdot ( {h}_{t - 1} , {x}_{t} ) ) \\ {r}_{t} = σ ( {W}_{r} \cdot ( {h}_{t - 1} , {x}_{t} ) ) \\ {\tilde{h}}_{t} = tanh ( W \cdot ( {r}_{t} * {h}_{t - 1} , {x}_{t} ) ) \\ {h}_{t} = ( 1 - {z}_{t} ) * {h}_{t - 1} + {z}_{t} * {\tilde{h}}_{t}\end{matrix}$$

where:
t refers to the time instant/step, and in case of unrolled GRUs, refers also to the particular module in the unrolled structure (e.g. t=0 is the first module, first time instant, t=1 the second, and so on);
xₜ refers to the input vector of the recurrent module at instant t (e.g. to the frame at the time t, e.g. with or without the samples taken from the (e.g. immediately) preceding frame and/or with or without the samples taken from the (e.g. immediately) preceding frame);
hₜ refers to the state and output at instant t of the recurrent unit, which will be inherited by the (t+1)^{th} feedforward module in the unrolled case (with reference to FIG. 11, hₜ is reintroduced in feedback as hₜ₋₁, see below; with reference to FIG. 12, hₜ is provided to the immediately subsequent feedforward module);
hₜ₋₁ refers to the state and output at time step t−1, which is the input of the unit at instant t. In case of unrolled GRU (FIG. 12), hₜ₋₁ is an input of t^{th} feedforward module (i.e., either the output of the immediately preceding recurrent module, or the input of the GRU) (if the t^{th} module is the first module, then hₜ₋₁ will be a default value);
[symbol] refers to a candidate state and/or output of the recurrent module;
zₜ refers to an update gate vector;
rₜ refers to a reset gate vector;
W, W_{z}, Wᵣ, and b refer to learnable parameters (e.g., matrixes) obtained by training;
σ (e.g., sigmoid function) and tanH are activation functions (different activation functions may be chosen);
the operator “*” is an element-wise product;
the operator “·” is a vector/matrix product;
the comma indicates concatenation.

The output hₜ of the t^{th} module/time step may be obtained by summing [symbol] (weighted on the update gate vector zₜ) with hₜ₋₁ (weighted on the complement to one of the update gate vector zₜ). The candidate output [symbol] may be obtained by applying the weight parameter W (e.g. through matrix/vector multiplication) to both the element-wise product between the reset gate vector rₜ and hₜ₋₁ concatenated with input xₜ, followed by applying an activation function (e.g. tanH). The update gate vector zₜ may be obtained applying the parameter W_{z} (e.g. through matrix/vector multiplication) to both hₜ₋₁ and the input xₜ, followed by applying an activation function (e.g., sigmoid, σ). The reset gate vector rₜ may be obtained by applying the parameter Wᵣ (e.g. through matrix/vector multiplication) to both hₜ₋₁ and the input xₜ, followed by applying an activation function (e.g., sigmoid, σ).

In general terms:
the update gate vector [zₜ] may be seen as providing information on both how much is to be taken from the candidate state and/or output and how much is to be taken from the state and/or output [hₜ₋₁] of the preceding time step. E.g. if zₜ=0, the state and/or output for the current time instant is only taken from the state and/or output [hₜ₋₁] of the preceding time step; while if the zₜ=1, the the state and/or output for the current time instant is only taken from the candidate vector]; and/or
the reset gate vector [rₜ] may be understood as giving information on how much the state and/or output [hₜ₋₁] of the preceding time step shall be reset] [if rₜ=0, we reset everything and we keep nothing from hₜ₋₁, while if rₜ is higher, then we keep more from hₜ.].

Notably, the candidate state and/or output [symbol] keeps into account the input xₜ of the current time instant, while the state and/or output hₜ₋₁ at time step t−1 does not keep into account the input xₜ of the current time instant. Hence:
the higher the update gate vector [zₜ](e.g. zₜ having all the components equal to 1, or closer to 1), the less the state and/or output hₜ₋₁ at time step t−1 will be taken into account for generating the current state and/or output hₜ, and
the lower the update gate vector [zₜ](e.g. zₜ having all the components equal to 0, or closer to 0), the more the state and/or output hₜ₋₁ at time step t−1 will be taken into account for generating the current state and/or output hₜ.

Further, when generating the candidate state and/or output [symbol] , the reset gate vector [rₜ] may be taken into account:
the higher the reset gate vector [rₜ](e.g. all the elements of rₜ being 1 or closer to 1), the higher the more relevant the state and/or output hₜ₋₁ at time step t−1 will be for generating the current state and/or output hₜ, and
the lower the reset gate vector [rₜ](e.g. all the elements of rₜ being 0 or closer to 0), the less relevant will the state and/or output hₜ₋₁ at time step t−1 will be for generating the current state and/or output hₜ.

In the present examples, at least one of the weight parameters W, W_{z}, Wᵣ (obtained by training) may be the same for different time instants and/or modules (but in some examples.

The input of each t1 time step or feedforward module is in general indicated with xₜ but refers to:
1) at the GRU 240 of the encoder, the particular frame in the first audio signal representation 220 of the audio signal 1 (or a processed version thereof, e.g., the output of the convolutional learnable layer 230);
2) at the preconditioning learnable layer 710 of the decoder, the codes, tensors, vectors, etc. as obtained from the bitstream 3 (e.g., as outputted by the quantization index converter 313).

The output of each t^{th} time step or feedforward module may be the state hₜ. Therefore hₜ (or a processed version thereof) may be:
1) at the encoder, the output of the GRU 240, provided to the convolutional learnable layer 250;
2) at the encoder, the output of the preconditioning learnable layer 710, e.g. constituting the target data 15, to be provided, to the conditioning learnable layer(s) 71-73

In the present discussion it is often imagined that, for each time step and/or module, the state is the same of the output. This is why we have used the term hₜ₋₁ for indicating both the state and the output of each time step and/or module. However, this is not strictly necessary: the output of each time step and/or module may be in principle different from the state which is inherited by the subsequent time step and/or module. For example, the output of each time step and/or module may be a processed version of the state of the time step and/or module, or vice versa.

There are many other ways of making a recurrent learnable layer, and the GRU is not the only one technique to be used. It is notwithstanding advantageous to have a learnable layer which keeps also into account, for each time instant and/or module, the state and/or the output of the preceding time instant and/or module. It has been understood that, accordingly, vocoder techniques are advantaged. Each time instant, indeed, is generated by also taking into account the preceding time instant, and this greatly advantages operations like encoding and decoding (in particular encoding and decoding voice).

Instead of a GRU, we may also use for the recurrent learnable layer a long/short-term memory (LSTM) recurrent learnable layer, or “delta differences”.

The learnable layers discussed here can be, for example, neural networks (e.g. recurrent neural networks and/or GANs).

In general terms, in a recurrent learnable layer also the relevance of the preceding time instants is subjected to training, and this is a great advantage of such a technique.

### DISCUSSION

Neural networks have proven to be a formidable tool to tackle the problem of speech coding at very low bit rates. However, the design of a robust neural coder that can be operated robustly under real-world conditions remains a major challenge. Therefore, we present Neural End-2-End Speech Codec (NESC) (or more in general in the present examples) a robust, scalable end-to-end neural speech codec for high quality wide band speech coding at 3 kbps. The encoder of NESC (or more in general in the present examples), uses a new architecture configuration, which relies on our proposed Dual-PathConvRNN (DPCRNN) layer, and the decoder architecture is based on our previous work Streamwise-StyleMelGAN [1]. Our subjective listening tests show that NESC (or more in general in the present examples), is particularly robust to unseen conditions and noise, moreover, its computational complexity makes it suitable for deployment on end-devices.

Index Terms: neural speech coding, Gan, quantization

### 1. INTRODUCTION

Very low bit rate speech coding is particularly challenging when using classical techniques. The usual paradigm employed is parametric coding, since it yields intelligible speech, the achievable audio quality however is poor, and the synthesized speech sounds unnatural. Recent advances in neural networks are filling this gap, enabling speech coding of high-quality speech at very low bit rates.

We categorize the possible approaches to solving this problem according to the role played by the neural networks.
level 1 post-filtering: encoder and decoder are conventional, and a neural network is added after the decoder, in a post-processing step, in order to enhance the coded speech. This enables the enhancing of existing communication systems with minimal effort.
level 2 neural decoder: the encoder is classical and the speech is decoded using a neural network conditioned on the bitstream. This enables backward compatible decoding of existing bitstreams.
level 3 end-2-end: both encoder and decoder are neural networks, which are trained jointly. The input of the encoder is the speech waveform and possibly the quantization is jointly learned, hence obtaining directly the optimal bitstream for the signal.

Level 1 approaches such as [2, 3, 4, 5, 6] are minimally invasive, as they can be deployed over existing pipelines. Unfortunately they still suffer typical unpleasant artifacts, which are especially challenging.

The first published level 2 speech decoder was based on WaveNet [7], and served as a proof of concept. Several follow-up works [8, 9] improved quality and computational complexity, and [10] presented LPCNet, a low complexity decoder which synthesizes good quality clean speech at 1.6 kbps. We have shown in our previous work [1] that the same bitstream used in LPCNet can be decoded using a feed-forward GAN model, which provides significantly better quality.

All of these models produce high-quality clean speech, but are not 100% robust in the presence of noise and reverberation. Lyra [11] was the first model to directly tackle this problem. Its robustness for more general modes of speech was enforced via the use of variance regulation and a new bitstream still encoded in a classical way. Overall it seems that the generalization capabilities and the quality of level 2 models are partly weakened by the limitations of the classical representation of speech at the encoder side.

Many approaches tackling the problem from the perspective of a level 3 solution were proposed [12, 13, 14, 15], but these models usually do not target very low bit rates.

The first fully end-to-end approach which works at low bit rates and is robust under many different noise perturbations was SoundStream [16]. The architecture at the core of SoundStream is a convolutional U-Net-like encoder decoder, with no skip connections, and using a residual quantization layer in the middle. According to the authors' evaluation SoundStream is stable under a wide range of real-life coding scenarios. Moreover, it permits to synthesize speech at bit rates ranging from 3 kbps to 12 kbps. Finally, SoundStream works at 24 kHz, implements a noise reduction mode, and can also code music. More recently the work [17] presents another level 3 solution using a different set of techniques.

We present NESC (or more in general in the present examples) a new model capable of robustly coding wideband speech at 3 kbps. The architecture behind NESC (or more in general in the present examples) is fundamentally different from SoundStream and is the main aspects of novelty of our approach. The encoder architecture is based on our proposed DPCRNN, which uses a sandwich of convolutional and recurrent layers to efficiently model intra-frame and inter-frame dependencies. The DPCRNN layer is followed by a series of convolutional residual blocks with no downsampling and by a residual quantization. The decoder architecture is composed of a recurrent neural network followed by the decoder of Streamwise-StyleMelGAN (SSMGAN [1]).

Using data augmentation we can achieve robustness against a wide range of different types of noises and reverberation. We extensively test our model with many types of signal perturbations and unseen speakers as well as unseen languages. Moreover, we visualize some clustering behaviour shown by the latent and learned in an unsupervised way.

Contributions are inter alia the following:
We introduce NESC (or more in general in the present examples) a new end-to-end neural codec for speech.
We present the DPCRNN layer, which offers an efficient way of exploiting intra and inter-frame dependecies, for learning a latent representation suitable for quantization.
We analyze some interesting clustering behaviour exhibited by the NESC's quantized latent.
We show NESC's robustness against many types of noise and reverberation scenarios, via objective and subjective evaluations.

### 2. PROPOSED ARCHITECTURE

As illustrated in FIG. 1, the proposed model consists of a learned encoder, a learned quantization layer and a recurrent pre-net fol-lowed by a SSMGAN decoder.

The encoder architecture may count, for example, 2.09 M parameters, whereas the decoder may have 3.93 M parameters. The encoder rarely reuses the same parameters in computation, as we hypothesize that this favors generalization. It may run around 40× faster than real time on a single thread of an Intel® Core™ i7-6700 CPU at 3.40 GHz. The decoder may run around 2× faster than real time on the same architecture, despite only having double as many parameters as the encoder. Our implementations and de-sign are not even optimized for inference speed.

Our proposed model consists or comprises of a learned encoder, a learned quantization layer and a recurrent prenet followed by a SSMGAN decoder ([1]). For an overview of the model see FIG. 1.

### 2.1. Encoder (or Audio Signal Representation Generator)

The encoder architecture may rely on our newly proposed DPCRNN, which was inspired by [18]. This layer consists of or in particular comprises a rolling window operation format at definer 210 followed by a 1×1-convolution, a GRU, and finally another 1×1-convolution (respectively, 230, 240, 250). The rolling window transform reshapes the input signal of shape [1, t] into a signal of shape [s, f], where s is the length of a frame and f is the number of frames. We may use frames of 10 ms with 5 ms from the past frame and 5 ms lookahead. For 1 s of audio at 16 kHz this results in s=80+160+80=320 samples and f=100. The 1×1-convolutional layers (e.g. at 230 and/or 250) then model the time dependencies within each frames, i.e. intra-frame dependencies, whereas the GRU model (e.g. at 240) the dependencies between different frames, i.e. inter-frame dependencies. This approach allows us to avoid downsampling via strided convolutions or interpolation layers, which in early experiments were shown to strongly affect the final quality of the audio synthesized by SSMGAN [1].

The rest of the encoder architecture (at block 290) consists of (or in particular comprises) 4 residual blocks each a 1d-convolution with kernel size 3 followed by a 1×1-convolution and activated via LeakyReLUs. The use of the DPCRNN allows for a compact and efficient way to model the temporal dependencies of the signal, hence making the use of dilation or other tricks for extending the receptive field of the residual blocks unnecessary.

### 2.2. Quantization

The encoder architecture (at block 290) produces a latent vector of dimension 256 for each packet of 10 ms. This vector is then quantized using a learned residual vector quantizer based on Vector-Quantized VAE (VQ-VAE) [19] as in [16]. In a nutshell, this quantizer learns multiple codebooks on the vector space of the encoder latent packets. The first codebook approximates the latent output of the encoder z=E(x) via the closest entry of the codebook zₑ. The second codebook does the same on the “residual” of the quantization, i.e. on z−zₑ, and so on for the following codebooks. This technique is well known in classical coding, and permits to effectively use the vector space structure of the latent to code many more points in the latent space than the trivial union of the codebooks would allow.

In NESC (or more in general in the present examples), we use a residual quantizer with three codebooks each at 10 bits to code a packet of 10 ms, hence resulting in a total of 3 kbps.

Even though we did not train for this, at inference time it is possible to drop one or two of the codebooks and still retrieve a distorted version of the output. NESC (or more in general in the present examples), is then scalable at 2 kbps and 1 kbps.

### 2.3. Decoder

The decoder architecture that we use is composed of a recurrent neural network followed by a SSMGAN decoder [1]. We use a single non-causal GRU layer as a prenet in order to pre-pare the bitstream before feeding it to the SSMGAN decoder [1]. This provides better conditioning information for the Temporal Adaptive DEnormalization layers, which constitute the working horse of SSMGAN [1]. We do not apply significant modifications to the SSMGAN decoder [1], except for the use of a constant prior signal and the conditioning provided by the 256 latent channels. We refer to [1] for more details on this architecture. Briefly, this is a convolutional decoder which is based on TADE (also known as FiLM) conditioning and softmax-gated tanh activations. It upsamples the bit stream with very low upsampling scales and provides the conditioning information at each layer of upsampling.

It outputs four Pseudo Quadrature Mirror Filterbank (PQMF) subbands, which are then synthesized using a synthesis filter. This filter has 50 samples of lookahead, effectively introducing one frame of delay in our implementation. The total delay of our system is then 25 ms, 15 ms from the encoder and the framing and 10 ms from the decoder.

### 3. EVALUATION

### 3.1. Experimental Setup

We trained NESC (or more in general in the present examples) on the complete LibriTTS Dataset [20] at 16 kHz which comprises around 260 hours of speech. We augmented the dataset with reverberation and background noise addition. More precisely, we augment a clean sample coming from LibriTTS by adding background noise coming from the DNS Noise Challenge Dataset [21] at a random SNR between 0 dB and 50 dB, and then convolved via real or generated room impulse responses (RIRs) from the SLR28 Dataset [22].

The training of NESC (or more in general in the present examples) is very similar to the training of SSMGAN [1] as described in [1]. We first pretrain encoder and decoder together having the spectral reconstruction loss of [23] and the MSE loss as objective for around 500 k iterations. We then turn on the adversarial loss and the discriminator feature losses from [24] and train for another 700 k iterations, beyond that, we have not seen substantial improvements. The generator is trained on audio segments of 2 s with batch size 64. We use an Adam [25] optimizer with learning rate 1·10⁻⁴ for the pretraining of the generator, and bring down the learning rate to 5·10⁻⁵ as soon as the adversarial training starts. We use an Adam optimizer with learning rate 2·10⁻⁴ for the discriminator.

### 3.2. Complexity

We report the computational complexity estimates in the following table.

TABLE 1
Complexity Estimation

| | | |
|---|---|---|
| Model | Encoder Complexity | Decoder Complexity |

| | | | | |
|---|---|---|---|---|
| SSMGAN | 0.05 | GMACs | 4.56 | GMACS |
| SoundStream | 5 | GMACs | 5 | GMACs |
| NESC | 0.5 | GMACs | 7 | GMACs |

Our implementation runs faster than real time on a single thread of an Intel® Core™ i7-6700 CPU at 3.40 Ghz

### 3.3. Qualitative Statistical Analysis of the Latent

We provide a qualitative analysis of the distribution of the latent in order to give a better understanding of its behaviour in practice. The quantized latent frames are embedded in a space of dimension 256 hence in order to plot their distribution we use their t-SNE projections. For each experiment we first encode 10 s of audio with different recording conditions and we label each frame depending on a priori information regarding its acoustic and linguistic characteristics. Each subplot represent a different set of audio randomly selected from the LibriTTS, VCTK and NTT Datasets. Afterwards we look for clusterings in the low dimensional projections. Notice that the model is not trained with any clustering objective, hence any such behaviour shown at inference time is an emergent aspect of the training set up.

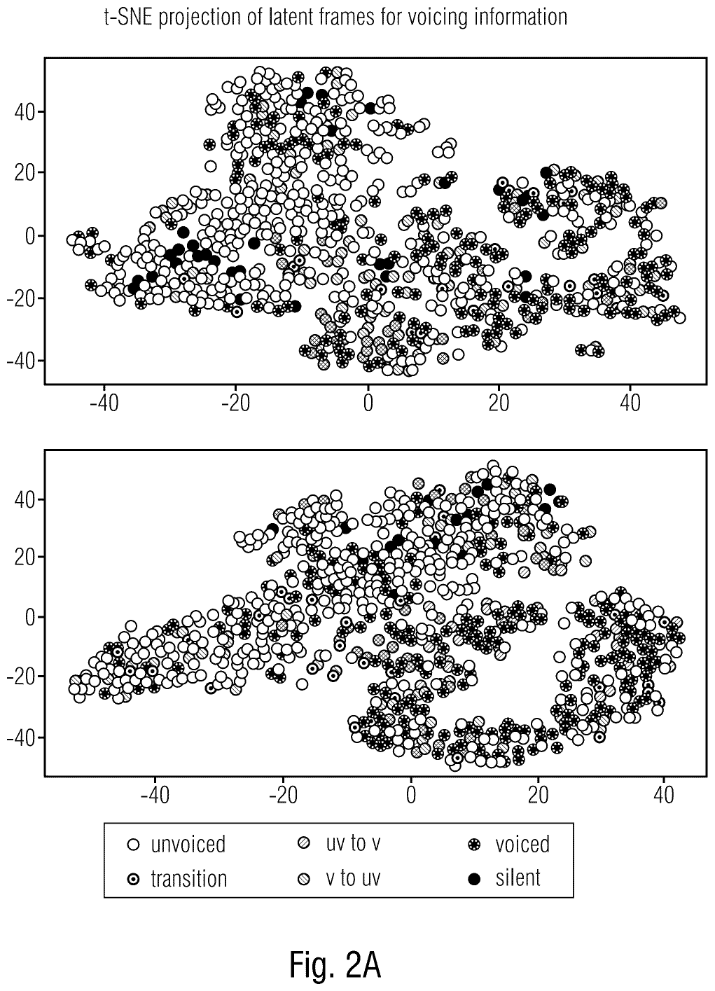

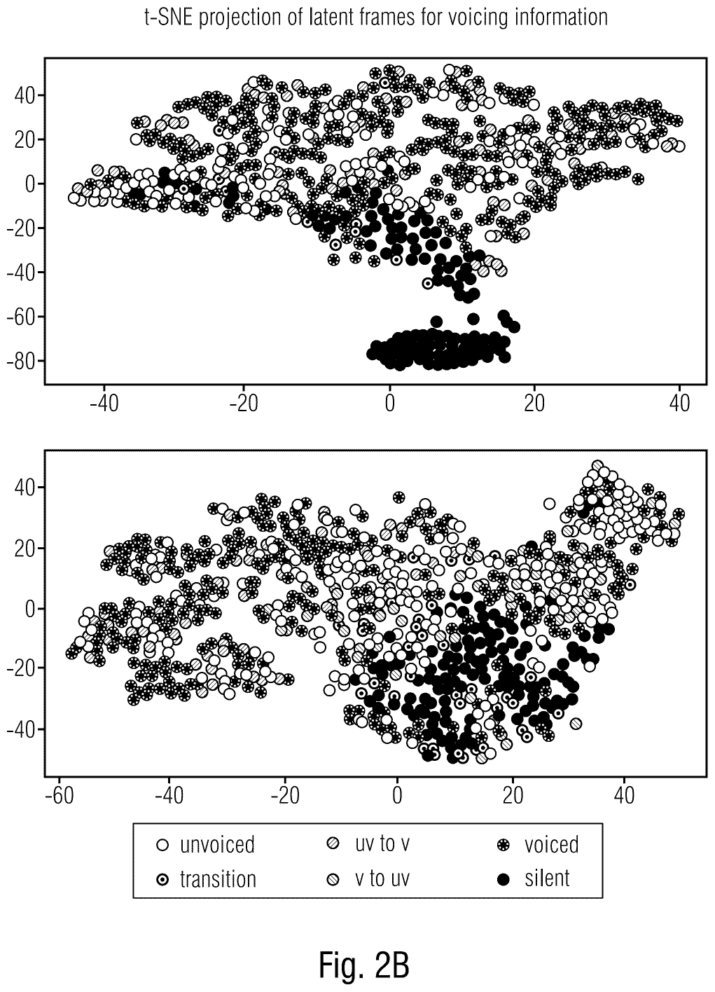

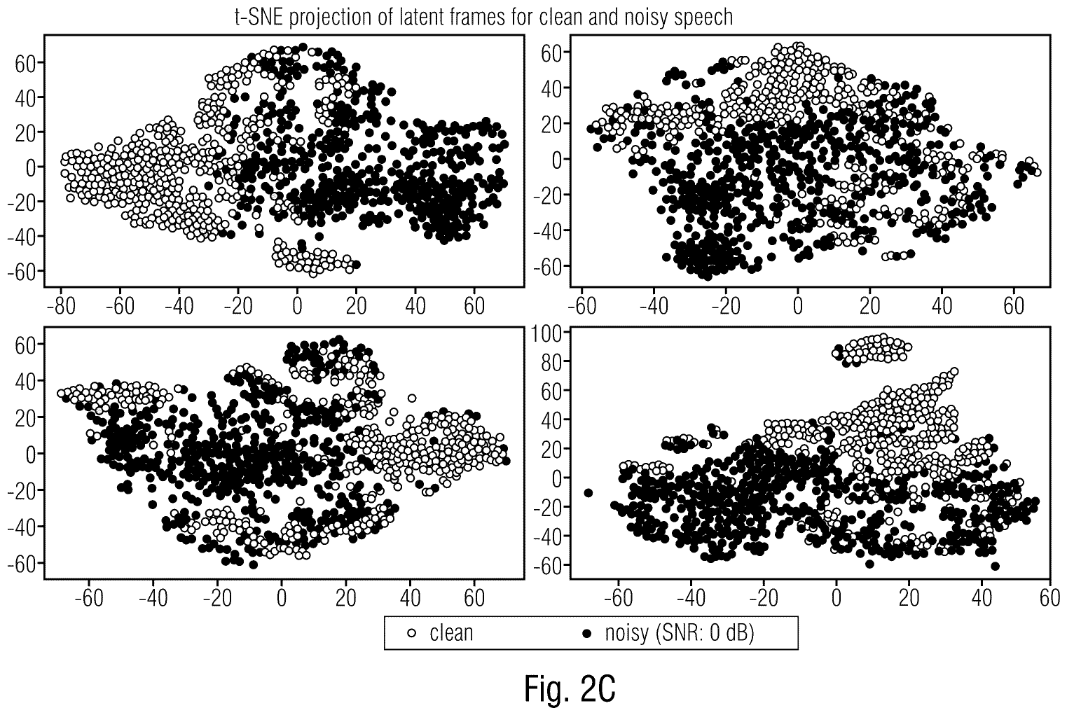

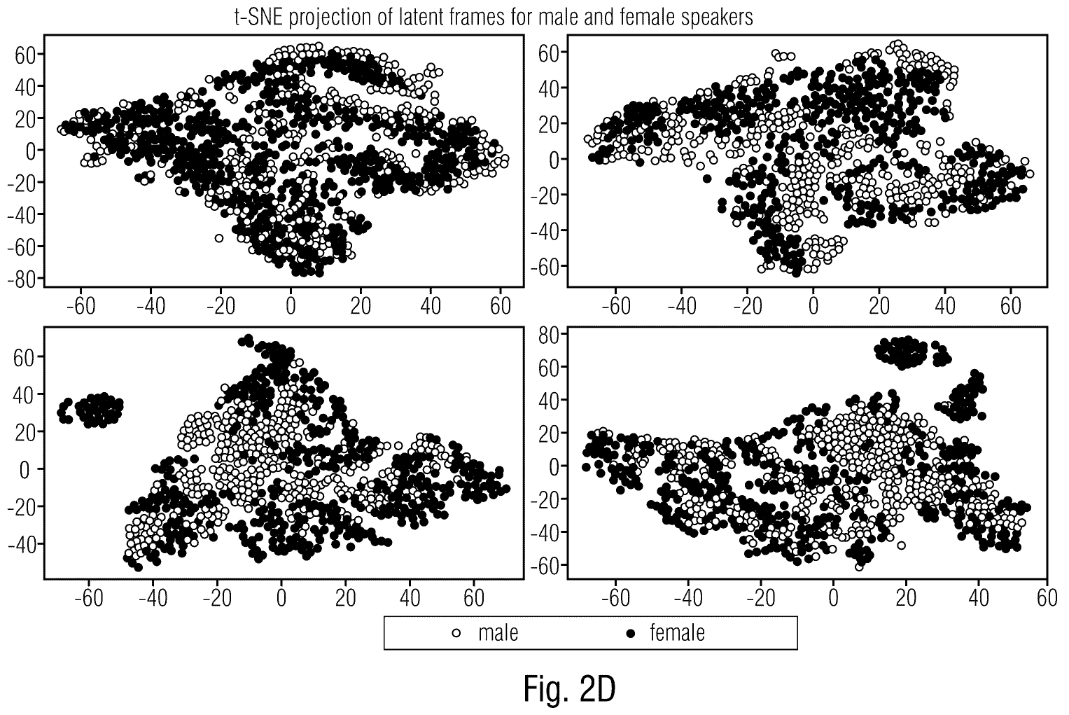

We test both speaker characteristics, such as language and gender, and acoustic aspects like voicing and noisiness. In our first experiment (FIG. 2a) we test voicing information using a VAD algorithm to label each frame automatically. We notice a clear clustering of voiced, unvoiced and silent frames with the boundary consisting of transition frames. We similarly label voiced frames based on their quantized pitch values, but this shows no significant clustering behaviour. We do not show the picture because of lack of space.

In our second experiment (FIG. 2b) we test the effect of noise introduced as in 3.1. We once again notice a clear division between noise frames and clean frames in the latent space, suggesting that the model is using distinct parts of the latent for these distinct modes.

Finally we test linguistic and speaker dependent characteristics such us gender (FIG. 2c) and language. In these cases we do not observe any particular clusterings, suggesting that the model is not able to distinguish between these macro-level aspects.

We hypothesize that the mentioned clustering behaviors might reflect the compression strategy of the model, which would be in line with well-known heuristics already used in classical codecs.

### 3.4 Objective Scores

We evaluate NESC using several objective metrics. It is well-known that such metrics are not reliable for assessing the quality of neural codecs [7, 10], as they disproportionately favor waveform-preserving codecs. Nonetheless, we report their values for comparison purposes. We consider ViSQOL v3 [29], POLQA [30] and the speech intelligibility measure STOI [31].

The scores are calculated on two internally curated test sets, the StudioSet and the InformalSet, respectively in Table 1 and 2. The StudioSet is constituted of 108 multi-lingual samples from the NTT Multi-Lingual Speech Database for Telephonometry, totalling around 14 minutes of studio-quality recordings. The InformalSet is constituted of 140 multi-lingual samples scraped from several datasets including LibriVox, and totalling around 14 minutes of audio recordings. This test set includes samples recorded with integrated microphones, more spontaneous speech, sometimes with low background noise or reverberation from a small room. NESC (invention) scores the best among the neural coding solutions across all three metrics.

TABLE 1
Average objective scores for neural decoders on the
StudioSet. For all metrics higher scores are better.
Confidence intervals are negligible for POLQA and ViSQOL
v3, while for STOI they are smaller than 0.02.

| Codec | POLQA | STOI | ViSQOL v3 |
|---|---|---|---|
| OPUS 6 kbps | 1.681 | 0.480 | 2.273 |
| EVS 5.9 kbps | 3.308 | 0.553 | 3.036 |
| SSMGAN 1.6 kbps | 2.213 | 0.536 | 2.505 |
| NESC 1 kbps | 1.534 | 0.612 | 2.109 |
| NESC 2 kbps | 2.382 | 0.641 | 2.615 |
| NESC 3 kbps | 2.548 | 0.643 | 2.841 |

TABLE 2
Average objective scores for neural decoders on the In-
formalSet. For all metrics higher scores are better.
Confidence intervals are negligible for POLQA and ViSQOL
v3, while for STOI they are smaller than 0.025

| Codec | POLQA | STOI | ViSQOL v3 |
|---|---|---|---|
| OPUS 6 kbps | 1.833 | 0.613 | 2.357 |
| EVS 5.9 kbps | 3.486 | 0.736 | 3.071 |
| SSMGAN 1.6 kbps | 2.267 | 0.647 | 2.476 |
| NESC 1 kbps | 1.659 | 0.745 | 2.074 |
| NESC 2 kbps | 2.492 | 0.802 | 2.595 |
| NESC 3 kbps | 2.707 | 0.817 | 2.822 |

### 3.5. Subjective Evaluation

We test the model only on challenging unseen conditions in order to assess its robustness. For this we select a test set of speech samples from the NTT Dataset comprising unseen speakers, languages and recording conditions. In the test set “m” stands for male, “f” for female, “ar” for Arabic, “en” for English, “fr” for French, “ge” for German, “ko” for Korean, and “th” for Thai.

We also test the model on noisy speech. For this we select the same speech samples as for the clean speech test and apply a similar augmentation policy as in Section 3.1. We add ambient noise samples (e.g. airport noises, typing noises, . . . ) at SNR between 10 dB and 30 dB and then convolve with room impulse responses (RIR) coming from small, medium and big sized rectangular rooms. More precisely, “ar/f”, “en/f”, “fr/m”, “ko/m”, and “th/f” are convolved with RIRs from small rooms, and hence for these signals the reverberation does not play a big role; whereas the other samples are convolved with RIRs medium and large size rooms. The augmentation datasets are the same used in training as they are vast enough to make memorization and overfitting unfeasible for the model.

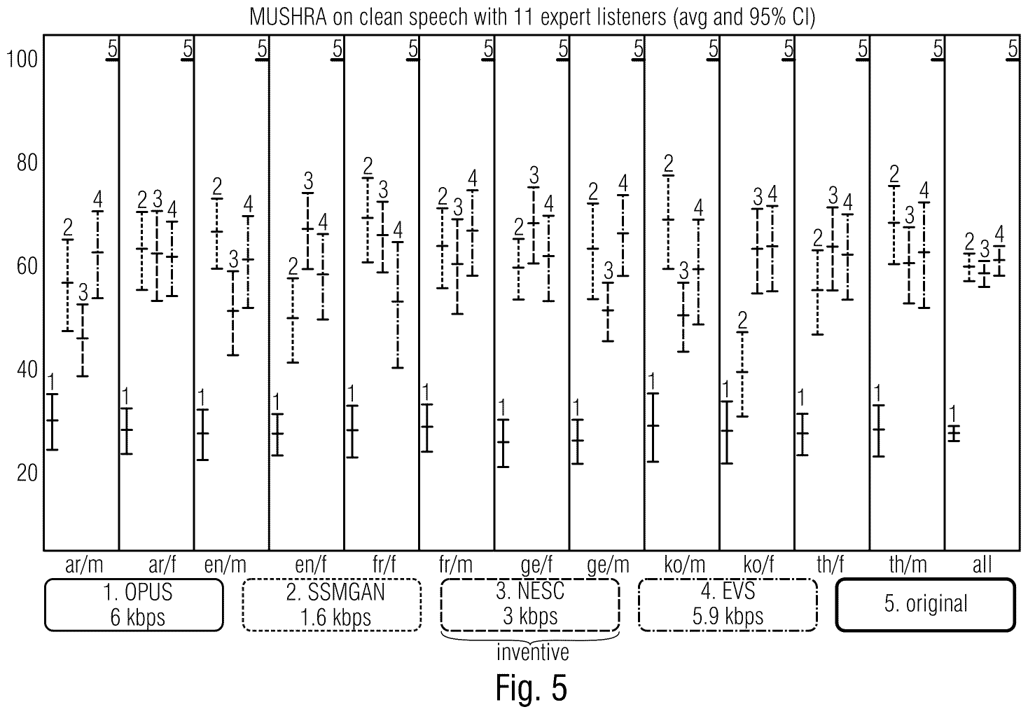

We conducted two MUSHRA listening test to assess the quality NESC (or more in general in the present examples), for clean speech and noisy speech involved 11 expert listeners. The results of the test on clean speech are shown in FIG. 5, and show that NESC (or more in general in the present examples), is on par with SSMGAN [1] and Enhanced Voice Services (EVS) in this case. The results of the test on noisy speech are shown in FIG. 6, and they confirmed that SSMGAN [1] is not robust to such scenarios while showing that NESC (or more in general in the present examples), is on par with EVS in this case.

The anchor for the tests is generated using the OPUS at 6 kbps, since the quality is expected to be very low at this bit rate. We took EVS at 5.9 kbps nominal bit rate as good benchmark for the classical codecs. In order to avoid an influence of CNG frames with different signature on the test, we deactivated the DTX transmission.

Finally, our solution was also tested against our previous neural decoder SSMGAN [1] at 1.6 kbps. This model yields high quality speech under clean conditions, but is not robust in noisy and real-life environments. SSMGAN [1] was trained on VCTK, hence the comparison with NESC (or more in general in the present examples), is not completely fair. Early experiments showed that training SSMGAN [1] with noisy data is more challenging than expected. We suppose that this issue is due to the reliance of SSMGAN [1] on the pitch information, which might be challenging to estimate in noisy environments. For this reason we decided to test NESC (or more in general in the present examples), against the best neural clean speech decoder that we have access to, namely SSMGAN [1] trained on VCTK, and still add it to the noisy speech test as an additional condition to show its limitations.

Both tests clearly show that NESC (or more in general in the present examples), is on par with EVS, while effectively having half of its bit rate. The noisy test moreover shows the limitations of SSMGAN [1] when working with noisy and reverberant signals, while showing how the quality of NESC stays high even in this challenging conditions.

### 4. CONCLUSIONS

We present NESC (or more in general in the present examples), a new GAN model capable of high-quality and robust end-to-end speech coding. We propose the new DPCRNN as the main building block for efficient and reliable encoding. We test our setup via objective quality measures and subjective listening tests, and show that it is robust under various types of noise and reverberation. We show a qualitative analysis of the latent structure giving a glimpse of the internal workings of our codec. Future work will be directed toward further complexity reduction and quality improvements.

### 5. REFERENCES

[1] A. Mustafa, J. Buthe, S. Korse, K. Gupta, G. Fuchs, and N. Pia, “A streamwise gan vocoder for wideband speech coding at very low bit rate,” in 2021 IEEE Workshop on Applications of Signal Processing to Audio and Acoustics (WASPAA), 2021, pp. 66-70.
[2]Z. Zhao, H. Liu, and T. Fingscheidt, “Convolutional Neural Networks to Enhance Coded Speech,” IEEE/ACM Transactions on Audio, Speech, and Language Processing, vol. 27, no. 4, pp. 663-678, April 2019.
[3]J. Skoglund and J. Valin, “Improving Opus Low Bit Rate Quality with Neural Speech Synthesis,” in INTERSPEECH, 2020.
[4]S. Korse, K. Gupta, and G. Fuchs, “Enhancement of Coded Speech Using a Mask-Based Post-Filter,” in ICASSP 2020-2020 IEEE International Conference on Acoustics, Speech and Signal Processing (ICASSP), 2020, pp. 6764-6768.
[5] A. Biswas and D. Jia, “Audio Codec Enhancement with Generative Adversarial Networks,” in ICASSP 2020-2020 IEEE International Conference on Acoustics, Speech and Signal Processing (ICASSP), 2020, pp. 356-360.
[6]S. Korse, N. Pia, K. Gupta, and G. Fuchs, “Postgan: A gan-based post-processor to enhance the quality of coded speech,” arXiv preprint arXiv:2201.13093, 2022.
[7]W. B. Kleijn, F. S. C. Lim, A. Luebs, J. Skoglund, F. Stimberg, Q. Wang, and T. C. Walters, “WaveNet Based Low Rate Speech Coding,” in ICASSP 2018, IEEE International Conference on Acoustics, Speech and Signal Processing, 2018, pp. 676-680.
[8]C. Garbacea, A. van den Oord, Y. Li, F. S. Lim, A. Luebs, O. Vinyals, and T. C. Walters, “Low bit-rate speech coding with vq-vae and a wavenet decoder,” in ICASSP 2019-2019 IEEE International Conference on Acoustics, Speech and Signal Processing (ICASSP). IEEE, 2019, pp. 735-739.
[9]J. Klejsa, P. Hedelin, C. Zhou, R. Fejgin, and L. Villemoes, “High-quality Speech Coding with SampleRNN,” in ICASSP 2019, IEEE International Conference on Acoustics, Speech and Signal Processing, 2019, pp. 7155-7159.
[10]J. Valin and J. Skoglund, “A Real-Time Wideband Neural Vocoder at 1.6 kb/s Using LPCNet,” in INTERSPEECH 2019, 20th Annual Conference of the International Speech Communication Association, 2019, pp. 3406-3410.
[11]W. Kleijn, A. Storus, M. Chinen, T. Denton, F. Lim, A. Luebs, J. Skoglund, and H. Yeh, “Generative speech coding with predictive variance regularization,” in ICASSP 2021, IEEE International Conference on Acoustics, Speech and Signal Processing, 2021.
[12]S. Morishima, H. Harashima, and Y. Katayama, “Speech coding based on a multi-layer neural network,” in IEEE International Conference on Communications, Including Supercomm Technical Sessions. IEEE, 1990, pp. 429-433.
[13]S. Kankanahalli, “End-to-end optimized speech coding with deep neural networks,” in 2018 IEEE International Conference on Acoustics, Speech and Signal Processing (ICASSP). IEEE, 2018, pp. 2521-2525.
[14]K. Zhen, J. Sung, M. S. Lee, S. Beack, and M. Kim, “Cascaded cross-module residual learning towards lightweight end-to-end speech coding,” arXiv preprint arXiv:1906.07769, 2019.
[15]K. Zhen, M. S. Lee, J. Sung, S. Beack, and M. Kim, “Efficient and scalable neural residual waveform coding with collaborative quantization,” in ICASSP 2020-2020 IEEE International Conference on Acoustics, Speech and Signal Processing (ICASSP). IEEE, 2020, pp. 361-365.
[16]N. Zeghidour, A. Luebs, A. Omran, J. Skoglund, and M. Tagliasacchi, “Soundstream: An end-to-end neural audio codec,” IEEE/ACM Transactions on Audio, Speech, and Lan-guage Processing, pp. 1-1, 2021.
[17]X. Jiang, X. Peng, C. Zheng, H. Xue, Y. Zhang, and Y. Lu, “End-to-end neural audio coding for real-time communications,” 2022.
[18]Y. Luo, Z. Chen, and T. Yoshioka, “Dual-path rnn: Efficient long sequence modeling for time-domain single-channel speech separation,” in ICASSP 2020-2020 IEEE International Conference on Acoustics, Speech and Signal Processing (ICASSP), 2020, pp. 46-50.
[19] A. van den Oord, O. Vinyals, and K. Kavukcuoglu, “Neural discrete representation learning,” in Proceedings of the 31st International Conference on Neural Information Processing Systems, 2017, pp. 6309-6318.
[20]H. Zen, V. Dang, R. Clark, Y. Zhang, R. Weiss, Y. Jia, Z. Chen, and Y. Wu, “Libritts: A corpus derived from librispeech for text-to-speech,” arXiv preprint arXiv:1904.02882, 2019.
[21]C. Reddy, H. Dubey, V. Gopal, R. Cutler, S. Braun, H. Gamper, R. Aichner, and S. Srinivasan, “Icassp 2021 deep noise suppression challenge,” in ICASSP 2021-2021 IEEE International Conference on Acoustics, Speech and Signal Processing (ICASSP). IEEE, 2021, pp. 6623-6627.
[22]D. Povey, “OpenSLR 28 Dataset,” https://www.openslr.org/28//.
[23]R. Yamamoto, E. Song, and J. Kim, “Parallel WaveGAN: A Fast Waveform Generation Model Based on Generative Adversarial Networks with Multi-Resolution Spectrogram,” in ICASSP 2020, IEEE International Conference on Acoustics, Speech and Signal Processing, 2020, pp. 6199-6203.
[24]K. Kumar, R. Kumar, de T. Boissiere, L. Gestin et al., “MelGAN: Generative Adversarial Networks for Conditional Waveform Synthesis,” in Advances in NeurIPS 32, 2019, pp. 14 910-14 921.
[25]D. P. Kingma and J. Ba, “Adam: A method for stochastic optimization,” ICLR, 2015.
[29]M. Chinen, F. S. Lim, J. Skoglund, N. Gureev, F. O'Gorman, and A. Hines, “ViSQOL v3: An open source production ready objective speech and audio metric,” in 2020 twelfth international conference on quality of multimedia experience (QoMEX). IEEE, 2020, pp. 1-6.
[30]J. Beerends, C. Schmidmer, J. Berger, M, Obermann, R. Ullmann, J. Pomy, and M. Keyhl, “Perceptual Objective Listening Quality Assessment (POLQA), the third generation ITU-T standard for end-to-end speech quality measurement part I—temporal alignment,” Journal of the audio engineering society, vol. 61, no. 6, pp. 1116-184, june. 2013.
[31]C. H. Taal, R. C. Hendriks. R, Heusdens, and J. Jensen, “Algorithm for intelligibility prediction of time frequency weighted noisy speech,” IEEE Trans Audio Speech Lang. Process., vol, pp. 2125-2 136. 201 I.

### FURTHER CHARACTERIZATION OF THE FIGURES

FIGS. 1b and 8: Neural End-2-End Speech Codec high level architecture.

FIG. 2a: t-SNE projection of the latent frames labeled based on voicing information. Voiced and unvoiced frames are clearly clustered. Each subplot represents 10 s of speech data.

FIG. 3: t-SNE projection of the latent frames clusters noisy and clean speech frames. Each subplot represents 10 s of speech data

FIG. 2b: t-SNE projection of the latent frames shows no clustering based on gender. Each subplot represents 10 s of speech data.

FIG. 3c: The listening test on clean speech shows that NESC is on par with EVS and SSMGAN.

FIG. 5: The listening test on clean speech shows that NESC is on par with EVS and SSMGAN.

FIG. 6: The listening test on noisy speech shows that NESC is robust under very challenging conditions

### 7. CONCLUSIONS

We present NESC a new GAN models capable of high-quality and robust end-to-end speech coding. We propose the new DPCRNN as the main building block for efficient and reliable encoding. We show how residual quantization and SSMGAN's decoder yield high-quality speech signals, which is robust under various types of noise and reverberation.

The question of how to increase the quality of speech even more while reducing the computational complexity of the model stays open.

### 8. IMPORTANT ASPECTS

8.1 Potential Applications and Benefits from Present Examples:
Generate a compact but generic and meaningful representation of speech signals, even if recorded in noisy and reverberant environments.
Application: process speech in so-generated latent representation, like speech enhancement (e.g. denoising, dereverberation), or disentanglement, separation, modification, suppression of paralinguistic features (speaker ID, emotion . . . ) for applications like voice conversion, privacy-preservation . . . .
Application in speech transmissions: Code and transmit speech at very low bitrates (or sampling rates) while maintaining a natural and good quality, surpassing coding efficiency of conventional coding schemes.

### 8.2 General-Purpose Speech Representation

Main novelties are the adoption of GRUs and the use of a dual path acoustic frontend based on the rolling windows. The rolling window operation consists in reshaping the signal in time domain of shape (1, time length) into overlap-ping frames of shape (frame length, number of frames). For example a signal (t0, t1, t2, t3) passed through a rolling window with frame length 2 and overlap 1 results in the reshaped signal

$$( {t}_{0} , {t}_{1} , {t}_{2} , {t}_{3} ) ↦ ( ( \begin{matrix}{t}_{0} \\ {t}_{1}\end{matrix} ) , ( \begin{matrix}{t}_{1} \\ {t}_{2}\end{matrix} ) , ( \begin{matrix}{t}_{2} \\ {t}_{3}\end{matrix} ) )$$

which has 3 frames each of length 2. The time dimension along the frames is interpreted as the input channels for a 1×1 convolution, i.e. a convolution with kernel size 1, which models the dependencies inside each frame. This is then followed by a GRU which models the dependencies amongst different frames.

For more details refer to FIGS. 1b and 8.

Conventional technology: HuBERT, wav2vec.

Reference above and below is also made to an audio representation method (or more in general technique) to generate a latent representation (e.g. 269) from an input audio signal (e.g. 1), the audio signal (e.g. 1) being subdivided in a sequence of frames, the audio representation 200 comprising:
a rolling window transformation 210, reshaping the successive samples split into frames of the input audio signal into a reshaped input (tensor) of at least 2 dimensions, one (inter-frame) dimension across the frame indices, and another (intra-frame) dimension across the sample position within one frame or more than one overlapping frames,
at least one sequence of learnable layers (e.g. 230, 240, 250) to provide an encoded representation (e.g. 269, 469) of the input audio signal (e.g. 1) at a given frame and accepting as input the reshaped input (tensor).

The input audio signal (e.g. 1) may be speech or speech recorded or mixed with background noise or a room effect. In addition or alternatively, the at least one sequence (e.g. 230, 240, 250) of learnable layers may include a recurrent unit (e.g. 240) (e.g. applied along the inter-frame dimension). In addition or alternatively, the at least one sequence (e.g. 230, 240, 250) of learnable layers may include a convolution 230 (e.g. 1×1 convolution) (e.g. applied along the intra-frame dimension). In addition or alternatively, the at least one sequence (e.g. 230, 240, 250) of learnable layers may include a convolution (e.g. 1×1 convolution) 230 e.g. followed by a recurrent unit 240 followed by a convolution (e.g. 1×1 convolution) 240.

### 8.3 Application Speech Transmission: Encoder

Encoder aspects cover the novelty of the model presently disclosed, by exploiting the speech representation method disclosed above.
Conventional technology: SoundStream [5].

Here, there is disclosed, inter alia, an audio encoder (e.g. 2), configured to generate a bitstream (e.g. 3) from an input audio signal (e.g. 1), the bitstream (e.g. 3) representing the audio signal (e.g. 1), the audio signal (e.g. 1) being subdivided in a sequence of frames, the audio encoder comprising:
a rolling window transformation (e.g. 210), reshaping the successive samples split into frames of the input audio signal into a reshaped input (tensor) of at least 2 dimensions, one (inter-frame) dimension across the frame indices, and another (intra-frame) dimension across the sample position within one frame or more than one overlapping frames,
at least one sequence (e.g. 230, 240, 250) of learnable layers to provide an encoded representation of the input audio signal (e.g. 1) at a given frame and accepting as input the reshaped input (tensor).
a quantizer (e.g. 300), configured to quantize the latent representation at the given frame.

Additionally or alternatively, the at least one sequence (e.g. 230, 240, 250) of learnable layers may include a recurrent unit (applied along the inter-frame dimension) 240 (e.g. a GRU, or a LSTM). Additionally or alternatively, the at least one sequence (e.g. 230, 240, 250) of learnable layers includes a 1×1 (e.g. 1×1 convolution) (e.g. applied along the intra-frame dimension). Additionally or alternatively, the at least one sequence of learnable layers may include a convolution (e.g. 1×1 convolution) 230 followed by a recurrent unit 240 followed by a convolution (e.g. 1×1 convolution) 250. Additionally or alternatively, the quantizer 300 may be a vector quantizer. Additionally or alternatively, the quantizer 300 may be a residual or a multi-stage vector quantizer. Additionally or alternatively, the quantizer 300 may be learnable and is learned together with the at least one learnable layer and/or the codebook which uses is learnable.

It is to be noted that the at least one codebook (at the quantizer 300 and/or at quantization index converter 313) can have fixed length. In case there are multiple rankings, it may be possible that the encoder signals in the bitstream which indexes of which ranking are encoded.

### 8.4 Application Speech Transmission: Decoder

The decoder uses features from the published Streamwise-StyleMelGAN (SSMGAN). Decoder aspects are then about using a RRN (e.g. GRU) as pre-network (prenet) used before condition SSMGAN.
Conventional technology: SSMGAN [1].

There is disclosed an audio decoder (e.g. 10), configured to generate an output audio signal (e.g. 16) from a bitstream (e.g. 3), the bitstream (e.g. 3) representing the audio signal (e.g. 1) intended to be reproduced, the audio signal (e.g. 1) being subdivided in a sequence of frames, the audio decoder (e.g. 10) comprising at least one of:
a first data provisioner (e.g. 702) configured to provide, for a given frame, a first data derived from an external source or internal source or from the bitstream (e.g. 3),
at least one preconditioning learnable layer (e.g. 710) based on recurrent unit(s) configured to receive the bitstream (e.g. 3) and, for the given frame, output target data (e.g. 12) representing the audio signal (e.g. 1) in the given frame.
at least one conditioning learnable layer configured, for the given frame, to process the target data (e.g. 12) to obtain conditioning feature parameters (e.g. 74, 75) for the given frame.
a styling element (e.g. 77) configured to apply the conditioning feature parameters (e.g. 74, 75) to the first data (e.g. 15) or normalized first data to obtain the output audio signal (e.g. 16).

### Final Summaries

The examples above are here summarized. Some new features can also integrate examples above (e.g. integrated by square brackets, which create additional embodiments and/or variants).

As shown in examples above, there is disclosed an audio generator (10) configured to generate an audio signal (16) from a bitstream (3), the bitstream (3) representing the audio signal (16), the audio signal being subdivided in a sequence of frames, the audio generator (10) comprising:
a first data provisioner (702) configured to provide, for a given frame, first data (15) derived from an input signal (14) [e.g. from an external or internal source or from the bitstream (3)], [wherein the first data (15) may have one single channel or multiple channels; the first data may be, for example, completely unrelated with the target data and/or with the bitstream, while in other examples the first data may have some relationship with the bitstream, since it may be obtained from the bitstream, e.g. from the LPC parameters of the bitstream, or other parameters taken from the bitstream];
a first processing block (40, 50, 50a-50h), configured, for the given frame, to receive the first data (15) and to output first output data (69) in the given frame, [wherein the first output data (69) may comprise a one single channel or a plurality of channels (47)],
[e.g. the audio generator also comprising a second processing block (45), configured, for the given frame, to receive, as second data, the first output data (69) or data derived from the first output data (69),]
wherein the first processing block (50) comprises:
   at least one preconditioning learnable layer (710) configured to receive the bitstream (3), or a processed version (112) thereof, and, for the given frame, output target data (12) representing the audio signal (16) in the given frame [e.g. with multiple channels and multiple samples for the given frame];
   at least one conditioning learnable layer (71, 72, 73) configured, for the given frame, to process the target data (12) to obtain conditioning feature parameters (74, 75) for the given frame; and
   a styling element (77), configured to apply the conditioning feature parameters (74, 75) to the first data (15, 59a) or normalized first data (59, 76′);
[wherein the second processing block (45), if present, may be configured to combine the plurality of channels (47) of the second data (69) to obtain the audio signal (16)],
wherein the at least one preconditioning learnable layer (710) includes at least one recurrent learnable layer [e.g. a gated recurrent learnable layer, such as a gated recurrent unit, GRU]
[e.g. configured to obtain the audio signal (16) from the first output data (69) or a processed version of the first output data (69)].

The audio generator (10) may be configured to obtain the audio signal (16) from the first output data (69) or a processed version of the first output data (69).

The audio generator (10) may be such that the first data (15) have multiple channels, wherein the first output data (69) comprise a plurality of channels (47),
the audio generator also comprising a second processing block (45), configured, for the given frame, to receive, as second data, the first output data (69) or data derived from the first output data (69), the output target data (12) being with multiple channels and multiple samples for the given frame, wherein the second processing block (45) is configured to combine the plurality of channels (47) of the second data (69) to obtain the audio signal (16).

As shown in examples above, there is disclosed an audio generator (10), configured to generate an audio signal (16) from a bitstream (3), the bitstream (3) representing the audio signal (16), the audio signal being subdivided in a sequence of frames, the audio generator (10) comprising:
a first data provisioner (702) configured to provide, for a given frame, first data (15) derived from an input signal (14), [e.g. from an external or internal source or from the bitstream (3)], [wherein the first data (15) may have one single channel or multiple channels; the first data may be, for example, completely unrelated with the target data and/or with the bitstream, while in other examples the first data may have some relationship with the bitstream, since it may be obtained from the bitstream, e.g. from the LPC parameters of the bitstream, or other parameters taken from the bitstream];
a first processing block (40, 50, 50a-50h), configured, for the given frame, to receive the first data (15) and to output first output data (69) in the given frame, wherein the first output data (69) may comprise a plurality of channels (47),
the audio generator also comprising a second processing block (45), configured, for the given frame, to receive, as second data, the first output data (69) or data derived from the first output data (69),
wherein the first processing block (50) comprises:
   at least one preconditioning learnable layer (710) configured to receive the bitstream (3), or a processed version (112) thereof, and, for the given frame, output target data (12) representing the audio signal (16) in the given frame [e.g. with multiple channels and multiple samples for the given frame];
   at least one conditioning learnable layer (71, 72, 73) configured, for the given frame, to process the target data (12) to obtain conditioning feature parameters (74, 75) for the given frame; and
   a styling element (77), configured to apply the conditioning feature parameters (74, 75) to the first data (15, 59a) or normalized first data (59, 76′);
wherein the second processing block (45), if present, may be configured to combine the plurality of channels (47) of the second data (69) to obtain the audio signal (16),
wherein the at least one preconditioning learnable layer (710) includes at least one recurrent learnable layer [e.g. a gated recurrent learnable layer, such as a gated recurrent unit, GRU, or LSTM]
   [e.g. the audio generator may be configured to obtain the audio signal (16) from the first output data (69) or a processed version of the first output data (69)].

The audio generator may be such that the recurrent learnable layer includes at least one gated recurrent unit, GRU.

The audio generator may be such that the recurrent learnable layer includes at least one long short term memory, LSTM, recurrent learnable layer.

The audio generator may be such that the recurrent learnable layer is configured to generate the output, which is [target data (12)] for a given time instant by keeping into account the output [target data (12)] and/or a state of a preceding [e.g. immediately preceding] time instant, wherein the relevance of the output [target data (12)] and/or state of a preceding [e.g. immediately preceding] time instant is obtained training.

The audio generator o may be such that the recurrent learnable layer operates along a series of time steps each having at least one state, in such a way that each time step is conditioned by the output and/or state of the [e.g. immediately] preceding time step [the state of the preceding time step may be the output] [it may be, like in FIG. 11, that the step and/or output of each step is recursively provided to a subsequent time step, e.g. the immediately subsequent time step] [alternatively, like in FIG. 12, there may be a plurality of feedforward modules, each providing the state and/or output to the subsequent module, e.g. the immediately subsequent module] [the implementation of FIG. 12 may be understood, in some examples, like the unrolled version of the implementation of FIG. 11] [in examples, the parameters of different time instants and/or feedforward modules may be in general different from each other, but in some examples they may be the same].

The audio generator may further comprising a plurality of feedforward modules, each providing the state and/or output to the immediately subsequent module.

The audio generator may be such that the recurrent learnable layer is configured to generate a state and/or output [hₜ] [for a particular t-th state or module] by:
weighting a candidate state and/or output through an update gate vector [zₜ] [whose elements may have a value between 0 and 1, or another value between 0 and c, with c>0], to generate a first weighted addend; and
weighting the state and/or output [hₜ₋₁] of the preceding time step through a vector which is complementary to 1 [i.e. its components are complementary to 1] with the update gate vector zₜ, to generate a second weighted addend; and
adding the first addend with the second addend
[the update gate vector [zₜ] provides information on both how much is to be taken from the candidate state and/or output and how much is to be taken from the state and/or output [hₜ₋₁] of the preceding time step; e.g. if zₜ=0, the state and/or output for the current time instant is only taken from the state and/or output [hₜ₋₁] of the preceding time step; while if the zₜ=1, the state and/or output for the current time instant is only taken from the candidate vector].

The audio generator may be such that the recurrent learnable layer is configured to generate a state and/or output [hₜ] by:
through reciprocally complementary weighting vectors, adding a weighted version of a candidate state and/or output with a weighted version of the state and/or output hₜ₋₁ of the preceding time step.

The audio generator may be such that the recurrent learnable layer is configured to generate the candidate state and/or output by at least applying a weight parameter [W], obtained by training, to:
an element-wise product between a reset gate vector [rₜ] and the state and/or output [hₜ₋₁] of the preceding time step, concatenated with the input [xₜ] for the current time instant;
optionally followed by applying an activation function (e.g. tanH)
[the reset gate vector [rₜ] giving information on how much the state and/or output [hₜ₋₁] of the preceding time step shall be reset] [if rₜ=0, we reset everything and we keep nothing from hₜ₋₁, while if rₜ is higher, then we keep more from hₜ₋₁].

The audio generator may be further configured to apply an activation function after having applied the weight parameter W. The activation function may be TanH.

The audio generator may be such that the recurrent learnable layer is configured to generate the candidate state and/or output by at least:
weighting, through weight parameter W obtained by training, a vector which is conditioned by both:
the input [xₜ] for the current time instant and
the state and/or output [hₜ₋₁] of the preceding time step weighted onto a reset gate vector [rₜ], [the reset gate vector giving information on how much the state and/or output [hₜ₋₁] of the preceding time step shall be reset] [if rₜ=0, we reset everything and we keep nothing from hₜ₋₁, while if rₜ is higher, then we keep more from hₜ₋₁]

The audio generator may be such that the recurrent learnable layer is configured to generate the update gate vector [zₜ] by applying a parameter [W_{z}] to a concatenation of:
the input [hₜ₋₁] of the recurrent module [hₜ₋₁] concatenated with
the input [xₜ] for the current time instant [e.g. the input to the at least one preconditioning learnable layer (710)],
optionally followed by applying an activation function (e.g., sigmoid, σ).

The audio generator may be configured, after having applied the parameter W_{z}, to apply an activation function.

The audio generator may be such that the activation function is a sigmoid, a.

The audio generator may be such that the reset gate vector rₜ is obtained by applying a weight parameter Wᵣ to a concatenation of both:
the state and/or output hₜ₋₁ of the preceding time step and
the input xₜ for the current time instant.

The audio generator may be configured, after having applied the parameter Wᵣ, to apply an activation function.

The audio generator may be such that the activation function is a sigmoid, a.

An audio generator (10) may comprise a quantization index converter (313) [also called index-to-code converter, inverse quantizer, reverse quantizer, etc.] configured to convert indexes of the bitstream (13) onto codes [e.g., according to the examples, the codes may be scalars, vectors or more in general tensors] [e.g. according to a codebook, e.g. a tensor may be multidimensional, such as a matrix or its generalization onto multiple dimensions, e.g. three dimensions, four dimensions, etc.] [e.g. the codebook may be learnable or may be deterministic] [e.g. the codebooks 112 may be provided to the preconditioning learnable layer (710)].

As shown in examples above, there is disclosed an audio generator (10) configured to generate an audio signal (16) from a bitstream (3), the bitstream (3) representing the audio signal (16), the bitstream (3) being subdivided into a sequence of indexes, the audio signal being subdivided in a sequence of frames, the audio generator (10) comprising:
a quantization index converter (313) [also called index-to-code converter, inverse quantizer, reverse quantizer, etc.] configured to convert the indexes of the bitstream (13) onto codes [e.g., according to the examples, the codes may be scalars, vectors or more in general tensors] [e.g. according to a codebook, e.g. a tensor may be multidimensional, such as a matrix or its generalization onto multiple dimensions, e.g. three dimensions, four dimensions, etc.] [e.g. the codebook may be learnable or may be deterministic],
a first data provisioner (702) configured to provide, for a given frame, first data (15) derived from an input signal (14) from an external or internal source or from the bitstream (3), [wherein the first data (15) may have one single channel or multiple channels] [;
a first processing block (40, 50, 50a-50h), configured, for the given frame, to receive the first data (15) and to output first output data (69) in the given frame, [wherein the first output data (69) may comprise a one single channel or a plurality of channels (47)], and
[there may be a second processing block (45), configured, for the given frame, to receive, as second data, the first output data (69) or data derived from the first output data (69)],
wherein the first processing block (50) comprises:
   at least one preconditioning learnable layer (710) configured to receive the bitstream (3), or a processed version (112) thereof [e.g. the processed version (112) may be outputted by the quantization index converter (313)], and, for the given frame, output target data (12) representing the audio signal (16) in the given frame [e.g. with multiple channels and multiple samples for the given frame];
   at least one conditioning learnable layer (71, 72, 73) configured, for the given frame, to process the target data (12) to obtain conditioning feature parameters (74, 75) for the given frame; and
   a styling element (77), configured to apply the conditioning feature parameters (74, 75) to the first data (15, 59a) or normalized first data (59, 76′);
   [wherein the second processing block (45), if present, may be configured to combine the plurality of channels (47) of the first output data or of the second output data (69) to obtain the audio signal (16)]
[e.g. configured to obtain the audio signal (16) from the first output data (69) or a processed version (16) of the first output data (69)].

The audio generator may be such that the first data has a plurality of channels, the first output data comprises a plurality of channels, the target data being with multiple channels, further comprising a second processing block (45) configured to combine the plurality of channels (47) of the first output data to obtain the audio signal (16).

The audio generator may be such that the least one codebook is learnable.

The audio generator may be such that the quantization index converter (313) uses at least one codebook associating indices [e.g. codebook(s) zₑ, rₑ, qₑ, with the index i_{z} representing a code z approximating E(x) and being taken from the codebook zₑ, the index iᵣ approximating E(x)−z and being taken from the codebook rₑ, and the index qₑ approximating E(x)−z−r and being taken from the codebook i_{q}] encoded in the bitstream to codes e.g. scalars, vectors or more in general tensors, representing a frame, several frames or portions of a frame of the audio signal to generate.

The audio generator may be such that the at least one codebook [e.g. zₑ, rₑ, qₑ] is or comprises a base codebook [e.g. zₑ] associating indexes [e.g. z] encoded in the bitstream (3) to codes [e.g. scalar, vectors or more in general tensors] representing main portions of frames [e.g. latent].

The audio generator may be such that the at least one codebook is a [or more comprises] a residual codebook [e.g. a first residual codebook, e.g. rₑ and maybe a second residual codebook, e.g. qₑ, and maybe even more low-ranked residual codebooks; further codebooks are possible] associating indexes encoded in the bitstream to codes [e.g. scalars, vectors, or more in general tensors] representing residual [e.g. error] portions of frames [e.g., wherein the audio generator is also configured to recompose the frames, e.g. by addition of the base portion to the one or two or more residual portions for each frame].

The audio generator may be such that there are defined a multiplicity of residual codebooks, so that
a second residual codebook associates indexes encoded in the bitstream to codes (scalar, vector, tensor . . . ) representing second residual portions of frames, and
a first residual codebook associates indexes encoded in the bitstream to codes representing first residual portions of frames,
wherein the second residual portions of frames are residual [e.g. low-ranked] with respect to the first residual portions of frames.

The audio generator may be such that the bitstream (3) signals whether indexes associated to residual frames are encoded or not, and the quantization index converter (313) is accordingly configured to read [e.g. only] the encoded indexes according to the signalling [and, in case of different rankings, the bitstream may signal which indexes of which ranking are encoded, and/or the at least one codebook (313) accordingly reads, e.g. only, the encoded indexes according to the signalling].

The audio generator may be such that at least one codebook is a fixed-length codebook [e.g. at least one codebook having a number of bits between 4 and 20, e.g. between 8 and 12, e.g. 10].

The audio generator may be configured to perform dithering to the codes.

The audio generator may be such that a training session is performed by receiving a multiplicity of bitstreams, with indexes associated with known codes, representing known audio signals, the training session including an evaluation of the generated audio signals in respect to the known audio signals, so as to adapt associations of indexes of the at least one codebook with the frames of the encoded bitstreams [e.g. by minimizing the difference between the generated audio signal and the known audio signals] [e.g. using a GAN].

The audio generator may be such that the training session is performed by receiving at least:
a multiplicity of first bitstreams with first candidate indexes having a first bitlength and being associated with first known frames representing known audio signals, the first candidate indexes forming a first candidate codebook, and a multiplicity of second bitstreams with second candidate indexes having a second
bitlength and being associated with known frames representing the same first known audio signals, the second candidate indexes forming a second candidate codebook,
wherein the first bitlength is higher than the second bitlength [and/or the first bitlength has higher resolution but it occupies more band than the second bitlength],
the training session including an evaluation of the generated audio signals obtained from the multiplicity of the first bitstreams in comparison with the generated audio signals obtained from the multiplicity of the second bitstreams, to thereby choose the codebook [e.g. so that the chosen learnable codebook is the chosen codebook between the first and second candidate codebooks] [for example, there may be an evaluation of a first ratio between a metrics measuring the quality of the audio signal generated from the multiplicity of first bitstreams in respect to the bitlength vs a second ratio between a metrics measuring the quality of the audio signal generated from the multiplicity of second bitstreams in respect to the bitrate (sampling rate), and to choose the bitlength which maximizes the ratio] [e.g. this can be repeated for each of the codebooks, e.g. the main, the first residual, the second residual, etc.].

The audio generator may be such that the training session is performed by receiving: a first multiplicity of first bitstreams with first indexes associated with first known frames representing known audio signals, wherein the first indexes are in a first maximum number, the first multiplicity of first candidate indexes forming a first candidate codebook; and
a second multiplicity of second bitstreams with second indexes associated with known frames representing the same first known audio signals, the second multiplicity of second candidate indexes forming a second candidate codebook, wherein the second indexes are in a second maximum number different from the first maximum number,
the training session including an evaluation of the generated audio signals obtained from the first multiplicity of the first bitstreams in comparison with the generated audio signals obtained from the second multiplicity of the second bitstreams, to thereby choose the learnable indexes [e.g. so that the chosen learnable codebook is chosen among the first candidate codebook and the second candidate codebook] [for example, there may be an evaluation of a first ratio between a metrics measuring the quality of the audio signal generated from the first multiplicity of first bitstreams vs a second ratio between a metrics measuring the quality of the audio signal generated from the second multiplicity of second bitstreams in respect to the bitrate (sampling rate), and to choose the multiplicity, among the first multiplicity and second multiplicity, which maximizes the ratio] [e.g. this can be repeated for each of the codebooks, e.g. the main, the first residual, the second residual, etc.].

The audio generator may be such that the training session is performed by receiving: a first multiplicity of first bitstreams with first indexes representing codes obtained from known audio signals, the first multiplicity of first bitstreams forming at least one first codebook [e.g. at least one main codebook zₑ]; and
a second multiplicity of second bitstreams including both the first indexes representing main codes obtained from known audio signals and second indexes representing residual codes in respect to the main codes, the second multiplicity of second bitstreams forming the at least one first codebook [e.g. at least one main codebook zₑ] and at least one second codebook [e.g. at least one residual codebook rₑ];
the training session including an evaluation of the generated audio signals obtained from the first multiplicity of the first bitstreams in comparison with the generated audio signals obtained from the second multiplicity of the second bitstreams,
to thereby choose among the first multiplicity [and/or the first candidate codebook zₑ] and the second multiplicity [and/or the first candidate codebook zₑ as main codebook, together with the at least one second codebook used as residual codebook rₑ] [e.g. so that the chosen learnable codebook is chosen among the first candidate codebook and the second candidate codebook] [for example, there may be an evaluation of a first ratio between a metrics measuring the quality of the audio signal generated from the first multiplicity of first bitstreams vs a second ratio between a metrics measuring the quality of the audio signal generated from the second multiplicity of second bitstreams in respect to the bitrate (sampling rate), and to choose the multiplicity, among the first multiplicity and second multiplicity, which maximizes the ratio] [e.g. this can be repeated for each of the codebooks, e.g. the main, the first residual, the second residual, etc.].

The audio generator may be configured so that the bitrate (sampling rate) of the audio signal (16) is greater than the bitrate (sampling rate) of both the target data (12) and/or of the first data (15) and/or of the second data (69).

The audio generator further comprising a second processing block (45) configured to increase the bitrate (sampling rate) of the second data (69), to obtain the audio signal (16) [and/or wherein the second processing block (45) is configured to reduce the number of channels of the second data (69), to obtain the audio signal (16).

The audio generator may be such that the first processing block (50) is configured to up-sample the first data (15) from a number of samples for the given frame to a second number of samples for the given frame greater than the first number of samples.

The audio generator may comprise a second processing block (45) configured to up-sample the second data (69) obtained from the first processing block (40) from a second number of samples for the given frame to a third number of samples for the given frame greater than the second number of samples.

The audio generator may be configured to reduce the number of channels of the first data (15) from a first number of channels to a second number of channels of the first output data (69) which is lower than the first number of channels.

The audio generator further comprising a second processing block (45) configured to reduce the number of channels of the first output data (69), obtained from the first processing block (40), from a second number of channels to a third number of channels of the audio signal (16), wherein the third number of channels is lower than the second number of channels.

The audio generator may be such that the audio signal (16) is a mono audio signal.

The audio generator may be configured to obtain the input signal (14) from the bitstream (3, 3b).

The audio generator may be configured to obtain the input signal from noise (14).

The audio generator may be such that the at least one preconditioning learnable layer (710) is configured to provide the target data (12) as a spectrogram or a decoded spectrogram.

The audio generator be such that the at least one conditioning learnable layer or a conditioning set of learnable layers comprises one or at least two convolution layers (71-73).

The audio generator be such that a first convolution layer (71-73) is configured to convolute the target data (12) or up-sampled target data to obtain first convoluted data (71′) using a first activation function.

The audio generator may be such that the first activation function is a leaky rectified linear unit, leaky ReLu, function.

The audio generator be such that the at least one conditioning learnable layer or a conditioning set of learnable layers (71-73) and the styling element (77) are part of a weight layer in a residual block (50, 50a-50h) of a neural network comprising one or more residual blocks (50, 50a-50h).

The audio generator be such that the audio generator (10) further comprises a normalizing element (76), which is configured to normalize the first data (59a, 15).

The audio generator be such that the audio generator (10) further comprises a normalizing element (76), which is configured to normalize the first data (59a, 15) in the channel dimension.

The audio generator be such that the audio signal (16) is a voice audio signal.

The audio generator be such that the target data (12) is up-sampled by a factor of a power of 2 or by another factor, such as 2.5 or a multiple of 2.5.

The audio generator be such that the target data (12) is up-sampled (70) by non-linear interpolation.

The audio generator be such that the first processing block (40, 50, 50a-50k) further comprises:
a further set of learnable layers (62a, 62b), configured to process data derived from the first data (15, 59, 59a, 59b) using a second activation function (63b, 64b),
wherein the second activation function (63b, 64b) is a gated activation function.

The audio generator be such that the further set of learnable layers (62a, 62b) may comprise one or two or more convolution layers.

The audio generator be such that the second activation function (63a, 63b) is a softmax-gated hyperbolic tangent, TanH, function.

The audio generator be such that the first activation function is a leaky rectified linear unit, leaky ReLu, function.

The audio generator be such that convolution operations (61b, 62b) run with maximum dilation factor of 2.

The audio generator comprise eight first processing blocks (50a-50h) and one second processing block (45).

The audio generator be such that the first data (15, 59, 59a, 59b) has own dimension which is lower than the audio signal (16).

The audio generator may be such that the target data (12) is a spectrogram.

The audio signal (16) may be a mono audio signal.

As shown in examples above, there is disclosed an audio signal representation generator (2, 20) for generating an output audio signal representation (3, 469) from an input audio signal (1) including a sequence of input audio signal frames, each input audio signal frame including a sequence of input audio signal samples, the audio signal representation generator comprising:
a format definer (210) configured to define a first multi-dimensional audio signal representation (220) of the input audio signal (1), the first multi-dimensional audio signal representation (220) of the input audio signal including at least:
   a first dimension [e.g. inter frame dimension], so that a plurality of mutually subsequent frames [e.g. immediately subsequent] is ordered according to the first dimension; and
   a second dimension [e.g. intra frame dimension], so that a plurality of samples of at least one frame are ordered according to the second dimension [the format definer may be configured to order mutually subsequent samples, e.g. immediately subsequent samples, one after the other one according to the second dimension],
at least one learnable layer (230, 240, 250, 290, 300) configured to process the first multidimensional audio signal representation (220) of the input audio signal (1), or processed version of the first multi-dimensional audio signal representation, to generate the output audio signal representation (3, 469) of the input audio signal (1).

The audio signal representation generator may be such that the format definer (210) is configured to insert, along the second dimension [e.g. intra frame dimension] of the first multidimensional audio signal representation of the input audio signal, input audio signal samples of each given frame.

The audio signal representation generator may be such that the format definer (210) is configured to insert, along the second dimension [e.g. intra frame dimension] of the first multi-dimensional audio signal representation (220) of the input audio signal (1), additional input audio signal samples of one or more additional frames immediately successive to the given frame [e.g. in a predefined number, e.g. application specific, e.g. defined by a user or an application].

The audio signal representation generator may be such that the format definer (210) is configured to insert, along the second dimension of the first multidimensional audio signal representation (220) of the input audio signal (1), additional input audio signal samples of one or more additional frames immediately preceding the given frame [e.g. in a predefined number, e.g. application specific, e.g. defined by a user or an application].

The audio signal representation generator may be such that the at least one learnable layer includes at least one recurrent learnable layer (240) [e.g. a GRU].

The audio signal representation generator may be such that the at least one recurrent learnable layer (240) is operated along the first dimension [e.g. inter frame dimension].

The audio signal representation generator may further comprise at least one first convolutional learnable layer (230) [e.g. with a convolutional kernel, which may be a learnable kernel and/or which may be a 1×1 kernel] between the format definer (210) and the at least one recurrent learnable layer (240) [e.g. GRU, or LSTM].

The audio signal representation generator may be such that in the at least one first convolutional learnable layer (230) [first learnable layer] the kernel is slid along the second direction [e.g. intra frame direction] of the first multi-dimensional audio signal representation (220) of the input audio signal (1).

The audio signal representation generator may further comprise at least one convolutional learnable layer (250) [e.g. with a convolutional kernel, which may be a learnable kernel and/or which may be a 1×1 kernel] downstream to the at least one recurrent learnable layer (240) [e.g. GRU, or LSTM].

The audio signal representation generator may be such that in the at least one convolutional learnable layer (250) [first learnable layer] the kernel is slid along the second direction [e.g. intra frame direction] of the first multi-dimensional audio signal representation (220) of the input audio signal (1).

The audio signal representation generator may be such that at least one or more of the at least one learnable layer is a residual learnable layer.

The audio signal representation generator may be such that at least one learnable layer (230, 240, 250) is a residual learnable layer [e.g. a main portion of the first multidimensional audio signal representation (220) of the input audio signal bypassing (259′) the at least one learnable layer (230, 240, 250), and/or the at least one learnable layer (230, 240, 250) is applied to at least a residual portion (259a) of the first bidimensional audio signal representation (220) of the input audio signal (1)].

207b″. The audio signal representation generator may be such that the recurrent learnable layer operates along a series of time steps each having at least one state, in such a way that each time step is conditioned by the output and/or state of the [e.g. immediately] preceding time step [the state of the preceding time step may be the output] [it may be, like in FIG. 11, that the step and/or output of each step is recursively provided to a subsequent time step, e.g. the immediately subsequent time step] [alternatively, like in FIG. 12, there may be a plurality of feedforward modules, each providing the state and/or output to the subsequent module, e.g. the immediately subsequent module] [the implementation of FIG. 12 may be understood, in some examples, like the unrolled, e.g. developed, version of the implementation of FIG. 11] [in examples, the parameters of different time instants and/or feedforward modules may be in general different from each other, but in some examples they may be the same].

The audio signal representation generator may be such that the step and/or output of each step is recursively provided to a subsequent time step.

The audio signal representation generator may comprise a plurality of feedforward modules, each providing the state and/or output to the subsequent module.

The audio signal representation generator may be such that the recurrent learnable layer generates the output [target data (12)] for a given time instant by keeping into account the output [target data (12)] and/or a state of a preceding [e.g. immediately preceding] time instant, wherein the relevance of the output and/or state of a preceding [e.g. immediately preceding] time instant is obtained training.

As shown in examples above, there is disclosed an audio signal representation generator (2, 20) for generating an output audio signal representation (3, 469) from an input audio signal (1) including a sequence of input audio signal frames, each input audio signal frame including a sequence of input audio signal samples, the audio signal representation generator (2, 20) comprising:
a [e.g. deterministic] format definer (210) configured to define a first multi-dimensional audio signal representation (220) of the input audio signal (1) [e.g. the same of above];
[an optional first learnable layer (230), e.g. a first convolutional learnable layer, which is a convolutional learnable layer configured to generate a second multi-dimensional audio signal representation of the input audio signal (1) by sliding along a second direction [e.g. intra frame direction] of the first multi-dimensional audio signal representation (220) of the input audio signal (1);]
a second learnable layer (240) which is a recurrent learnable layer configured to generate a third multi-dimensional audio signal representation of the input audio signal (1) by operating along a first direction [e.g. inter frame direction] of the second multi-dimensional audio signal representation (220) of the input audio signal (1) [e.g. using a 1×1 kernel, e.g. a 1×1 learnable kernel, or another kernel];
a third learnable layer (250) [which may be, for example, a second convolutional learnable layer] which is a convolutional learnable layer configured to generate a fourth multi-dimensional audio signal representation (265b′) of the input audio signal by sliding along the second direction [e.g. intra frame direction] of the first multi-dimensional audio signal representation of the input audio signal [e.g. using a 1×1 kernel, e.g. a 1×1 learnable kernel],
so as to obtain the output audio signal representation (269) from the fourth [or the second or the third] multi-dimensional audio signal representation (265b′) of the input audio signal (1) [e.g., after having added the fourth multi-dimensional audio signal representation (265b′) with a main portion of the multi-dimensional audio signal representation (220) of the input audio signal (1), or after the block 290 and/or quantization block 300].

The audio signal representation generator may further comprise a first learnable layer (230) which is a convolutional learnable layer configured to generate a second multi-dimensional audio signal representation of the input audio signal (1) by sliding along a second direction of the first multi-dimensional audio signal representation (220) of the input audio signal (1).

The audio signal representation generator may be such that the first learnable layer is applied along the second dimension of the first multidimensional audio signal representation of the input audio signal.

The audio signal representation generator may be such that the first learnable layer is a residual learnable layer.

The audio signal representation generator may be such that at least the second learnable layer (240) and the third learnable layer (250) are residual learnable layer[e.g. a main portion of the first multidimensional audio signal representation (220) of the input audio signal bypasses (259′) the first learnable layer (230), the second learnable layer (240), and the third learnable layer (250), and/or the first learnable layer (230), the second learnable layer (240), and the third learnable layer (250) are applied to at least a residual portion (259a) of the first bidimensional audio signal representation (220) of the input audio signal (1)].

The audio signal representation generator may be such that the first learnable layer is applied [e.g. by sliding the kernel] along the second dimension of the first multidimensional audio signal representation of the input audio signal.

The audio signal representation generator may be such that the third learnable layer is applied [e.g. by sliding the kernel] along the second dimension of the third multi-dimensional audio signal representation of the input audio signal.

The audio signal representation generator may further comprise an encoder [and/or a quantizer] to encode a bitstream from the output audio signal representation.

The audio signal representation generator may further comprise at least one further learnable block (290) downstream to the at least one learnable block (230) [and/or upstream to the quantizer, which may be a learnable quantizer, e.g. a quantizer using a learnable codebook] to generate, from the fourth [or the first, or the second, or the third, or another] multi-dimensional audio signal representation (269) of the input audio signal (1) [and/or from the output audio signal representation (3, 469) of the input audio signal (1)], a fifth audio signal representation (469) of the input audio signal (1) with multiple samples [e.g. 256, or at least between 120 and 560] for each frame [e.g. for 10 ms, or for 5 ms, or for 20 ms] [the learnable block may be, for example, a non-residual learnable block, and it may have a kernel which may be a learnable kernel, e.g. a 1×1 kernel].

The audio signal representation generator may be such that the at least one further learnable block (290) downstream to the at least one learnable block (230) [and/or upstream to the quantizer] includes:
at least one residual learnable layer [e.g. a main portion (459a′) of the audio signal representation (429) bypasses (459′) at least one of a first layer (430) [e.g. an activation function, e.g. leaky ReLU] [the first bypassed layer 430 may therefore be a non-learnable activation function], a second, learnable layer (440), a third layer (450) [e.g. an activation function, e.g. leaky ReLU] and a fourth, learnable layer (450) [e.g. without being followed by an activation function] and/or at least one of a first layer (430), a second, learnable layer (440), a third layer (450) and a fourth, learnable layer (450) is applied to at least a residual portion (459a) of the audio signal representation (359a) of the input audio signal (1)].

The audio signal representation generator may be such that the at least one further learnable block (290) downstream to the at least one learnable block (230) [and/or upstream to the quantizer] includes:
at least one convolutional learnable layer.

The audio signal representation generator may be such that the at least one further learnable block (290) downstream to the at least one learnable block (230) [and/or upstream to the quantizer] includes:
at least one learnable layer activated by an activation function (e.g. ReLu or Leaky ReLu).

The audio signal representation generator may be such that the activation function is ReLu or Leaky ReLu.

The audio signal representation generator may be such that the format definer (210) is configured to define a first multi-dimensional audio signal representation (220) of the input audio signal (1), the first multi-dimensional audio signal representation (220) of the input audio signal including at least:
a first dimension [e.g. inter frame dimension], so that a plurality of mutually subsequent frames [e.g. immediately subsequent] is ordered according to the first dimension; and
a second dimension [e.g. intra frame dimension], so that a plurality of samples of at least one frame are ordered according to the second dimension [the format definer may be configured to order mutually subsequent samples, e.g. immediately subsequent samples, one after the other one according to the second dimension.

As shown in examples above, there is disclosed an an encoder (2) comprising the audio signal representation generator (20) and a quantizer (300) to encode a bitstream (3) from the output audio signal representation (269).

The encoder (2) of may be such that the quantizer (300) is a learnable quantizer (300) [e.g. a quantizer using at least one learnable codebook] configured to associate, to each frame of the first multi-dimensional audio signal representation (290) of the input audio signal (1), or a processed version of the first multi-dimensional audio signal representation, indexes of at least one codebook, so as to generate the bitstream [the at least one codebook may be, for example, a learnable codebook].

As shown in examples above, there is disclosed an an encoder (2) for generating a bitstream (3) in which an input audio signal (1) including a sequence of input audio signal frames is encoded, each input audio signal frame including a sequence of input audio signal samples, the encoder (2) comprising:
a format definer (210) configured to define [e.g. generate] a first multi-dimensional audio signal representation (220) of the input audio signal, the first multi-dimensional audio signal representation of the input audio signal including at least:
   a first dimension [e.g. inter frame dimension], so that a plurality of mutually subsequent frames [e.g. immediately subsequent] is ordered according to the first dimension; and
   a second dimension [e.g. intra frame dimension], so that a plurality of samples of at least one frame are ordered according to the second dimension [the format definer may be configured to order mutually subsequent samples, e.g. immediately subsequent samples, one after the other one according to the second dimension],
optionally, at least one intermediate layer [e.g. a deterministic layer and/or at least one learnable layer, such as a recurrent learnable layer, e.g. a GRU, or LSTM)] to provide at least one processed version of the first multi-dimensional audio signal representation of the input audio signal;
a learnable quantizer [e.g. a quantizer using a learnable codebook, while the quantization as such may be deterministic or learnable] to associate, to each frame of the first multi-dimensional or a processed version of the first multi-dimensional audio signal representation of the input audio signal, indexes of at least one codebook, so as to generate the bitstream.

As shown in examples above, there is disclosed an encoder for generating a bitstream in which an input audio signal including a sequence of input audio signal frames is encoded, each input audio signal frame including a sequence of input audio signal samples, the encoder comprising:
a learnable quantizer to associate, to each frame of a first multi-dimensional audio signal representation of the input audio signal, indexes of at least one codebook, so as to generate the bitstream.

As shown in examples above, there is disclosed an an encoder for generating a bitstream encoding an input audio signal including a sequence of input audio signal frames, each input audio signal frame including a sequence of input audio signal samples, the encoder comprising:
a format definer configured to define a first multi-dimensional audio signal representation of the input audio signal, the first multi-dimensional audio signal representation of the input audio signal including at least:
   a first dimension [e.g. inter frame dimension], so that a plurality of mutually subsequent frames [e.g. immediately subsequent] is ordered according to the first dimension; and
   a second dimension [e.g. intra frame dimension], so that a plurality of samples of at least one frame are ordered according to the second dimension [the format definer may be configured to order mutually subsequent samples, e.g. immediately subsequent samples, one after the other one according to the second dimension],
at least one intermediate learnable layer [e.g. such as a recurrent learnable layer, e.g. a GRU, or LSTM, which may be residual, and which may be in cascade with at least one convolutional learnable layer] to provide at least one processed version of the first multi-dimensional audio signal representation of the input audio signal;
a learnable quantizer to associate, to each frame of the first multi-dimensional or a processed version of the first multi-dimensional audio signal representation of the input audio signal, indexes of at least one codebook [e.g. learnable codebook], so as to generate the bitstream.

The encoder may be such that the learnable quantizer [or quantizer] uses the at least one codebook [e.g. learnable codebook] associating indexes [e.g. i_{z}, iᵣ, i_{q}, with the index i_{z} representing a code z approximating E(x) and being taken from the codebook [e.g. learnable codebook]zₑ, the index iₜ representing a code r approximating E(x)−z and being taken from the codebook [e.g. learnable codebook]rₑ, and the index i_{q} representing a code q approximating E(x)−z−r and being taken from the codebook [e.g. learnable codebook]qₑ] to be encoded in the bitstream.

The encoder may be such that the at least one codebook [e.g. learnable codebook] [e.g. zₑ, rₑ, qₑ] includes at least one base codebook [e.g. learnable codebook] [e.g. zₑ] associating, to indexes [e.g. i_{z}] to be encoded in the bitstream, multidimensional tensors [or other types of codes, such as vectors] of the first multi-dimensional audio signal representation of the input audio signal.

The encoder may be such that the at least one codebook [e.g. learnable codebook] includes at least one residual codebook [e.g. learnable codebook] [e.g. a first residual codebook, e.g. rₑ and maybe a second residual codebook, e.g. qₑ, and maybe even more low-ranked residual codebooks] associating, to indexes to be encoded in the bitstream, multidimensional tensors of the first multi-dimensional audio signal representation of the input audio signal.

The encoder may be such that there are defined a multiplicity of residual codebooks [e.g. learnable codebooks], so that:
a second residual codebook [e.g. second residual learnable codebook] associates, to indexes to be encoded in the audio signal representation, multidimensional tensors representing second residual portions of the first multi-dimensional audio signal representation of the input audio signal,
a first residual codebook [e.g. second residual learnable codebook] associates, to indexes to be encoded in the audio signal representation, multidimensional tensors representing first residual portions of frames of the first multi-dimensional audio signal representation,
wherein the second residual portions of frames are residual [e.g. low-ranked] with respect to the first residual portions of frames.

The encoder may be configured to signal, in the bitstream (3), whether indexes associated to residual frames are encoded or not, and the quantization index (313) accordingly reads [e.g. only] the encoded indexes according to the signalling [and, in case of different rankings, the bitstream may signal which indexes of which ranking are encoded, and/or the at least one codebook [e.g. learnable codebook] (313) accordingly reads, e.g. only, the encoded indexes according to the signalling].

The encoder may be such that at least one codebook [e.g. learnable codebook] is a fixed-length codebook [e.g. at least one codebook having a number of bits between 4 and 20, e.g. between 8 and 12, e.g. 10].

The encoder may further comprise [e.g. in the intermediate layer or downstream to the intermediate layer but upstream to the quantizer] at least one further learnable block (290) downstream to the at least one learnable block (230) [and/or upstream to the quantizer, which may be a learnable quantizer, e.g. a quantizer using a learnable codebook] to generate, from the fourth multi-dimensional audio signal representation (269) or another version of the input audio signal (1), a fifth audio signal representation of the input audio signal (1) with multiple samples [e.g. 256, or at least between 120 and 560] for each frame [e.g. for 10 ms, or for 5 ms, or for 20 ms] [the learnable block may be, for example, a non-residual learnable block, and it may have a kernel which may be a learnable kernel, e.g. a 1×1 kernel].

The encoder may be such that the at least one further learnable block (290) downstream to the at least one learnable block (230) [and/or upstream to the quantizer] includes: at least one residual learnable layer [e.g. a main portion (459a′) of the audio signal representation (429) bypasses (459′) at least one of a first learnable layer (430), a second learnable layer (440), a third learnable layer (450) and a fourth learnable layer (450) and/or at least one of a first learnable layer (430), a second learnable layer (440), a third learnable layer (450) and a fourth learnable layer (450) is applied to at least a residual portion (459a) of the audio signal representation (359a) of the input audio signal (1)].

The encoder may be such that the at least one further learnable block (290) downstream to the at least one learnable block (230) [and/or upstream to the quantizer] includes:
at least one convolutional learnable layer.

The encoder may be such that the at least one further learnable block (290) downstream to the at least one learnable block (230) [and/or upstream to the quantizer] includes:
at least one learnable layer activated by an activation function (e.g. ReLu or Leaky ReLu).

The encoder may be such that a training session is performed by generating a multiplicity of bitstreams with candidate indexes associated with known frames representing known audio signals, the training session including a decoding of the bitstreams and an evaluation of audio signals generated by the decoding in respect to the known audio signals, so as to adapt associations of indexes of the at least one codebook [e.g. learnable codebook] with the frames of the encoded bitstreams [e.g. by minimizing the difference between the generated audio signal and the known audio signals] [e.g. using a GAN].

The encoder may be such that the training session is performed by receiving at least:
a multiplicity of first bitstreams with first candidate indexes having a first bitlength and being associated with first known frames representing known audio signals, the first candidate indexes forming a first candidate codebook, and
a multiplicity of second bitstreams with second candidate indexes having a second bitlength and being associated with known frames representing the same first known audio signals, the second candidate indexes forming a second candidate codebook,
wherein the first bitlength is higher than the second bitlength [and/or the first bitlength has higher resolution but it occupies more band than the second bitlength],
the training session including an evaluation of the generated audio signals obtained from the multiplicity of the first bitstreams in comparison with the generated audio signals obtained from the multiplicity of the second bitstreams, to thereby choose the codebook [e.g. so that the chosen learnable codebook is the chosen codebook between the first and second candidate codebooks] [for example, there may be an evaluation of a first ratio between a metrics measuring the quality of the audio signal generated from the multiplicity of first bitstreams in respect to the bitlength vs a second ratio between a metrics measuring the quality of the audio signal generated from the multiplicity of second bitstreams in respect to the bitrate (sampling rate), and to choose the bitlength which maximizes the ratio] [e.g. this can be repeated for each of the codebooks, e.g. the main, the first residual, the second residual, etc.].

The encoder may be such that the training session is performed by receiving:
a first multiplicity of first bitstreams with first indexes associated with first known frames representing known audio signals, wherein the first indexes are in a first maximum number, the first multiplicity of first candidate indexes forming a first candidate codebook; and
a second multiplicity of second bitstreams with second indexes associated with known frames representing the same first known audio signals, the second multiplicity of second candidate indexes forming a second candidate codebook, wherein the second indexes are in a second maximum number different from the first maximum number,
the training session including an evaluation of the generated audio signals obtained from the first multiplicity of the first bitstreams in comparison with the generated audio signals obtained from the second multiplicity of the second bitstreams, to thereby choose the learnable indexes [e.g. so that the chosen learnable codebook is chosen among the first candidate codebook and the second candidate codebook] [for example, there may be an evaluation of a first ratio between a metrics measuring the quality of the audio signal generated from the first multiplicity of first bitstreams vs a second ratio between a metrics measuring the quality of the audio signal generated from the second multiplicity of second bitstreams in respect to the bitrate (sampling rate), and to choose the multiplicity, among the first multiplicity and second multiplicity, which maximizes the ratio] [e.g. this can be repeated for each of the codebooks, e.g. the main, the first residual, the second residual, etc.].

In the learnable layer 240 of the encoder, which may have a recurrent learnable layer (e.g. a GRU), in some examples the recurrent learnable layer may be configured to generate the output (e.g. to be provided to the convolutional layer 250) (e.g. for a given time instant) by keeping into account the output and/or a state of a preceding [e.g. immediately preceding] time instant, wherein the relevance of the output [target data (12)] and/or state of a preceding [e.g. immediately preceding] time instant may be obtained by training.

The recurrent learnable layer of the learnable layer 240 may operates along a series of time steps each having at least one state, in such a way that each time step is conditioned by the output and/or state of the [e.g. immediately] preceding time step [the state of the preceding time step may be the output] [it may be, like in FIG. 11, that the step and/or output of each step is recursively provided to a subsequent time step, e.g. the immediately subsequent time step] [alternatively, like in FIG. 12, there may be a plurality of feedforward modules, each providing the state and/or output to the subsequent module, e.g. the immediately subsequent module] [the implementation of FIG. 12 may be understood, in some examples, like the unrolled version of the implementation of FIG. 11] [in examples, the parameters of different time instants and/or feedforward modules may be in general different from each other, but in some examples they may be the same].

The GRU of the learnable layer 240 may further comprise a plurality of feedforward modules, each providing the state and/or output to the immediately subsequent module.

The GRU of the learnable layer 240 may be configured to generate a state and/or output [hₜ] [for a particular t-th state or module] by:
weighting a candidate state and/or output through an update gate vector [zₜ] [whose elements may have a value between 0 and 1, or another value between 0 and c, with c>0], to generate a first weighted addend; and
weighting the state and/or output [hₜ₋₁] of the preceding time step through a vector which is complementary to 1 [i.e. its components are complementary to 1] with the update gate vector zₜ, to generate a second weighted addend; and
adding the first addend with the second addend
[the update gate vector [zₜ] may provide information on both how much is to be taken from the candidate state and/or output and how much is to be taken from the state and/or output [hₜ₋₁] of the preceding time step; e.g. if zₜ=0, the state and/or output for the current time instant is only taken from the state and/or output [hₜ₋₁] of the preceding time step; while if the zₜ=1, the state and/or output for the current time instant is only taken from the candidate vector].

The GRU of the learnable layer 240 may be such that the recurrent learnable layer is configured to generate a state and/or output [hₜ] by:
through reciprocally complementary weighting vectors, adding a weighted version of a candidate state and/or output with a weighted version of the state and/or output hₜ₋₁ of the preceding time step.

The GRU of the learnable layer 240 may be configured to generate the candidate state and/or output by at least applying a weight parameter [W], obtained by training, to:
an element-wise product between a reset gate vector [rₜ] and the state and/or output [hₜ₋₁] of the preceding time step, concatenated with the input [xₜ] for the current time instant;
optionally followed by applying an activation function (e.g. tanH)
[the reset gate vector [rₜ] giving information on how much the state and/or output [hₜ₋₁] of the preceding time step shall be reset] [if rₜ=0, we reset everything and we keep nothing from hₜ₋₁, while if rₜ is higher, then we keep more from hₜ₋₁].

The GRU of the learnable layer 240 may be further configured to apply an activation function after having applied the weight parameter W. The audio generator may be such that the activation function is TanH.

The GRU of the learnable layer 240 may be configured to generate the candidate state and/or output by at least:
weighting, through weight parameter W obtained by training, a vector which is conditioned by both:
the input [xₜ] for the current time instant and
the state and/or output [hₜ₋₁] of the preceding time step weighted onto a reset gate vector [rₜ], [the reset gate vector giving information on how much the state and/or output [hₜ₋₁] of the preceding time step shall be reset] [if rₜ=0, we reset everything and we keep nothing from hₜ₋₁, while if rₜ is higher, then we keep more from hₜ₋₁]

The GRU of the learnable layer 240 may be configured to generate the update gate vector [zₜ] by applying a parameter [W_{z}] to a concatenation of:
the input [hₜ₋₁] of the recurrent module [hₜ₋₁] concatenated with
the input [xₜ] for the current time instant [e.g. the input to the at least one preconditioning learnable layer (710)],
optionally followed by applying an activation function (e.g., sigmoid, a).

After having applied the parameter W_{z}, an activation function may be applied. The activation function is a sigmoid, a.

The reset gate vector rₜ may be obtained by applying a weight parameter Wᵣ to a concatenation of both:
the state and/or output hₜ₋₁ of the preceding time step and
the input xₜ for the current time instant.

After having applied the parameter Wᵣ, an activation function may be applied. The activation function is a sigmoid, a.

The audio generator may be such that the training session is performed by receiving:
a first multiplicity of first bitstreams with first indexes representing codes obtained from known audio signals, the first multiplicity of first bitstreams forming at least one first codebook [e.g. at least one main codebook zₑ]; and
a second multiplicity of second bitstreams including both the first indexes representing main codes obtained from known audio signals and second indexes representing residual codes in respect to the main codes, the second multiplicity of second bitstreams forming the at least one first codebook [e.g. at least one main codebook zₑ] and at least one second codebook [e.g. at least one residual codebook rₑ];
the training session including an evaluation of the generated audio signals obtained from the first multiplicity of the first bitstreams in comparison with the generated audio signals obtained from the second multiplicity of the second bitstreams,
to thereby choose among the first multiplicity [and/or the first candidate codebook zₑ] and the second multiplicity [and/or the first candidate codebook zₑ as main codebook, together with the at least one second codebook used as residual codebook rₑ] [e.g. so that the chosen learnable codebook is chosen among the first candidate codebook and the second candidate codebook] [for example, there may be an evaluation of a first ratio between a metrics measuring the quality of the audio signal generated from the first multiplicity of first bitstreams vs a second ratio between a metrics measuring the quality of the audio signal generated from the second multiplicity of second bitstreams in respect to the bitrate (sampling rate), and to choose the multiplicity, among the first multiplicity and second multiplicity, which maximizes the ratio] [e.g. this can be repeated for each of the codebooks, e.g. the main, the first residual, the second residual, etc.].

As shown in examples above, there is disclosed a method for training the audio signal generator [e.g. decoder], may comprise a training session including generating a multiplicity of bitstreams with candidate indexes associated with known frames representing known audio signals, the training session including a decoding of the bitstreams and an evaluation of audio signals generated by the decoding in respect to the known audio signals, so as to adapt associations of indexes of the at least one codebook with the frames of the encoded bitstreams [e.g. by minimizing the difference between the generated audio signal and the known audio signals] [e.g. using a GAN].

As shown in examples above, there is disclosed a method for training an audio signal generator [e.g. decoder] as above, may comprise a training session including generating a multiplicity of bitstreams with candidate indexes associated with known frames representing known audio signals, the training session including providing to the audio signal generator bitstreams non-provided by the encoder, so as to obtain the indexes to be used [e.g. obtain the codebook] by optimizing a loss function.

As shown in examples above, there is disclosed a method for training an audio signal generator [e.g. decoder] as above, may comprise a training session including generating multiple output audio signal representations of known input audio signals, the training session including an evaluation of the multiple output audio signal representations [e.g. bitstreams] in respect to the known input audio signals and/or minimizing a loss function, so as to adapt parameters of at least one learnable layer(s) optimizing a loss function.

As shown in examples above, there is disclosed a method for training an audio signal representation generator (or encoder) as above, may comprise a training session including receiving a multiplicity of bitstreams with indexes associated with known frames representing known audio signals, the training session including an evaluation of the generated audio signals in respect to the known audio signals, so as to adapt associations of indexes of the at least one codebook with the frames of the encoded bitstreams and/or optimizing a loss function [e.g. by minimizing the difference between the generated audio signal and the known audio signals] [e.g. using a GAN].

As shown in examples above, there is disclosed a method for training an audio signal representation generator (or encoder) as above together with an audio signal generator [e.g. decoder]e.g. as above, may comprise:
providing a plurality of audio signals (1) to the audio signal representation generator, so as to obtain audio signal representations and/or bitstreams (3) and, at the audio signal generator (10), generating the output signals (16) from the audio signal representations and/or bitstreams (3);
providing, to the audio signal generator (10), a plurality of audio signal representations and/or bitstreams (3) which not generated by the audio signal representation generator (20), and, at the audio signal generator (10), generating the output signals (16) from the audio signal representations and/or bitstreams (3);
evaluating a loss function associated to the output signals (16) from the audio signal representations and/or bitstreams (3) vs the output signals (16) from the audio signal representations and/or bitstreams (3), so as to obtain the parameters of the learnable layers and blocks of the audio signal generator (10) and of the audio signal representation generator by minimizing the loss function.

As shown in examples above, there is disclosed a method for generating an audio signal (16) from a bitstream (3), the bitstream (3) representing the audio signal (16), the audio signal being subdivided in a sequence of frames, the method may comprise:
providing, for a given frame, first data (15) derived from an input signal (14)[e.g. from an external or internal source or from the bitstream (3)], [wherein the first data (15) may have one single channel or multiple channels];
though a first processing block (40, 50, 50a-50h), receiving [e.g. for the given frame] the first data (15) and outputting first output data (69) in the given frame, [wherein the first output data (69) may comprise a one single channel or a plurality of channels (47)],
[e.g. the method also comprising through a second processing block (45), e.g. for the given frame, receiving, as second data, the first output data (69) or data derived from the first output data (69),]
wherein the first processing block (50) comprises:
   at least one preconditioning learnable layer (710) receiving the bitstream (3), or a processed version (112) thereof, and, for the given frame, output target data (12) representing the audio signal (16) in the given frame [e.g. with multiple channels and multiple samples for the given frame];
   at least one conditioning learnable layer (71, 72, 73) processing, e.g. for the given frame, the target data (12) to obtain conditioning feature parameters (74, 75) for the given frame; and
   a styling element (77), applying the conditioning feature parameters (74, 75) to the first data (15, 59a) or normalized first data (59, 76′);
[wherein the second processing block (45), if present, may combine the plurality of channels (47) of the second data (69) to obtain the audio signal (16)],
wherein the at least one preconditioning learnable layer (710) includes at least one recurrent learnable layer [e.g. a gated recurrent learnable layer, such as a gated recurrent unit, GRU, or LSTM]
[e.g. obtaining the audio signal (16) from the first output data (69) or a processed version of the first output data (69)].

As shown in examples above, there is disclosed a method for generating an audio signal (16) from a bitstream (3), the bitstream (3) representing the audio signal (16), the bitstream (3) being subdivided into a sequence of indexes, the audio signal being subdivided in a sequence of frames, the method may comprise:
a quantization index converter step (313) [also called index-to-code converter step, inverse quantizer step, reverse quantizer step, etc.] converting the indexes of the bitstream (13) onto codes [e.g., according to the examples, the codes may be scalars, vectors or more in general tensors] [e.g. according to a codebook, e.g. a tensor may be multidimensional, such as a matrix or its generalization onto multiple dimensions, e.g. three dimensions, four dimensions, etc.] [e.g. the codebook may be learnable or may be deterministic],
a first data provisioner step (702) providing, e.g. for a given frame, first data (15) derived from an input signal (14) from an external or internal source or from the bitstream (3), [wherein the first data (15) may have one single channel or multiple channels] [;
a step using a first processing block (40, 50, 50a-50h), e.g. for the given frame, to receive the first data (15) and to output first output data (69) in the given frame, [wherein the first output data (69) may comprise a one single channel or a plurality of channels (47)], and
[there may be a second processing block (45), e.g. for the given frame, to receive, as second data, the first output data (69) or data derived from the first output data (69)],
wherein the first processing block (50) comprises:
   at least one preconditioning learnable layer (710) to receive the bitstream (3), or a processed version (112) thereof, and, for the given frame, output target data (12) representing the audio signal (16) in the given frame [e.g. with multiple channels and multiple samples for the given frame];
   at least one conditioning learnable layer (71, 72, 73), e.g. for the given frame, to process the target data (12) to obtain conditioning feature parameters (74, 75) for the given frame; and
   a styling element (77), to apply the conditioning feature parameters (74, 75) to the first data (15, 59a) or normalized first data (59, 76′);
   [wherein the second processing block (45), if present, may combine the plurality of channels (47) of the first output data or of the second output data (69) to obtain the audio signal (16)]
[e.g. to obtain the audio signal (16) from the first output data (69) or a processed version (16) of the first output data (69)].

As shown in examples above, there is disclosed a method for generating an output audio signal representation (3, 469) from an input audio signal (1) including a sequence of input audio signal frames, each input audio signal frame including a sequence of input audio signal samples, the audio signal representation generator (2, 20) may comprise:
defining a first multi-dimensional audio signal representation (220) of the input audio signal (1) [e.g. the same of above];
through a first learnable layer (230), [e.g. a first convolutional learnable layer, which is a convolutional learnable layer] generating a second multi-dimensional audio signal representation of the input audio signal (1) by sliding along a second direction [e.g. intra frame direction] of the first multi-dimensional audio signal representation (220) of the input audio signal (1);
through a second learnable layer (240) which is a recurrent learnable layer generating a third multi-dimensional audio signal representation of the input audio signal (1) by operating along a first direction [e.g. inter frame direction] of the second multi-dimensional audio signal representation (220) of the input audio signal (1) [e.g. using a 1×1 kernel, e.g. a 1×1 learnable kernel, or another kernel];
through a third learnable layer (250) [which may be, for example, a second convolutional learnable layer] which is a convolutional learnable layer generating a fourth multi-dimensional audio signal representation (265b′) of the input audio signal by sliding along the second direction [e.g. intra frame direction] of the first multi-dimensional audio signal representation of the input audio signal [e.g. using a 1×1 kernel, e.g. a 1×1 learnable kernel],
so as to obtain the output audio signal representation (469) from the fourth multi-dimensional audio signal representation (265b′) of the input audio signal (1)[e.g., after having added the fourth multi-dimensional audio signal representation (265b′) with a main portion of the multi-dimensional audio signal representation (220) of the input audio signal (1), or after the block 290 and/or quantization block 300].

A non-transitable storage unit storing instruction may be such that, when executed by a processor, cause the processor to perform a method as above.

### Further Examples

Generally, examples may be implemented as a computer program product with program instructions, the program instructions being operative for performing one of the methods when the computer program product runs on a computer. The program instructions may for example be stored on a machine readable medium. Other examples comprise the computer program for performing one of the methods described herein, stored on a machine readable carrier. In other words, an example of method is, therefore, a computer program having a program instructions for performing one of the methods described herein, when the computer program runs on a computer. A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory. A further example of the method is, therefore, a data stream or a sequence of signals representing the computer program for performing one of the methods described herein. The data stream or the sequence of signals may for example be transferred via a data communication connection, for example via the Internet. A further example comprises a processing means, for example a computer, or a programmable logic device performing one of the methods described herein. A further example comprises a computer having installed thereon the computer program for performing one of the methods described herein. A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver. In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus. The above described examples are merely illustrative for the principles discussed above. It is understood that modifications and variations of the arrangements and the details described herein will be apparent. It is the intent, therefore, to be limited by the scope of the claims and not by the specific details presented by way of description and explanation of the examples herein. Equal or equivalent elements or elements with equal or equivalent functionality are denoted in the following description by equal or equivalent reference numerals even if occurring in different figures.

Also, further examples are defined by the enclosed claims (examples are also in the claims). It should be noted that any example as defined by the claims can be supplemented by any of the details (features and functionalities) described in the following chapters. Also, the examples described in the above passages can be used individually, and can also be supplemented by any of the features in another chapter, or by any feature included in the claims. The text in round brackets and square brackets is optional, and defines further embodiments (further to those defined by the claims). Also, it should be noted that individual aspects described herein can be used individually or in combination. Thus, details can be added to each of said individual aspects without adding details to another one of said aspects. It should also be noted that the present disclosure describes, explicitly or implicitly, features of a mobile communication device and of a receiver and of a mobile communication system. Depending on certain implementation requirements, examples may be implemented in hardware. The implementation may be performed using a digital storage medium, for example a floppy disk, a Digital Versatile Disc (DVD), a Blu-Ray Disc, a Compact Disc (CD), a Read-only Memory (ROM), a Programmable Read-only Memory (PROM), an Erasable and Programmable Read-only Memory (EPROM), an Electrically Erasable Programmable Read-Only Memory (EEPROM) or a flash memory, having electronically readable control signals stored thereon, which cooperate (or are capable of cooperating) with a programmable computer system such that the respective method is performed. Therefore, the digital storage medium may be computer readable. Generally, examples may be implemented as a computer program product with program instructions, the program instructions being operative for performing one of the methods when the computer program product runs on a computer. The program instructions may for example be stored on a machine readable medium. Other examples comprise the computer program for performing one of the methods described herein, stored on a machine-readable carrier. In other words, an example of method is, therefore, a computer program having a program-instructions for performing one of the methods described herein, when the computer program runs on a computer. A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory. A further example comprises a processing unit, for example a computer, or a programmable logic device performing one of the methods described herein. A further example comprises a computer having installed thereon the computer program for performing one of the methods described herein. A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver. In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed:

1. An audio signal representation generator for generating an output audio signal representation from an input audio signal comprising a sequence of input audio signal frames, each input audio signal frame comprising a sequence of input audio signal samples, the audio signal representation generator comprising:
a format definer configured to define a first multi-dimensional audio signal representation of the input audio signal, the first multi-dimensional audio signal representation of the input audio signal comprising at least:
a first dimension, so that a plurality of mutually subsequent frames is ordered according to the first dimension; and
a second dimension so that a plurality of samples of at least one frame are ordered according to the second dimension,
at least one learnable layer configured to process the first multidimensional audio signal representation of the input audio signal, or processed version of the first multi-dimensional audio signal representation, to generate the output audio signal representation of the input audio signal,
wherein the format definer is configured to insert, along the second dimension of the first multi-dimensional audio signal representation of the input audio signal, additional input audio signal samples of one or more additional frames immediately successive to or immediately preceding the given frame.

2. The audio signal representation generator of claim 1, wherein the format definer is configured to insert, along the second dimension of the first multidimensional audio signal representation of the input audio signal, input audio signal samples of each given frame.

3. The audio signal representation generator of claim 1, wherein the at least one learnable layer comprises at least one recurrent learnable layer.

4. The audio signal representation generator of claim 3, wherein the at least one recurrent learnable layer comprises a gated recurrent unit, GRU.

5. The audio signal representation generator of claim 3, wherein the at least one recurrent learnable layer is operated along the first dimension.

6. The audio signal representation generator of claim 1, further comprising at least one first convolutional learnable layer between the format definer and the at least one recurrent learnable layer.

7. The audio signal representation generator of claim 6, wherein in the at least one first convolutional learnable layer the kernel is slid along the second direction of the first multi-dimensional audio signal representation of the input audio signal.

8. The audio signal representation generator of claim 1, further comprising at least one convolutional learnable layer downstream to the at least one recurrent learnable layer.

9. The audio signal representation generator of claim 8, wherein in the at least one convolutional learnable layer the kernel is slid along the second direction of the first multi-dimensional audio signal representation of the input audio signal.

10. The audio signal representation generator of claim 1, wherein at least one or more of the at least one learnable layer is a residual learnable layer.

11. The audio signal representation generator of claim 10, wherein at least one learnable layer is a residual learnable layer, a main portion of the first multidimensional audio signal representation of the input audio signal bypassing the at least one learnable layer, and/or the at least one learnable layer is applied to at least a residual portion of the first bidimensional audio signal representation of the input audio signal.

12. The audio signal representation generator of claim 3, wherein the recurrent learnable layer operates along a series of time steps each comprising at least one state, in such a way that each time step is conditioned by the output and/or state of the preceding time step.

13. The audio signal representation generator of claim 12, wherein the step and/or output of each step is recursively provided to a subsequent time step.

14. The audio signal representation generator of claim 12, comprising a plurality of feedforward modules, each providing the state and/or output to the subsequent module.

15. The audio signal representation generator of claim 3, wherein the recurrent learnable layer generates the output for a given time instant by keeping into account the output and/or a state of a preceding time instant, wherein the relevance of the output and/or state of a preceding time instant is obtained training.

16. The audio signal representation generator of claim 1, the format definer begin configured to order mutually subsequent samples, one after the other one according to the second dimension.

17. An audio signal representation generator for generating an output audio signal representation from an input audio signal comprising a sequence of input audio signal frames, each input audio signal frame comprising a sequence of input audio signal samples, the audio signal representation generator comprising:
a format definer configured to define a first multi-dimensional audio signal representation of the input audio signal;
a second learnable layer which is a recurrent learnable layer configured to generate a third multi-dimensional audio signal representation of the input audio signal by operating along a first direction of the first multi-dimensional audio signal representation, or of a processed version thereof which is a second multi-dimensional audio signal representation, of the input audio signal;
a third learnable layer which is a convolutional learnable layer configured to generate a fourth multi-dimensional audio signal representation of the input audio signal by sliding along the second direction of the third multi-dimensional audio signal representation of the input audio signal,
so as to obtain the output audio signal representation from the fourth multi-dimensional audio signal representation of the input audio signal.

18. The audio signal representation generator according to claim 1 and a quantizer to encode a bitstream from the output audio signal representation.

19. The audio signal representation generator according to claim 17 and a quantizer to encode a bitstream from the output audio signal representation.

20. The audio signal representation generator of claim 18, wherein the quantizer is a learnable quantizer configured to associate, to each frame of the first multi-dimensional audio signal representation of the input audio signal, or a processed version of the first multi-dimensional audio signal representation, indexes of at least one codebook, so as to generate the bitstream.

21. The audio signal representation generator of claim 18, wherein the learnable quantizer uses the at least one codebook associating indexes i_{z}, iᵣ, i_{q}, with the index i_{z} representing a code z approximating E(x) and being taken from the codebook zₑ, the index iᵣ representing a code r approximating E(x)−z and being taken from the codebook rₑ, and the index i_{q} representing a code q approximating E(x)−z−r and being taken from the codebook qₑ to be encoded in the bitstream.

22. The audio signal representation generator of claim 18, wherein the at least one codebook comprises at least one base codebook associating, to indexes to be encoded in the bitstream, multidimensional tensors of the first multi-dimensional audio signal representation of the input audio signal.

23. The audio signal representation generator of claim 18, wherein the at least one codebook comprises at least one residual codebook associating, to indexes to be encoded in the bitstream, multidimensional tensors of the first multi-dimensional audio signal representation of the input audio signal.

24. The audio signal representation generator of claim 18, wherein there are defined a multiplicity of residual codebooks, so that:
a second residual codebook associates, to indexes to be encoded in the audio signal representation, multidimensional tensors representing second residual portions of the first multi-dimensional audio signal representation of the input audio signal,
a first residual codebook associates, to indexes to be encoded in the audio signal representation, multidimensional tensors representing first residual portions of frames of the first multi-dimensional audio signal representation,
wherein the second residual portions of frames are residual with respect to the first residual portions of frames.

25. The audio signal representation generator of claim 18, configured to signal, in the bitstream, whether indexes associated to residual frames are encoded or not.

26. The audio signal representation generator of claim 18, wherein at least one codebook is a fixed-length codebook.

27. The audio signal representation generator of claim 18, further comprising at least one further learnable block downstream to the at least one learnable block to generate, from the fourth multi-dimensional audio signal representation or another version of the input audio signal, a fifth audio signal representation of the input audio signal with multiple samples for each frame.

28. The audio signal representation generator of claim 27, wherein the at least one further learnable block downstream to the at least one learnable block comprises:
at least one residual learnable layer.

29. The audio signal representation generator of claim 27, wherein the at least one further learnable block downstream to the at least one learnable block comprises:
at least one convolutional learnable layer.

30. The audio signal representation generator of claim 27, wherein the at least one further learnable block downstream to the at least one learnable block comprises:
at least one learnable layer activated by an activation function (e.g. ReLu or Leaky ReLu).
